(19) United States
(12) Patent Application Publication
(10) Pub. No.: US 2006/0177808 A1
(43) Pub. Date: Aug. 10, 2006

(54) Apparatus for ability evaluation, method of evaluating ability, and computer program product for ability evaluation

(75) Inventors: Hidenori Aosawa, Minato-ku (JP); Masahiro Kanazawa, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: CSK Holdings Corporation

(21) Appl. No.: 11/337,461

(22) Filed: Jan. 24, 2006

Related U.S. Application Data
(63) Continuation-in-part of application No. PCT/JP04/03294, filed on Mar. 12, 2004.

(30) Foreign Application Priority Data
Jul. 24, 2003 (JP) 2003-201361

(51) Int. Cl. G09B 3/00

(52) U.S. Cl. 434/322

(57) ABSTRACT

An ability evaluation apparatus which evaluates an individual ability and stores a result of evaluation in an ability database, includes an ability mapping rule storing unit that stores an ability mapping rule which associates an ability item extracted from an ability sentence written in a natural language about an individual ability with a data item in the ability database using a structure of the ability sentence, a natural language processing unit that analyzes each sentence in a document written in the natural language about the individual ability to output a result of structural analysis, and an ability item storing unit that extracts the ability item from the result of structural analysis output from the natural language processing unit using the ability mapping rule stored in the ability mapping rule storing unit, and stores the extracted ability item in the ability database.

### CROSS-REFERENCE TO RELATED APPLICATIONS

This application is a continuation-in-part of a PCT application No. PCT/JP2004/003294 filed on Mar. 12, 2004, which claims the benefit of priority from the prior Japanese Patent Application No. 2003-201361 filed on Jul. 24, 2003; the entire contents of the PCT application and the Japanese application are incorporated herein by reference.

### BACKGROUND OF THE INVENTION

1) Field of the Invention

The present invention relates to technology for ability evaluation.

2) Description of the Related Art

A conventional way to evaluate an individual skill is to ask an evaluatee to answer a series of questions in a predetermined question and answer (Q&A) table, thereby collecting necessary information (see, Patent Literature 1, for example).

For the skill evaluation in an IT industry, for example, the evaluatee is asked to answer a question such as “Do you have an experience of developing a business system?” by “Yes” or “No.” When the evaluatee has an experience of a project management or an organization management, the evaluatee is asked to answer a question such as “How many people did you take charge of management?” by a specific number.

Thus, in a typical format of the skill evaluation based on the Q&A table, the evaluatee is expected to give an answer in a form of, for example, “Yes” or “No,” a certain level among a few predetermined skill levels or a numeral such as the number of personnel and the number of years.

Further, Patent Literatures 2 and 3 disclose conventional techniques of natural language processing which can be employed for extraction of necessary skill items from a document such as a resume of work experience written in a natural language without the use of the Q&A table.

Patent Literature 1: Japanese Patent Application Laid-Open No. 2002-140451

Patent Literature 2: Japanese Patent Application Laid-Open No.

Patent Literature 3: Japanese Patent Application Laid-Open No. 2002-230344

However, for the information collection based on the predetermined Q&A table, the evaluatee needs to answer a large amount of questions, which is quite a burden. In addition, the information collection based on a Q&A format by nature tends to include only general questions, therefore is incapable of gathering detailed information.

The Q&A table which includes only general questions cannot ask the evaluatee a more particular question on a specific skill-related name (such as a name of product or technique which the evaluate has deal with so far), for example, and hence is incapable of drawing out detailed information on specific skill-related names such as “product name” or “name of technique” (hereinbelow, “skill-related name” is also referred to as “skill name”).

Thus, the conventional Q&A table-based information gathering, though being able to ask question on widely-used standard products and techniques, does not distinguish professional products and techniques which are not known to general public. In particular, it is almost impossible to ask about “a name of something specific to a company.”

On the other hand, efforts of extracting specific skill-related names via questions are likely to result in a provision of a massive volume of questions (or options) and impedes a swift selection/input of information on skills thereby deteriorates the usability of the ability evaluation system.

In addition, such information collection requires maintenance of a skill evaluation system in the future (for example, new product names and technique names must be covered in the questions, and an additional processing is required to deal with such modification), resulting in a large volume of maintenance works. When these inconveniences are taken into consideration, the inclusion of specific product names and technique names into the questions is rather difficult to realize.

Thus, the information collection using the Q&A table in general can obtain only the “overall information” about the general skills without achieving extraction of specific skill-related names (product names or technique names). For example, to the question “Do you have an experience of developing a business system?” in the Q&A table, merely the answer “Yes” or “No” is provided. Then, the evaluator cannot know what kind of business system the evaluatee develops.

In addition, since the conventional skill evaluation based on the Q&A table mostly asks the evaluatee to answer in the forms of “Yes/No” or by an “input of one skill level among given levels,” the evaluatee sometimes finds it difficult to give the answer he/she thinks appropriate.

Specifically, the conventional Q&A table directly asks the skill level without giving the evaluatee an opportunity to provide information on process of his/her skill acquisition, and other supplementary information. In addition, the conventional Q&A table provides only typical and general questions and limited answer options, which sometimes forces the evaluatee to give an unsuitable answer (especially when the Q&A table does not include a suitable answer option for the evaluatee).

For example, for the question “Do you have an experience of developing a business system?” given answer options are “Yes” and “No” alone. Hence, the evaluator cannot acquire information on, for example, when, how, and with how many people the evaluatee develops the system. Further, the evaluator cannot distinguish the evaluatee who develops the system in 10 days from the evaluatee who develops the system in a year, nor the evaluator cannot distinguish the evaluatee who develops the system alone from the evaluatee who develops the system with ten people (When the evaluatee develops the system in ten days, he/she may answer either “Yes” or “No.” Thus the evaluatees with similar work experience may give different answers.)

Still further, the Q&A table type information collection cannot properly correct the biases of respective evaluatees (some may overevaluate themselves, others may underevaluate themselves.). Then, a proper judgment on evaluatee's skill is not possible without an actual interview with the evaluatee.

Still further, the conventional skill evaluation in the Q&A format asks the evaluatee to answer only a limited number of questions, which sometimes does not cover all points need to be answered. In particular, Q&A table often does not cover latest technologies.

Still further, when the questions are asked in the conventional skill evaluation format, the answers immediately given by the evaluatee often include only the comments on the latest events and do not reflect older performance (since the evaluatee cannot remind the past performance immediately). Still further, the conventional skill analysis asks only the questions corresponding to the type of job the evaluatee takes at the time of evaluation (basically, the questions are given after the evaluatee is categorized into a certain job type). Hence, the skill level of the evaluatee with respect to his/her suitability for other types of jobs cannot be known.

Thus, since the conventional Q&A format skill evaluation has various inconveniences, a more desirable information collection can be as such in which the evaluatee freely writes about his/her skill. Such information gathering allows collection of more correct skill information, and hence may be more preferable as a manner of information collection than the use of a fixed format such as the Q&A table.

One may think of extracting necessary skill items from a document such as a resume of work experience written in a natural language with the use of a natural language processing technique instead of using the Q&A table. The conventional application of natural language processing, however, merely performs matching between character strings. Hence, such application, though being capable of retrieving a predetermined character string, cannot extract a skill item based on a proper understanding of the contents of the document.

The problems as described above arise not only in the evaluation of individual skills, but also in the evaluation of individual abilities which should be considered at the review of job applications or internal transfers, for example, when it is required to evaluate an individual's level of motivation or the like.

### SUMMARY OF THE INVENTION

It is an object of the present invention to solve at least the problems in the conventional technology.

An ability evaluation apparatus which evaluates an individual ability and stores a result of evaluation in an ability database, according to embodiments of the present invention, includes: an ability mapping rule storing unit that stores an ability mapping rule which associates an ability item extracted from an ability sentence written in a natural language about an individual ability with a data item in the ability database using a structure of the ability sentence; a natural language processing unit that analyzes each sentence in a document written in the natural language about the individual ability to output a result of structural analysis; and an ability item storing unit that extracts the ability item from the result of structural analysis output from the natural language processing unit using the ability mapping rule stored in the ability mapping rule storing unit, and stores the extracted ability item in the ability database.

### BRIEF DESCRIPTION OF THE DRAWINGS

FIG. 1 is an explanatory diagram of a concept of a skill evaluation apparatus according to a first embodiment;

FIG. 2 is a functional block diagram of a structure of the skill evaluation apparatus according to the first embodiment;

FIG. 3 is an explanatory diagram of a natural language processing by a natural language processing unit;

FIG. 4 is a diagram of a skill mapping rule;

FIG. 5 is a diagram of another skill mapping rule;

FIG. 6 is a diagram of information which can be specified in a conditional part;

FIG. 7 is an explanatory diagram of a correspondence between a skill database and the ITSS;

FIG. 8 is a diagram of a skill database conversion rule;

FIG. 9 is a flowchart of a process sequence of the skill evaluation apparatus according to the first embodiment;

FIG. 10 is an explanatory diagram of a skill evaluation apparatus which performs a direct association with the skill database;

FIG. 11 is a diagram of a functional structure of a skill evaluation system according to a second embodiment;

FIG. 12 is a diagram of a screen structure of the skill evaluation system according to the second embodiment;

FIG. 13 is a diagram of an example of a format of an original evaluatees' list;

FIG. 14 is a diagram of an example of a format of a skill information file;

FIG. 15 is a diagram of an example of a format of a skill evaluatees' list;

FIG. 16 is an explanatory diagram of a concept of a motivation evaluation apparatus according to a third embodiment;

FIG. 17 is a functional block diagram of a structure of the motivation evaluation apparatus according to the third embodiment;

FIG. 18 is an explanatory diagram of a natural language processing by a natural language processing unit;

FIG. 19 is a diagram of a motivation mapping rule;

FIG. 20 is a diagram of another motivation mapping rule;

FIG. 21 is a diagram of information which can be specified in a conditional part;

FIGS. 22 and 23 are explanatory diagrams of a correspondence between a motivation database and a motivation definition system;

FIG. 24 is a diagram of a motivation database conversion rule;

FIG. 25 is a flowchart of a process sequence of the motivation evaluation apparatus according to the third embodiment;

FIG. 26 is an explanatory diagram of the motivation evaluation apparatus which performs a direct association with the motivation database;

FIG. 27 is a diagram of a functional structure of a motivation evaluation system according to a fourth embodiment;

FIG. 28 is a diagram of a screen structure of the motivation evaluation system according to the fourth embodiment;

FIG. 29 is a diagram of an example of a format of an original evaluatees' list;

FIG. 30 is a diagram of an example of a format of a motivation information file;

FIG. 31 is a diagram of an example of a format of a motivation evaluatees' list; and

FIG. 32 is an explanatory diagram of an integration of the skill evaluation apparatus and the motivation evaluation apparatus.

### DETAILED DESCRIPTIONS

In the following, exemplary embodiments of an ability evaluation apparatus, a method of evaluating ability, and a computer program product for ability evaluation according to the present invention are described in details with reference to the accompanying drawings. However, it should be noted that the present invention is not limited by these embodiments. Here, descriptions are given only on applications of the present invention to skill evaluation and motivation evaluation for personnel in a field of information processing.

First, main terms used in the description of the embodiments are described. In the description, the term “skill” means one of individual abilities, such as a management ability or a development ability, which can be considered in the reviews of job applications or internal transfers. A sentence in a document such as a resume of work experience written about such “skill” in a natural language is referred to as a “skill sentence.” The skill sentence and the result of a morphological analysis for the skill sentence is described in both Japanese and English. The term “Japanese expression (JE)” is attached to the Japanese and the term “English expression (EE)” is attached to the English in order to clearly distinguish these each other. In the description, “skill GAP” means a difference (gap) between a skill of a person possessing a standard skill expected in a market and a skill of an evaluatee.

Further, the term “motivation” in the description means one of individual abilities, such as an innovation-oriented character, or a specialty-oriented character, which can be considered in the reviews of job applications or internal transfers. A sentence in a document such as an application or a response to a motivation-related questionnaire written about such “motivation” in a natural language is referred to as a “motivation sentence.” In the description, “motivation GAP” means a difference (gap) between a motivation of a person possessing a standard motivation expected in a market and a motivation of an evaluatee.

Further, “integrated employment data” recited in the appended claims means integrated data on job-related information including information on standard skills and motivation expected in a job market, information on job vacancy and required skills and motivation, for example.

In a first embodiment, a skill evaluation apparatus is described. In a second embodiment, a description is given on a comprehensive skill evaluation system which supports job seekers or the like to find employment and gain education based on the skill evaluation. In a third embodiment, a motivation evaluation apparatus is described. In a fourth embodiment, a description is given on a comprehensive motivation evaluation system which supports job seekers or the like to find employment and gain education based on the motivation evaluation.

### 1: First Embodiment (Skill Evaluation Apparatus)

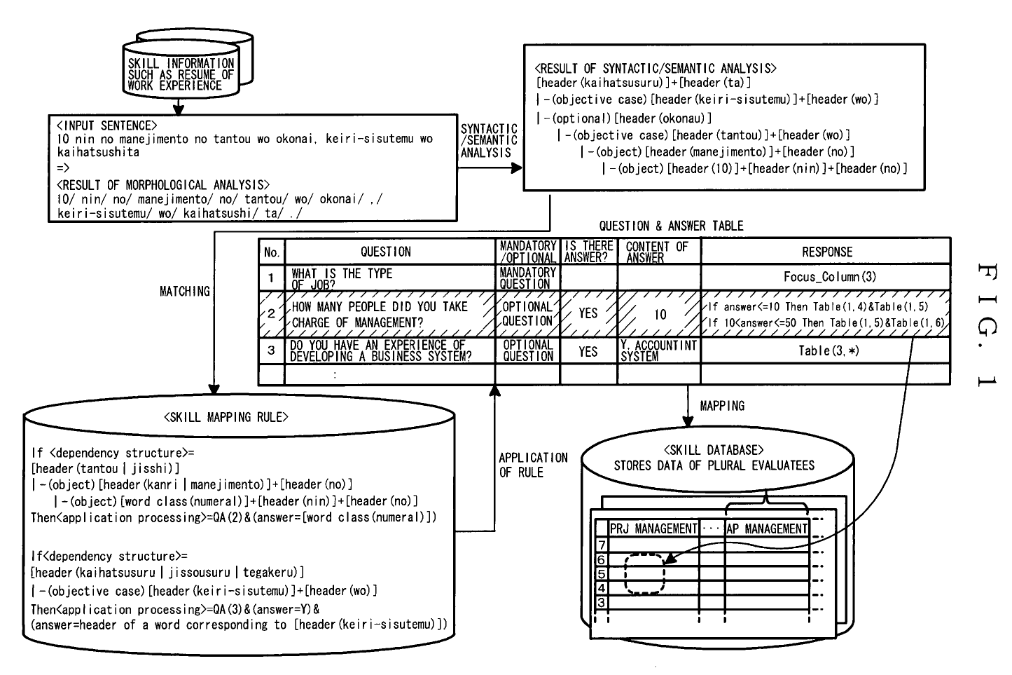

In the description of the first embodiment hereinbelow, with reference to FIGS. 1 to 10, a concept of the skill evaluation apparatus according to the first embodiment ([1-1: Concept of Skill Evaluation Apparatus]), a structure of the skill evaluation apparatus according to the first embodiment ([1-2: Structure of Skill Evaluation Apparatus]), a process sequence of the skill evaluation apparatus according to the first embodiment ([1-3: Process Sequence of Skill Evaluation Apparatus]), advantages of the skill evaluation apparatus according to the first embodiment ([1-4: Advantages]), and other embodiments of the skill evaluation apparatus ([1-5: Other Embodiments of Skill Evaluation Apparatus]) are described.

Hereinbelow, the term “syntactic/semantic structure” is also referred to as a “dependency structure” or a “result of syntactic analysis,” and the term “morphological structure” is also referred to as a “result of morphological analysis,” a “morpheme list,” or a “word list.” These should be understood as denoting the same, respectively.

[1-1: Concept of Skill Evaluation Apparatus]

The concept of the skill evaluation apparatus according to the first embodiment is described. FIG. 1 is an explanatory diagram of the concept of the skill evaluation apparatus according to the first embodiment. As shown in FIG. 1, the skill evaluation apparatus prepares in advance a skill mapping rule (skill-associating rule) for association of a skill sentence which describes a skill with a Q&A table for skill evaluation, finds a match in each sentence in a document such as a resume of work experience written in a natural language with the skill mapping rule, and if there is a match, automatically creates an answer to the Q&A table from a matched sentence.

Specifically, the skill evaluation apparatus prepares the skill mapping rule in advance which includes a conditional part which is a data structure of a result of a syntactic analysis and a semantic analysis of the skill sentence written in the natural language that would be used as an answer to the Q&A table for the skill evaluation, and an executing part which associates the answer to a corresponding item in the Q&A table. The skill evaluation apparatus analyses the syntax and the semantics of each sentence in the document such as the resume of work experience written in the natural language, checks if the analyzed sentence matches with any conditional part of the skill mapping rule, and if there is a match, determines that the pertinent sentence is the skill sentence, and creates an answer from the pertinent skill sentence for an item associated therewith by the executing part of the skill mapping rule.

For example, if the resume of work experience includes a sentence such as “10 nin no manejimento no tantou wo okonai, keiri-sisutemu wo kaihatsushita. (JE)” (“I took charge of management of 10 people, and developed an accounting system. (EE)”), the result of the morphological analysis for the sentence is a word list such as “10/nin/no/manejimento/ no/tantou/wo/okonai//keiri-sisutemu/wo/kaihatsushi/ta/./ (JE)” (“I/ took/charge/of/management/of/10/ people/,/and/developed/an/ accounting system/./ (EE)”).

Then, the result of the syntactic analysis and the semantic analysis on the Japanese word list is:

```
[header(kaihatsusuru)]+[header(ta)]
|-(objective case)[header (keiri-sisutemu)]+[header(wo)]
|
|-(optional)[header (okonau)]
  |-(objective case)[header(tantou)]+[header(wo)]
    |-(object)[header(manejimento)]+[header(no)]
      |-(object)[header(10)]+[header(nin)]+[header(no)].
(JE)
[header(develop)]
|-(objective case)[header(accounting system)]
|  |-(optional)[header(an)]
|
|-(optional)[header(take)]
  |-(objective case)[header(charge)]
  |  |-(object) [header(of)]+ [header(management)]
  |  |-(object) [header(of)]+ [header(10)]+[header(people)]
  |-(subject)[header(I)]
(EE)
```

In the result of the syntactic analysis shown above, “|” and “|-” are descriptive symbols used to indicate that a node (word) and a node (word) are related with each other in a predetermined dependency relation such as a super-subrelation.

After the analysis above is finished, the part,

```
|-(objective case)[header(tantou)]+[header(wo)]
  |-(object)[header(manejimento)]+[header(no)]
    |-(object)[header(10)]+[header(nin)]+[header(no)]
(JE)
|-(objective case)[header(charge)]
  |-(object) [header(of)]+ [header(management)]
    |-(object) [header(of)]+ [header(10)]+[header(people)]
(EE)
```

is found to match with the conditional part in the skill mapping rule, whereby “10 nin no manejimento (JE)” (“management of 10 people (EE)”) is found to be an answer to a second question “How many people did you take charge of management?” in the Q&A table.

Here, the information contained in each node (word) included in the result of the syntactic analysis shown above also provides grammatical and semantic information such as word class, conjugation, and semantics, other than the information as shown above. The above is merely a representation provided for convenience. To simplify the description, the result of the syntactic analysis is sometimes shown only with headers, and information denoting the inter-node relations (such as the terms “objective case” and “optional” enclosed by parenthesis in the above example) is omitted from the description. These should be understood as to signify the complete representation of stored data of the syntactic analysis.

For example, the result of the syntactic analysis shown above can be described only with headers as:

```
[kaihatsusuru]+[ta]
|-[keiri-sisutemu]+[wo]
|
|-[okonau]
  |-[tantou]+[wo]
    |-[manejimento]+[no]
      |-[10]+[nin]+[no].
(JE)
[develop]
|- [accounting system]
|  |-[an]
|
|-[take]
  |-[charge]
  |  |-[of]+ [management]
  |  |-[of]+ [10]+[people]
  |-[I]
(EE)
```

Here, the description “QA(2)” in the executing part means that the portion of the document matched with the conditional part should be associated with the second question in the Q&A table. Further, the description “Table(1,4)&Table(1,5)” in a second box of “RESPONSE” column of the Q&A table means that the answer to the question, i.e., the extracted skill item (content of answer), is associated with data items specified by (1,4) and (1,5) and stored in the skill database.

When the questions in the Q&A table are categorized into two categories, i.e., “a question to which the answer is mandatory,” and “a question to which the answer is optional,” and the category of the question (mandatory/optional) is stored in the Q&A table, even if a supplied document does not contain enough information on skills, it would be possible to supplement information only for the mandatory question. Thus, even if the Q&A table includes a vast amount of questions, an efficient skill evaluation can be carried out with the use of mandatory information alone.

The skill database is a database which stores skill items of the evaluatee. In the skill database, data is stored for each evaluatee in a two-dimensional matrix format where a horizontal direction (row) represents types of skill items (i.e., skill categories: skill categories are set according to the job types. The skill category is further divided into sub-categories.), and a vertical direction (column) represents skill level for each skill item.

The first number in the parenthesis ( ) shown above indicates the location along the horizontal (row) direction in the skill database, which denotes a skill category set for each job type. The second number in the parenthesis indicates the location along the vertical (column) direction in the skill database, which denotes a skill level in a pertinent skill category.

When the result of the syntactic analysis matches with the skill mapping rule, the skill item is not only extracted, but is associated with a data item (data storing location) in the skill database. Such association indicates “in which skill level of which skill item (skill category)” the corresponding data should be categorized.

Thus, when the match with the skill mapping rule is found, the skill item is extracted, the skill level for the extracted skill item is evaluated, and the location in the skill database at which the corresponding data should be stored (associated with) is known. In other words, when the match with the rule is found, the skill evaluation for one skill is finished.

Further, the portion,

[header(kaihatsusuru)]+[header(ta)]
|-(objective case)[header(keiri-sisutemu)]+[header(wo)]
(JE)
[header(develop)]
|-(objective case)[header(accounting system)]
|-(optional)[header(an)]
(EE)

matches with another conditional part of the skill mapping rule, and “keiri-sisutemu wo kaihatsushita (JE)” (“developed an accounting system (EE)”) is found to be an answer to a third question in the Q&A table, i.e., “Do you have an experience of developing a business system?” The response to this answer, “Table(3,*)” means that the answer is associated with a data item in the location specified by (3,*) in the skill database (here, [*] denotes any skill level (any location along the column)).

Then, according to the association with the data item in the skill database specified in the column of “RESPONSE,” the answer (skill item) to the Q&A table is stored in the pertinent location in the skill database. For example, a skill item deduced from the answer “10 nin no manejimento (JE)” (“management of 10 people (EE)”) is stored in a location of a data item in a skill category related with the project management (PRJ management) in the skill database, whereas a skill item deduced from the answer “keiri-sisutemu wo kaihatsushita (JE)” (“developed an accounting system (EE)”) is stored in a location of a data item in a skill category related with the application development (AP development) in the skill database.

Various skill items may be stored in the same location in the skill database. For example, when a skill sentence which states that the evaluatee developed “keiri-sisutemu (JE)” (“an accounting system (EE)”) and “jinji-sisutemu (JE)” (“a personnel management system (EE)”) is evaluated, the skill items “keiri-sisutemu wo kaihatsu (JE)” (“developed an accounting system (EE)”) and “jinji-sisutemu wo kaihatsu (JE)” (“developed a personnel management system (EE)”) are expected to be stored in the same data item location. The evaluatee can be evaluated to have a higher skill level when one location (data item) stores many skill items.

Thus, the skill evaluation apparatus according to the first embodiment prepares the skill mapping rule which includes the conditional part which is the data structure representing the result of the syntactic analysis/semantic analysis of the skill sentence, finds a match between the result of the syntactic analysis/semantic analysis of each sentence in the document such as a resume of work experience with the conditional part in the skill mapping rule, and if a match is found, creates the answer to the Q&A table from the sentence, thereby making it possible to automatically extract the skill item from the document such as a resume of work experience written in the natural language, and to evaluate the evaluatee.

[1-2: Structure of Skill Evaluation Apparatus]

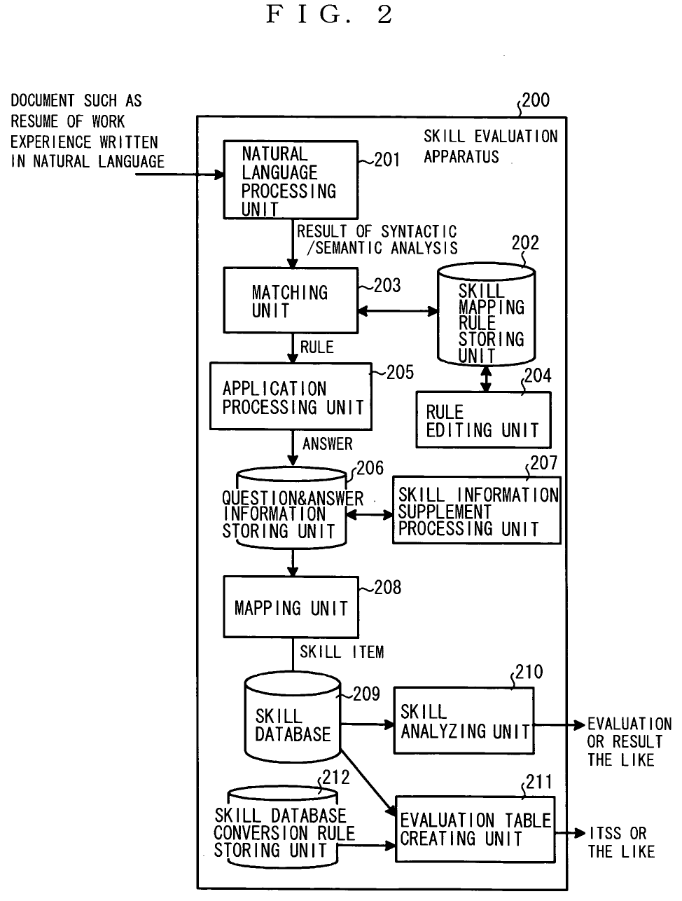

Next, the structure of the skill evaluation apparatus according to the first embodiment is described. FIG. 2 is a functional block diagram of the structure of the skill evaluation apparatus according to the first embodiment. As shown in FIG. 2, a skill evaluation apparatus 200 includes a natural language processing unit 201, a skill mapping rule storing unit 202, a matching unit 203, a rule editing unit 204, an application processing unit 205, an Q&A information storing unit 206, a skill information supplement processing unit 207, a mapping unit 208, a skill database 209, a skill analyzing unit 210, an evaluation table creating unit 211, and a skill database conversion rule storing unit 212.

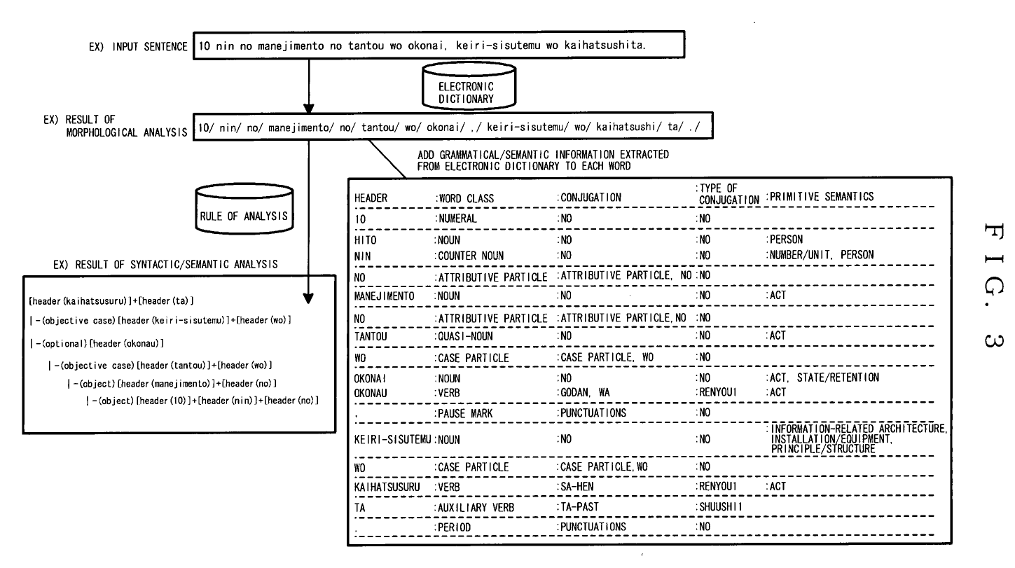

The natural language processing unit 201 is a processor which receives an input of a document such as a resume of work experience written in a natural language and performs the syntactic analysis and the semantic analysis thereon. FIG. 3 is an explanatory diagram of the natural language processing by the natural language processing unit 201.

As shown in FIG. 3, the natural language processing unit 201, on receiving an input of a sentence “10 nin no manejimento no tantou wo okonai, keiri-sisutemu wo kaihatsushita. (JE)” (“I took charge of management of 10 people, and developed an accounting system. (EE)”), for example, performs the morphological analysis using an electronic dictionary to obtain a word list “10/nin/no/manejimento/no/tantou/wo/okonai/,/ keiri-sisutemu/wo/kaihatsushi/ta/./(JE)” (“I/took/charge/of/ management/of/10/people/,/and/developed/an/accounting/system/./ (EE)”) as a result of the analysis. Further, the natural language processing unit 201 adds grammatical/semantic information such as word class, conjugation, type of conjugation, semantics, or the like for each word delineated by a slash (/). In FIG. 3, the term “GODAN” means “fifth group,” the term “SA-HEN” means “sa-row irregular conjugation” (“sa-gyo henhaku katsuyo (JE”)), and the term “TA-PAST” means “conjugation of past auxiliary verb “ta.”

For example, to the word “10”, added grammatical/semantic information is: “numeral” as the word class; “no conjugation” as the conjugation; and “no conjugation” as the type of conjugation. To the word “nin (JE)” (“people(EE)”) since the Japanese term “nin (JE)” (“people (EE)”) denoted by the Chinese character “ [symbol] ,” can be interpreted as two different morphemes, the term is regarded as to have plural word classes. For one morpheme (word) “hito (JE)” (“people (EE)”) corresponding to “ [symbol] ,” added grammatical/semantic information is: “noun” as the word class; “no conjugation” as the conjugation; “no conjugation” as the type of conjugation; and “person” as the primitive semantics. For another morpheme (word)“nin (JE)” (“people (EE)”) corresponding to “ [symbol] ,” added grammatical/semantic information is: “counter noun (tanni-meishi (JE))” as the word class; “no conjugation” as the conjugation; “no conjugation” as the type of conjugation; and “number/unit, person” as the primitive semantics.

Then, through the syntactic analysis and the semantic analysis based on an analysis rule on the results of morphological analysis, the following result of the syntactic/semantic analysis is obtained:

```
[header (kaihatsusuru)]+[header(ta)]
|-(objective case)[header(keiri-sisutemu)]+[header(wo)]
|
|-(optional)[header (okonau)]
  |-(objective case)[header (tantou)]+[header(wo)]
    |-(object)[header (manejimento)]+[header (no)]
      |-(object)[header (10)]+[header (nin)]+[header(no)].
(JE)
[header(develop)]
|-(objective case)[header(accounting system)]
|  |-(optional)[header(an)]
|
|-(optional)[header(take)]
  |-(objective case)[header(charge)]
  |  |-(object) [header(of)]+ [header(management)]
  |  |-(object) [header(of)]+ [header(10)]+[header(people)]
  |-(subject)[header(I)]
(EE)
```

In the result of the syntactic/semantic analysis shown above, “|” and “|-” are descriptive symbols used to indicate that a node (word) and a node (word) are related with each other in a predetermined dependency relation such as a super-subrelation. The term “optional” in the parenthesis ( ) immediately after the symbol indicates that the inter-word relation is optional, and the term “objective case” indicates that the word is used as the objective case. These terms corresponds with the case relation (subjective case, objective case, accusative case (aite-kaku (JE)), or the like) or the relation to attribute (subject, object, possession, or the like) in the natural language processing.

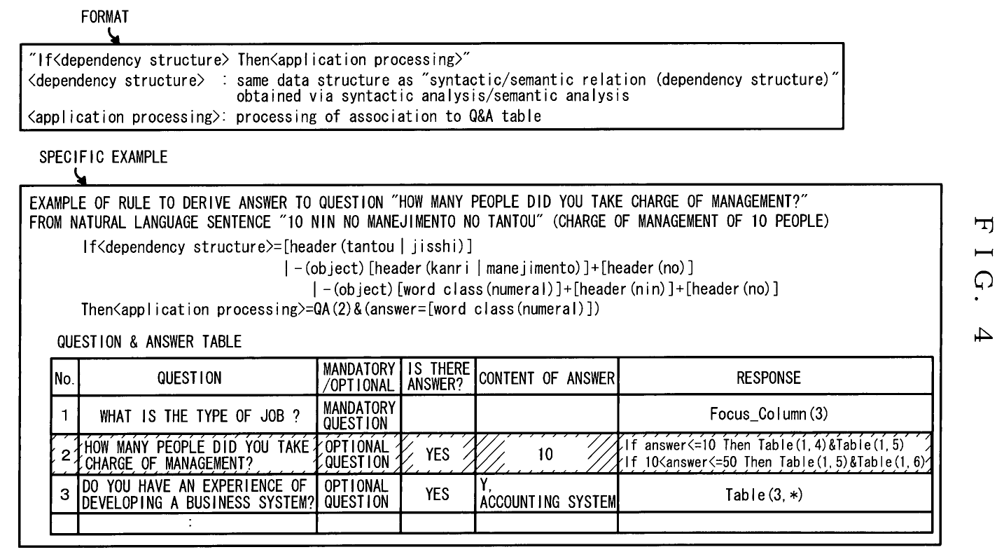

The skill mapping rule storing unit 202 is a memory that stores the skill mapping rule. FIG. 4 is a diagram of the skill mapping rule and more particularly, shows a format of the skill mapping rule and a specific example thereof.

As shown in the “FORMAT” of FIG. 4, the skill mapping rule has a format constituted from a conditional part and an executing part, such as “If<dependency structure> Then<application processing>.” Here, <dependency structure>in the conditional part has the same data structure as “syntactic/semantic relation (dependency structure)” obtained via the syntactic/semantic analysis. On the other hand, <application processing> in the executing part is a process of association to the Q&A table.

Further, as shown in the “SPECIFIC EXAMPLE” in FIG. 4, the skill mapping rule to derive the answer to the second question “How many people did you take charge of manage?” from a natural language phrase “10 nin no manejimento no tantou (JE)” (“charge of management of 10 people (EE)”), for example, is:

```
If <dependency structure>=
[header (tantou | jisshi)]
|-(object)[header(kanri | manejimento)]+[header(no)]
  |-(object)[word class(numeral)]+[header(nin)]+[header(no)]
Then <application processing>=QA(2)&(answer=[word class(numeral)].
(JE)
If <dependency structure>=
[header (charge | implementation)]
|-(object)[header(supervision | management)]
  |-(object)[word class(numeral)]+[header(people)]
Then <application processing>=QA(2)&(answer=[word class(numeral)].
(EE)
```

Here, “|” in parentheses represents OR condition. In other words, “tantou | jisshi (JE)” means “tantou (JE)” or “jissi (JE)” and “charge | implementation (EE)” means “charge (EE)” or “implementation (EE).” In the above example, the inter-node relation is limited to “(object),” though the application can be expanded to an optional relation, so that the inter-node relation is described as “(optional).”

When the skill mapping rule is applied, a box for the second question “How many people did you take charge of management?” in the column of “is there answer?” in the Q&A table is checked as “YES,” according to the executing part “QA(2)”, and “10” in the skill sentence is stored as the answer according to the part “(answer=[word class(numeral)])” (the word class of the header “10” is numeral.).

Here, any terms in the skill sentence, as in the above example of the answer, or the entire skill sentence can be stored as the skill item as the answer information. Further, to the question in the YES/NO format, the rule can be described as “(answer=Y)” and “(answer=N)” so that the sentence can be treated as equivalent to the answer “Yes” or “No.”

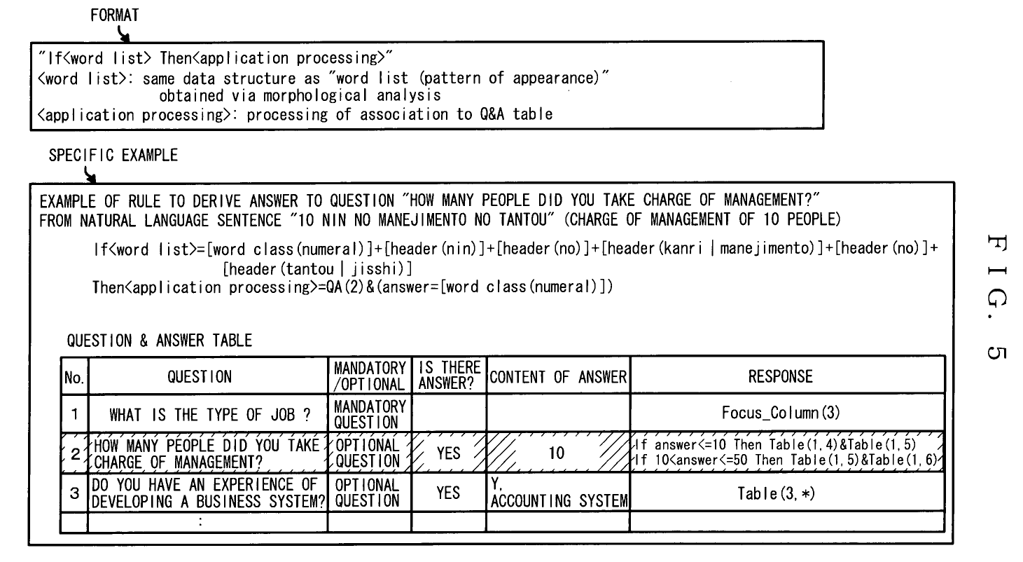

FIG. 5 is a diagram of another skill mapping rule and more particularly, shows another format of the skill mapping rule and a specific example thereof.

As shown in “FORMAT” in FIG. 5, the skill mapping rule has a format “If <word list> Then <application processing>.” Here, <word list> has the same data structure as the “word list (pattern of appearance)” obtained via the morphological analysis.

Further, as shown in “SPECIFIC EXAMPLE” in FIG. 5, the skill mapping rule to derive the answer to the question “How many people did you take charge of management?” from the natural language sentence “10 nin no manejimento no tantou (JE)” (“charge of management of 10 people (EE)”),” for example, is:

If <word list>=
[word class (numeral)]+[header(nin)]+[header (no)]
+[header (kanri | manejimento)]+[header (no)]+[header(tantou | jisshi)]
Then <application processing>=QA(2)&(answer=[word class(numeral)].
(JE)
If <word list>=
[header(charge | implementation)]+[header (supervision | management)]
+[word class (numeral)]+[header(people)]
+[header (supervision | management)]+[header(charge | implementation)]
Then <application processing>=QA(2)&(answer=[word class(numeral)].
(EE)

When the skill mapping rule is applied, a box for the second question “How many people did you take charge of management?” in the column of “is there answer?” in the Q&A table is checked as “YES,” according to the executing part “QA(2)”, and “10” in the skill sentence is stored as the answer according to the part “(answer=[word class(numeral)])” (the word class of the header “10” is numeral.).

Here, any terms in the skill sentence, as in the above example of the answer, or the entire skill sentence can be stored as the skill item as the answer information. Further, to the question in the YES/NO format, the rule can be described as “(answer=Y)” and “(answer=N)” so that the sentence can be treated as equivalent to the answer “Yes” or “No.”

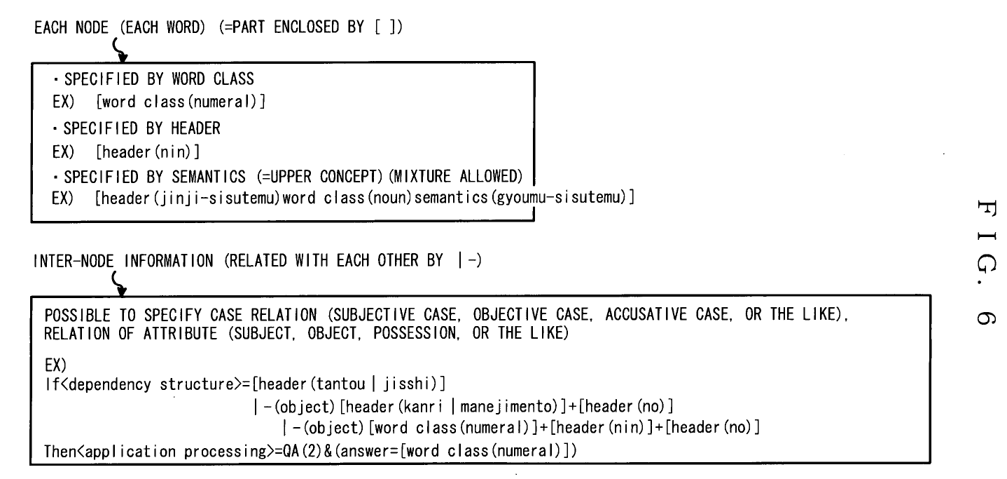

FIG. 6 is a diagram of information which can be specified in the conditional part of the skill mapping rule. As is shown by “EACH NODE” in FIG. 6, information that can be specified in each node in the conditional part, i.e., a part demarcated by “[ ]”, may include semantics (upper concept) in addition to the word class, the header, or the like. For example, “[header(jinji-sisutemu)word class(noun)semantics(gyoumu-sisutemu)] (JE)” means that “jinji-sisutemu (JE) (“personnel management system (EE)”) is one type of the “gyoumu-sisutemu (JE)” (“business system (EE)”).

Further, as shown by “INTER-NODE INFORMATION” in FIG. 6, inter-node information in <dependency structure> can specify the case relation (subjective case, objective case, accusative case, or the like) and the relation of attribute (subject, object, possession, or the like).

For example, in the skill mapping rule,

```
If <dependency structure>=
[header (tantou | jisshi)]
|-(object)[header(kanri|manejimento)]+[header(no)]
  |-(object)[word class(numeral)]+[header(nin)]+[header(no)]
(JE)
If <dependency structure>=
[header (charge | implementation)]
|-(object)[header(supervision | management)]
  |-(object)[word class(numeral)]+[header(people)]
(EE)
```

Then <application processing>=QA(2)&(answer=[word class(numeral)], “kanri|manejimento (JE)” is the “object” of “tantou (JE)”, meaning that someone is in charge of (tantou (JE)) management (kanri, or manejimento (JE)), and “● nin (JE)” is the “object” of “kanri (JE)”, meaning that someone is “supervising (kanri (JE)) ● people.”

In addition, since plural OR conditions can be described for the header and other elements, a variety of sentences and words can be properly handled. Further, the “semantics” description can be used to accommodate variation in description in the processed document. Thus, proper handling is possible without the increase in the number of skill mapping rules. Further, “*” can be used as a wild card so that any desirable term can be processed as a matched term. Thus, the <dependency structure> described in the conditional part of the skill mapping rule has the same data structure as the dependency structure of the results of the syntactic/semantic analysis. Similarly, the <word list> described in the conditional part of the skill mapping rule has the same data structure with the word list of the results of the morphological analysis.

The matching unit 203 shown in FIG. 2 is a processor which receives the results of the syntactic/semantic analysis from the natural language processing unit 201 and finds a match between the same and the skill mapping rule stored in the skill mapping rule storing unit 202.

Specifically, the matching unit 203 compares the results of the syntactic/semantic analysis performed by the natural language processing unit 201 with the conditional part of the skill mapping rule, and searches for a skill mapping rule whose conditional part has the same dependency structure with that of the results of the syntactic/semantic analysis.

Thus, since the matching unit 203 performs a matching process on the results of the syntactic/semantic analysis of each sentence in the supplied document and the conditional part of the skill mapping rule, it is possible to select a skill sentence from the document written in the natural language and to extract a skill item.

The rule editing unit 204 is a processor that edits the skill mapping rule storing unit 202. Specifically, the rule editing unit 204 performs operations such as addition of a skill mapping rule to the skill mapping storing unit 202, and correction or deletion of a skill mapping rule stored in the skill mapping storing unit 202.

The application processing unit 205 is a processor that deals with the executing part of the skill mapping rule found as a match by the matching unit 203. Specifically, the application processing unit 205 extracts the skill item from the skill sentence and evaluates the same to generate an answer to a question in the Q&A table associated therewith by the executing part.

Since the application processing unit 205 generates an answer to the question associated therewith by the executing part of the skill mapping rule among the questions in the Q&A table, it is possible to generate an answer to the Q&A table from the skill sentence.

The Q&A table information storing unit 206 is a memory that stores the Q&A table for the skill evaluation, in which the question and the answer are stored in association with each other. The application processing unit 206 writes the generated answer into the Q&A table in the Q&A table information storing unit 206.

Here, plural answers can be stored for each question. For example, when answers (results of skill evaluation) such as “develop an accounting system” or “develop a personnel management system” are extracted from the skill sentence, both of them can be stored as an answer to the third question in the Q&A table of FIG. 5, i.e., “Do you have an experience of developing a business system?” according to the skill mapping rule.

The skill information supplement processing unit 207 is a processor to supplement the Q&A table with an answer which is not acquired/generated by the application processing unit 206. The skill information supplement processing unit 207 acquires an answer from the evaluatee as necessary and writes the same into the Q&A table stored in the Q&A table information storing unit 206. Alternatively, the skill information supplement processing unit 207 may write only an answer to a mandatory question to the Q&A table among questions to which the answer is not generated by the application processing unit 206.

The mapping unit 208 is a processor which generates the skill database 209 from the information in the Q&A table stored in the Q&A information storing unit 206. Specifically, the mapping unit 208 associates the answers appear on the Q&A table with the data items in the skill database 209 according to the description in the “RESPONSE” column of the Q&A table.

The description in the “RESPONSE” column of the Q&A table provides information on which data item corresponding to which skill level of which skill category in the skill database the extracted skill item (answer) should be stored in. The storage of a skill item (answer) in the skill database is equivalent to the storage of the result of evaluation of a skill level for one skill category.

Further, dynamic control of the data item to be associated with the answer is made possible with the description in the “RESPONSE” column of the Q&A table (in other words, description of branched conditioning is allowed in the “RESPONSE” column). For example, the answer “(management of) 10 (people)” can be associated with the data item of skill level 3, whereas the answer “(management) 50 (people)” can be associated with the data item of skill level 4.

The skill database 209 is a database which stores the result of skill evaluation of the evaluatee. In the skill database 209, the types of the skill items are indicated along the horizontal direction (row) (skill items are largely classified by the job types and the skill items in each job type are further classified into subcategories), and the levels of skill are indicated along the vertical direction (column). Thus, the skill database 209 stores the data in a two-dimensional matrix format for each evaluatee.

Thus, the skill items in, for example, the skill category of the evaluatee's experience of application development (AP development) and the skill category of the evaluatee's experience on project management (PRJ management) can be stored in the locations of data items of corresponding skill levels.

The skill analyzing unit 210 is a processor that displays the results of the analysis/evaluation of the skill of the evaluatee, for example, based on the results of the skill evaluation stored in the skill database 209. Further, the skill analyzing unit 210 gathers the results of the skill evaluation for all evaluatees stored in the skill database 209 together and analyses the trends thereof to display the results.

The evaluation table creating unit 211 converts the results of skill evaluation stored in the skill database 209 into a skill evaluation table in a desired format based on the skill database conversion rule stored in the skill database conversion rule storing unit 212, to supply the results as an output. This process allows creation of a skill evaluation table in a form complying, for example, with the ITSS formulated by the Japanese Ministry of Economy, Trade and Industry.

The evaluation table creating unit 211 of course is able to output the results of the evaluation in the skill database without applying the skill database conversion rule, in other words, is able to output the skill evaluation table including the skill categories and skill levels described in the same format as stored in the skill database.

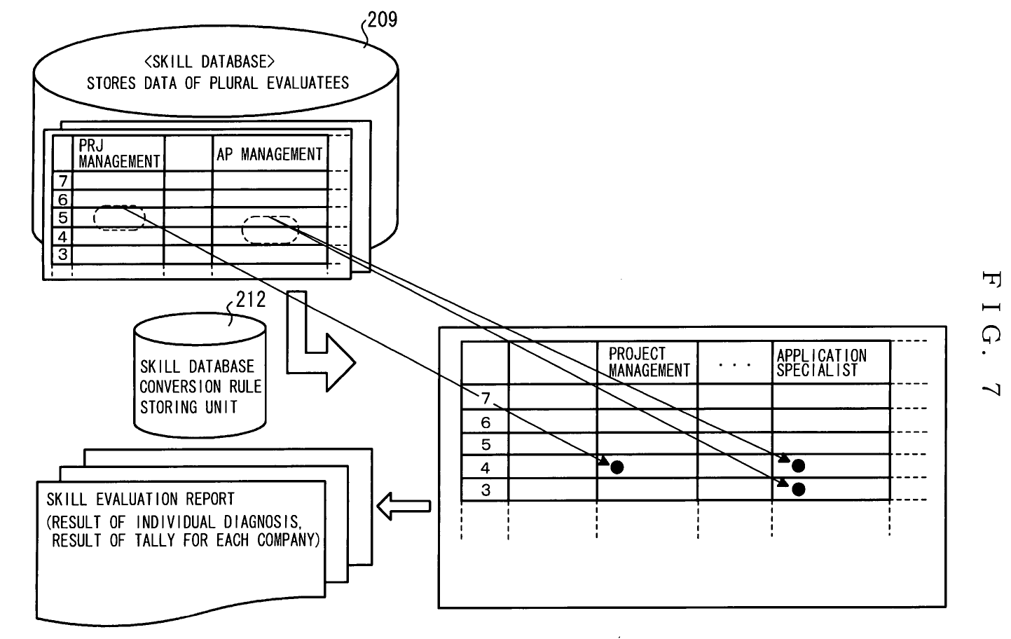

FIG. 7 is an explanatory diagram of the correspondence between the skill database 209 and the ITSS. As is seen from FIG. 7, the skill items concerning the PRJ management or the AP development stored in the skill database 209 can be associated with skill items concerning a project management or an application specialist in the ITSS. Thus, when the skill database 209 is associated with the ITSS, a predetermined report on skill evaluation can be created following the ITSS.

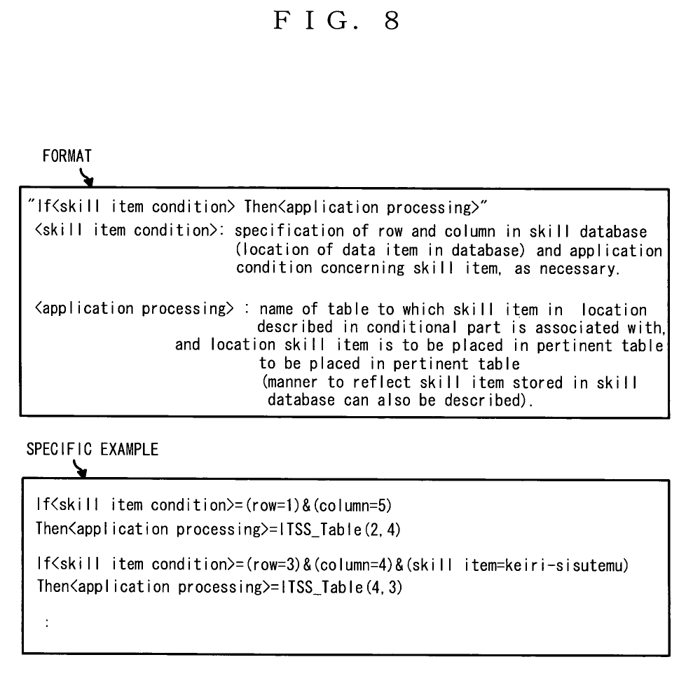

The skill database conversion rule storing unit 212 stores the skill database conversion rule which is utilized for the conversion of the results of skill evaluation stored in the skill database 209 into the skill evaluation table in a desired format. The skill database conversion rule is described in a format as shown in FIG. 8.

The conditional part of the skill database conversion rule can specify a row and a column in the skill database 209 (i.e., the location of the data item in the skill database 209), and the condition to be applied to the skill item as necessary. The executing part of the skill database conversion rule describes processing such as matching of the skill item (result of evaluation) located in a position specified in the conditional part to a predetermined position in an evaluation table with a desired format, use of the skill item stored in the skill database 209 without change, or storage of the results after a certain operation (e.g., converting the results of skill evaluation to a score according to a predetermined scoring system).

Here, the condition to be applied to the skill items may be described only when necessary. At the conversion, if the conditional part includes a skill database conversion rule which matches with all rows and columns in the skill database 209, executing part is sequentially applied.

Specifically, the skill database conversion rule is described as shown in FIG. 8, for example. FIG. 8 is an example of the skill database conversion rule for converting the data in the skill database 209 into an evaluation table complying with the ITSS.

[1-3: Process Sequence of Skill Evaluation Apparatus]

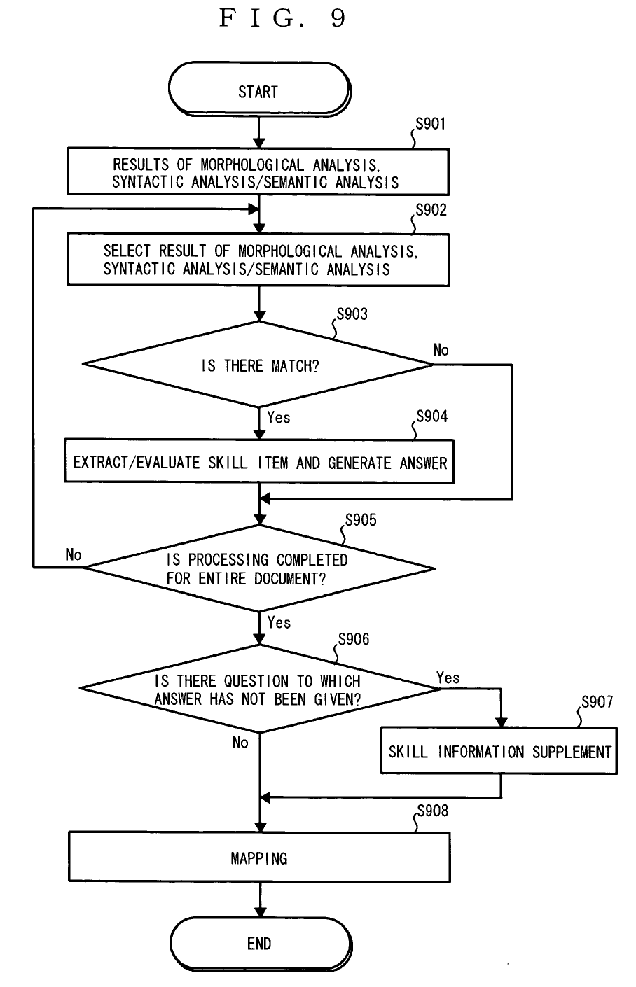

Next, the process sequence of the skill evaluation apparatus 200 according to the first embodiment is described. FIG. 9 is a flowchart of the process sequence of the skill evaluation apparatus 200 according to the first embodiment. As shown in FIG. 9, the skill evaluation apparatus 200 receives the document written in a natural language at the natural language processing unit 201 and performs the morphological analysis and the syntactic/semantic analysis thereon (step S901).

Then, the matching unit 203 sequentially selects the result of the morphological/syntactic analysis on the document performed by the natural language processing unit 201 (step S902) and determines whether there is a skill mapping rule whose conditional part matches with the selected result of the morphological/syntactic analysis (step S903).

When, as a results, there is a skill mapping rule with the conditional part that matches with the selected result of the morphological/syntactic analysis, the application processing unit 205 extracts the skill item from the result of the morphological/syntactic analysis (or the input document) selected by the matching unit 203, evaluates the extracted skill item, to generate an answer to a question which the result is associated with by the executing part of the matched skill mapping rule (step S904). On the other hand, when there is no skill mapping rule which has the conditional part matching with the selected result of the morphological/syntactic analysis, the application processing unit 205 does not perform any processing on the result of the morphological/syntactic analysis (input document).

Then, the skill evaluation apparatus 200 checks if the processing of the entire document has been finished or not (step S905). When the processing of the entire document has not been completed, the skill evaluation apparatus 200 returns to step S902 and starts processing a next sentence. On the other hand, when the processing of the entire document has been finished, the skill evaluation apparatus 200 checks if there is a question to which an answer has not been given in the Q&A table (step S906). When the skill evaluation apparatus 200 finds a non-answered question, the skill information supplement processing unit 207 performs a skill information supplement process by acquiring an answer from the evaluatee, for example (step S907).

Here, questions in the Q&A table may be classified into a mandatory question and an optional question, and such information may be provided in the Q&A table. Then, the skill information supplement processing unit 207 may perform the supplement process only on the mandatory question. Then, an efficient skill evaluation can be carried out only with necessary information regardless of the amount of the questions.

Then, the mapping unit 208 performs a process as described in the “RESPONSE” box of the Q&A table stored in the Q&A information storing unit 206, thereby storing the skill item in the location of a data item with a predetermined skill category and a skill level in the skill database 209 (step S908).

When there are many evaluatees, the Q&A table, data (table) in the skill database 209, or the like are generated for each evaluatee in the above-described process.

Thus, the matching unit 203 performs the matching process between the sentence analyzed by the natural language processing unit 201 and the skill mapping rule; the application processing unit 205 generates an answer to the Q&A table when there is a skill mapping rule matching with the analyzed sentence using the executing part of the skill mapping rule; and mapping unit 208 maps the answer in the Q&A table into the data item in the skill database 209 to store the answer in the skill database 209, whereby the skill item can be extracted from the document written in the natural language for evaluation and be stored in the skill database 209.

[1-4: Advantages]

As can be seen from the foregoing, in the skill evaluation apparatus 200 according to the first embodiment: the natural language processing unit 201 performs the syntactic analysis and the semantic analysis on each sentence in the document, e.g. a resume of work experience, written in the natural language; the skill mapping rule storing unit 202 stores the skill mapping rule associating the skill item and the question item in the Q&A table; the matching unit 203 finds a match between each sentence analyzed by the natural language processing unit 201 and the skill mapping rule; the application processing unit 205 generates an answer to a question item which is associated with a matched sentence found by the matching unit 203 according to the skill mapping rule and stores the answer in the Q&A information storing unit 206; and the mapping unit 208 maps the answer stored in the Q&A information storing unit 206 to the data item in the skill database 209, whereby the skill database 209 can be automatically generated from the sentences written on the skill in the natural language.

A skill evaluation by automatic extraction of skill items from the document written in the natural language performed, for example, in the skill evaluation apparatus 200 described in the first embodiment above has the following advantages.

(1) Specific Skill-Related Name (Product Name, Name of Technique, etc) can be Extracted

The skill evaluation apparatus 200 according to the first embodiment can extract a specific skill-related name such as a “product name” or a “name of technique” from information written in the natural language.

For example, if the document in the natural language includes descriptions such as “I developed a personnel management system,” “I developed an accounting system,” “I developed an ABC system,” (assume that “ABC” is a name of a business system specific to a certain company), all descriptions are treated as being equivalent to answer to the question “Do you have an experience of developing a business system?” with “YES.” In addition, specific skill-related names such as “personnel management system,” “accounting system,” “ABC system” can be obtained.

To allow such processing, a following technique can be employed. First, a “product name” or a “name of technique” is registered in a dictionary for natural language processing as a header. The semantics (which can be interpreted as a header with an upper concept) is registered for each header (word). The application condition of the skill mapping rule is described and specified not by the header but by the semantics, and the executing part is described so that the registered skill-related names are associated with the question concerning the registered semantics (i.e., header with upper concept). Alternatively, the headers of a “product name” or a “name of technique” may be described in the application condition of the skill mapping rule with the use of OR conditioning, and associated with the question concerning an “upper concept” thereof in the executing part.

Specifically, when the application condition of the skill mapping rule is to be specified not by the header but by the semantics, following data is registered in the dictionary, for example.

1:The term “gyoumu-sisutemu (JE) (business system (EE))” is registered as the semantics (header with upper concept) for the header “jinji-sisutemu (JE) (personnel management system (EE)).”

2:The term “gyoumu-sisutemu (JE)” (“business system (EE)”) is registered as the semantics (header with upper concept) for the header “keiri-sisutemu (JE)” (“accounting system (EE)”).

3:The term “gyoumu-sisutemu (JE)” (“business system (EE)”) (or “keiri-sisutemu (JE)” (“accounting system (EE)”) is registered as the semantics (header with upper concept) for the header “ABC-sisutemu (JE) (“ABC system (EE)”).

The skill mapping rule to derive the answer to the question “Do you have an experience of developing a business system?” from a natural language sentence “Keiri-sisutemu wo kaihatsushita (JE)” (“developed an accounting system (EE)”) can be described as follows, for example:

### EXAMPLE 1

### Using Semantics:

If <dependency structure>=
[header(kaihatsusuru|jissousuru|tegakeru)]
|-(objective case)[semantics (gyoumu-sisutemu)]+[header (wo)]
Then<application processing>=QA(3)&(answer=Y)&(answer=header
corresponding to [semantics(gyoumu-sisutemu)])
(JE)
If <dependency structure>=
[header(develop | implement | deal with)]
|-(objective case)[semantics (business system)]
Then<application processing>=QA(3)&(answer=Y)&(answer=header
corresponding to [semantics(business system)])
(EE)

### EXAMPLE 2

### Using OR for Header:

If <dependency structure>=
[header(kaihatsusuru|jissousuru|tegakeru)]
|-(objective case)[header(gyoumu-sisutemu | keiri-sisutemu |
jinji-sisutemu |
ABC-sisutemu)]+[header(wo)]
Then <application processing>=QA(3)&(answer=Y)&(answer=header
corresponding to [header(gyoumu-sisutemu|keiri-sisutemu|jinji-sisutemu|
ABC-sisutemu)])
(JE)
If <dependency structure>=
[header(develop | implement | deal with))]
|-(objective case)[header(business system | accounting system | personnel
system| ABC-system)]
Then <application processing>=QA(3)&(answer=Y)&(answer=header
corresponding to [header(business system | accounting system | personnel
system| ABC-system)])
(EE)

Thus, the header corresponding to the names of the systems in the above-described dependency structure and “Y” (YES) are extracted as the answer information to the question No. 3 (“Do you have an experience of developing a business system?”) and associated therewith.

When the actually given sentence is “2003 nendo ni keiri-sisutemu wo menbaa 5 nin no riidaa toshite kaihastushita (JE)” (“I developed an accounting system as a leader of 5 members in 2003 (EE)”), the syntactic analysis gives following dependency structure:

<dependency structure>=
[header(kaihatsusuru)]+[header(ta)]
|-[header(riidaa)]+[header(toshite)]
| |-[header(5)]+[header(nin)]+[header(no)]
|-(objective case)[header(keiri-sisutemu)]+[header(wo)]
|-(time case)[header(2003)]+[header(nendo)]+[header(ni)].
(JE)
<dependency structure>=
[header(develop)]
|- [header(as)]+[header(leader)]
| |-(optional)[header(a)]
| |-(object)[header(of)]+[header(5)]+[header(member)]
|-(objective case)[header(accounting system)]
| |-(optional)[header(an)]
|-(time case)[header(in)] +[header(2003)]
|-(subject)[header(I)]
(EE)

Then, among the nodes in the dependency structure, the node “[header(kaihatsusuru)]+[header(ta)] (JE)” (“[header(develop)] (EE)”) and the node “|-(objective case)[header(keiri-sisutemu)]+[header(wo)] (JE)” (“|-(objective case)[header(accounting system)] (EE)”) match with the rule in the above-described <Example 1> and <Example 2>, and the term “keiri-sisutemu (JE)”(“accounting system (EE)”) is extracted as the skill item.

Such a dependency structure has an additional advantage that the rule can be formulated without consideration to the order of words actually appear in the sentence, since the order of words does not significantly affect the dependency structure. For example, the sentence “2003 nendo ni keiri-sisutemu wo menbaa 5 nin no riidaa toshite kaihatsushita (JE)” (“I developed an accounting system as a leader of 5 members in 2003 (EE)”), and the sentence “menbaa 5 nin no riidaa toshite keiri-sisutemu wo 2003 nendo ni kaihatsushita (JE)” (“As a leader of 5 members, I developed an accounting system in 2003 (EE)”), match with the same rule.

<Advantage of Acquisition of Specific Skill-Related Name>

1: The viewer (user under evaluation, manager thereof) of the result of evaluation can easily understand the display and the description of the evaluation reading the extracted skill-related name.

2: Advantages concerning education planning and employment planning.

Since the specific skill whose supply is sufficient or insufficient can be easily identified even among the skills classified into the same skill category based on the description of specific skill-related names, a fine-tuned response can be made.

(2) Extraction of Detailed Information and Supplementary Information is Possible for Each Skill

The skill evaluation apparatus 200 according to the first embodiment allows the addition of detailed information and supplementary information concerning the skill level since the input is given in the form of a document in a natural language which is written by the evaluatee as he/she wants to. For example, when sentences such as “zensha no jinji-sisutemu wo kaihatsushita (JE)” (“I developed a personnel management system for entire company (EE)”), and “bunai no keiri-sisutemu wo kaihatsushita (JE)” (“I developed an accounting system for one section (EE)”), are given as inputs, the evaluation can be different for each sentence (i.e., two sentences can be interpreted as different answers), if the phrases “zensha no (JE)” (“for entire company (EE)”) and “bunai no (JE)” (“for one section (EE)”) are interpreted to indicate different skill levels (for example, the evaluation may be set higher by one level for “zensha no (JE)” (“for entire company (EE)”) than for “bunai no (JE)” (“for one section (EE)”) and the rule may be defined accordingly to apply different processing.).

Then, the evaluatee can write the document at his/her discretion and the skill evaluation apparatus 200 can deal with such document flexibly (in other words, the skill evaluation apparatus 200 can give the finely-tuned evaluation considering the “level” of the skill described by “adverb phrase” or “adjective phrase” in the sentence (length of time period, number of persons, scale, etc.)).

(3) Further Comprehensiveness of Extraction of Skill Information

The skill evaluation apparatus 200 according to the first embodiment can accept any number of pieces of information (the documents in the natural language) as far as they are related with the skill. When the skill evaluation apparatus 200 extracts the necessary information alone from such a wide variety of information, the comprehensiveness of the extracted information can be enhanced.

In addition, the skill evaluation apparatus 200 according to the first embodiment can accept any number of pieces of information (the documents in the natural language) of the past as far as they are related with the skill. When the skill evaluation apparatus 200 extracts the necessary information alone from such a wide variety of information, the comprehensiveness of the extracted information can be enhanced.

Still in addition, the skill evaluation apparatus 200 according to the first embodiment can accept any number of pieces of information about a variety of job types the evaluatee took in the past and a variety of skills the evaluatee possesses at present as far as they are related with the skill. When the skill evaluation apparatus 200 extracts the necessary information alone from such a wide variety of information, the comprehensiveness of the extracted information can be enhanced. Further, the skill evaluation apparatus 200 can evaluate the same information as to represent a skill level XX (level xx) for one job type, and to represent a skill level YY (level yy) for another job type and provide a display accordingly (Note that the skill evaluation apparatus 200 can extract the skill items without categorizing them into a certain job type.).

(4) One Question can be Associated with Various Pieces of Information as Answers

The conventional skill evaluation basically takes one answer/one evaluation value for one question. Contrarily, the skill evaluation apparatus 200 according to the first embodiment can evaluate various pieces of skill information in many sentences as answers to the same question. For example, if one document includes the sentence “Jinji-sisutemu wo kaihatsushita (JE)” (“I developed a personnel management system (EE)”), and another document includes the sentence “Keiri-sisutemu wo kaihatsushita (JE)” (“I developed an accounting system (EE)”), both sentences can be treated as an answer to the question “Do you have an experience of developing a business system?”

In addition, it is possible to give a higher evaluation by one level to the evaluatee who developed two business systems, i.e., the “personnel management system” and the “accounting system” than to the evaluatee who developed only one “personnel management system.” Still in addition, plural skill items can be extracted simultaneously from one sentence.

For example, from the sentence such as “10 nin no kanri wo okonai, jinji-sisutemu to keiri-sisutemu no kaihatsu wo okonatta (JE)” (“I took charge of management of 10 people, and developed a personnel management system and an accounting system (EE)”), “10 nin no kanri (JE)” (“management of ten people (EE)”), “jinji-sisutemu no kaihatsu (JE)” (“develop a personnel management system (EE)”), and “keiri-sisutemu no kaihatsu (JE)” (“develop an accounting system (EE)”) can be extracted as skill items.

[1-5: Other Embodiments of Skill Evaluation Apparatus]

In the first embodiment, the association with the Q&A table is performed according to the <application processing> in the executing part of the skill mapping rule. However, in the <application processing> of the skill mapping rule, associated data can be modified. Hence, the association may not be made to the Q&A table but directly to the skill database.

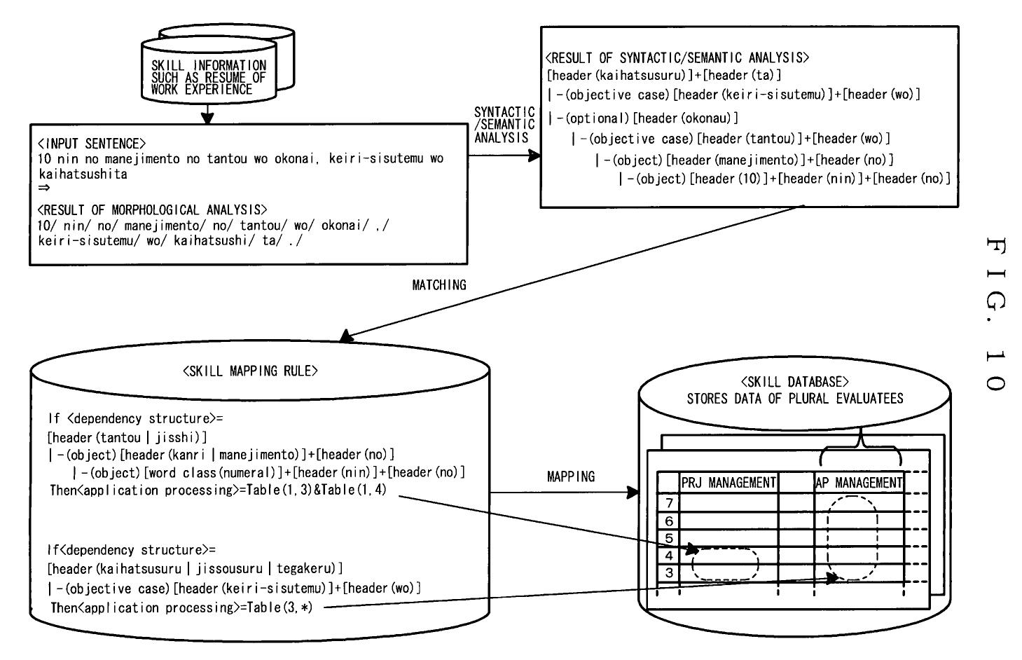

FIG. 10 is an explanatory diagram of a skill evaluation apparatus which performs the direct association to the skill database. As shown in FIG. 10, in the skill evaluation apparatus, the skill mapping rule directly associates the skill sentence written in the natural language to the skill database.

Further, though in the above, the description is given on the technique to convert the data in the skill database to the skill evaluation table complying with the ITSS or the like according to the skill database conversion rule, the data can be directly associated with a table (evaluation table, for example) or the like in a desired format such as the skill evaluation table complying with the ITSS according to the skill mapping rule.

Specifically, in a skill mapping rule:

```
If <dependency structure>=
[header(tantou | jisshi)]
|-(object)[header(kanri|manejimento)]+[header(no)]
  |-(object)[word class(numeral)]+[header(nin)]+[header(no)]
(JE)
If <dependency structure>=
[header(charge| implementation)]
|-(objective case)[header(supervision| management)]
  |-(object)[word class(numeral)]+[header(people)]
(EE)
```

Then Table(1,4)&Table(1,5), the <application processing> is “Table(1,4)&Table(1,5)” which specifies the association to the data item identified by (1,4) and (1,5) in the skill database. Further, in the part,

If <dependency structure>=
[header(kaihatsusuru | jissousuru | tegakeru)]
|-(objective case)[header(keiri-sisutemu]+[header(wo)]
(JE)
If <dependency structure>=
[header(develop | implement | deal with)]
|-(objective case)[header(accounting system)]
(EE)

Then Table(3,*), the <application processing> is “Table(3,*)” which specifies the association to the data item identified by (3,*) in the skill database (here, “*” represents any skill level (any column position)).

Thus, when the direct association to the skill database is realized by the executing part of the skill mapping rule instead of the Q&A table, an efficient creation of the skill database can be realized.

### 2: Second Embodiment (Skill Evaluation System)

In the first embodiment, the description is given on the skill evaluation apparatus which extracts the skill item from the document written in the natural language using the skill mapping rule, evaluates the extracted skill item, and stores the result in the skill database. The rule, such as the skill mapping rule, which analyzes the natural language, however, can similarly be applied to the extraction of information such as information on job vacancies (personnel search), and general information on job market from the documents written in the natural language, besides the extraction of the skill information.

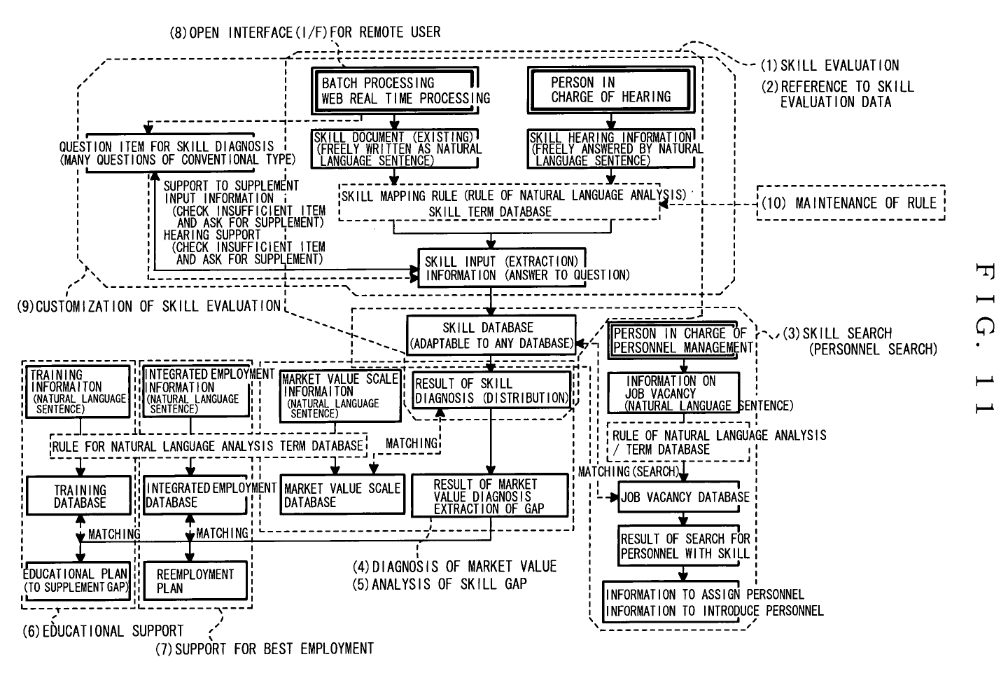

In the second embodiment, description is given on the skill evaluation system which extracts various information with the use of the rule for the natural language analysis. In the second embodiment, description is given with reference to FIGS. 11 to 15 on a functional structure of the skill evaluation system according to the second embodiment ([2-1: Functional Structure of Skill Evaluation System]), a screen structure of the skill evaluation system according to the second embodiment ([2-2: Screen Structure of Skill Evaluation System]), and a process sequence of the skill evaluation system according to the second embodiment ([2-3: Process Sequence of Skill Evaluation System]).

[2-1: Functional Structure of Skill Evaluation System]

First, the functional structure of the skill evaluation system according to the second embodiment is described. FIG. 11 is a diagram of the functional structure of the skill evaluation system according to the second embodiment.

As shown in FIG. 11, the skill evaluation system has functions such as (1) skill evaluation, (2) reference to skill evaluation data, (3) skill search (personnel search), (4) diagnosis of market value, (5) analysis of skill GAP, (6) educational support, (7) support for best employment, (8) open interface (I/F) for remote user, (9) customization of skill evaluation, and (10) maintenance of rule.

The skill evaluation function includes: fetching and shaping of skill information; the morphological analysis and the syntactic analysis of skill information; mapping of skill items extracted after the morphological/syntactic analysis into the skill database (or to the evaluation table complying with the ITSS) according to the skill mapping rule; analysis and evaluation; storage of the results of skill evaluation into the skill database; analysis of individual tendency; and compilation of data per company and output of the result of trend analysis. The skill evaluation function is one of the functions of the skill evaluation apparatus described according to the first embodiment. The function of the reference to the skill evaluation data is a function such as a display of a list of the evaluatees, and a detailed display of the results of the evaluation for each evaluatee.

The function of skill search is a function such as a search of the results of skill evaluation (skill database), a display of a list, a detailed display, and a support for the analysis of intra-company trends. In addition, according to the function of the skill search, a job vacancy item (corresponding to the skill item in the skill evaluation) is extracted from job vacancy information written in the natural language, and the extracted job vacancy item is associated with a job vacancy database (corresponding to the skill database in the skill evaluation, and having the same data structure as the skill category and the skill level in the skill database) and stored in a predetermined location according to a job vacancy mapping rule described with a similar data structure to the skill mapping rule used in the skill evaluation similarly to the skill evaluation by the skill evaluation apparatus of the first embodiment.

The job vacancy item in the job vacancy database is matched with the results of skill evaluation for all evaluatees in the skill database. When there is an evaluatee whose data matches with the job vacancy item, the evaluatee is extracted. Thus, the person with the specified skill can be found.

The function of the diagnosis of market value is a function such as determination of market value. According to the function of the market value diagnosis, a market value scale item (corresponding to the skill item in the skill evaluation) is extracted from market value scale information written in the natural language, and the extracted market value scale item is associated with a market value scale database (corresponding to the skill database in the skill evaluation, and having the same data structure as the skill category and the skill level in the skill database) and stored in a predetermined location according to a market value scale mapping rule described with a similar data structure to the skill mapping rule used in the skill evaluation similarly to the skill evaluation by the skill evaluation apparatus of the first embodiment.

The market value scale database stores a result of skill evaluation expected from a person with a standard skill in the market for each job type and for each skill level separately. The result of the skill evaluation of an evaluatee under the diagnosis of market value is matched with the data item of corresponding job type in the market value scale database. Then, the skill level of the person can be determined (i.e., the standard person in which skill level of which job type is closest to the diagnosed person is determined) for the determination of his/her market value.

The function of the skill GAP analysis is a function such as an extraction of GAP with respect to the specified job type. When a certain skill level is set as a target level in a matching condition for the person under the market value diagnosis, a GAP from the target value can be calculated.

The market value and the GAP obtained as a result of these processing have the same structure as the data item (in terms of structure of skill category or skill level) in the skill database or the data in the market value scale database.

The function of the educational support is a function such as a support to formulate an educational plan according to the skill GAP. According to the function of the educational support, a training item (corresponding to the skill item in the skill evaluation) is extracted from training information written in the natural language, and the extracted training item is associated with a training database (corresponding to the skill database in the skill evaluation, and having the same data structure as the skill category and the skill level in the skill database) and stored in a predetermined location according to a training mapping rule described with a similar data structure to the skill mapping rule used in the skill evaluation similarly to the skill evaluation by the skill evaluation apparatus of the first embodiment.

The training database stores a result of skill evaluation expected from a person with a standard skill in the market (classified according to the job type, skill level, or the like) and the name of the training item required to be categorized into each skill level (similarly to the storage of the skill-related names in the skill database). Then, the training item is extracted corresponding to the GAP detected in the diagnosis of the market value.

The function of the support for best employment is a function such as a support to formulate a best employment plan according to the skill GAP. According to the function of the best employment support, an integrated employment item (corresponding to the skill item in the skill evaluation) is extracted from integrated employment information written in the natural language, and the extracted integrated employment item is associated with an integrated employment database (corresponding to the skill database in the skill evaluation, and having the same data structure as the skill category and the skill level in the skill database) and stored in a predetermined location according to an integrated employment mapping rule described with a similar data structure to the skill mapping rule used in the skill evaluation similarly to the skill evaluation by the skill evaluation apparatus of the first embodiment.

The data item (skill category or skill level) in the integrated employment database has basically the same structure as the data in the skill database. The integrated employment information database stores various information such as information of the standard skill required in the job market, and information on actual job vacancy classified by various categories such as a job type and skill level as the results of skill evaluation (skill holding condition). The data item in the integrated employment information database is matched with the market value (or the result of skill evaluation) of the evaluatee to extract the matched data item from the integrated employment information database as a candidate employer.

Here, it is possible to take the skill GAP into consideration so that the evaluatee is treated as a person with a higher skill level at the matching. Here, it is also possible to find a match between the training data and the skill GAP so that the educational support can be provided to supplement the GAP.

The function of the open interface (I/F) for remote user is a function such as a function to allow easy self-diagnosis of the skill by any user on the web, and a function to allow acquisition of various know-how. The function of the customization of skill evaluation (support to facilitate input to answer the question, audio support) is a function such as a function to prompt an input concerning an item which cannot be acquired from the skill information extracted from the natural language document, a function (tool) to analyze the Q&A on real-time and to prompt an acquisition (question) of lacked data, and a function (expert system) to ask questions and to acquire answers via a notebook computer as a stand alone (or via the open I/F). The function of the rule maintenance is a function such as an automatic extraction of a rule.

[2-2: Screen Structure of Skill Evaluation System]

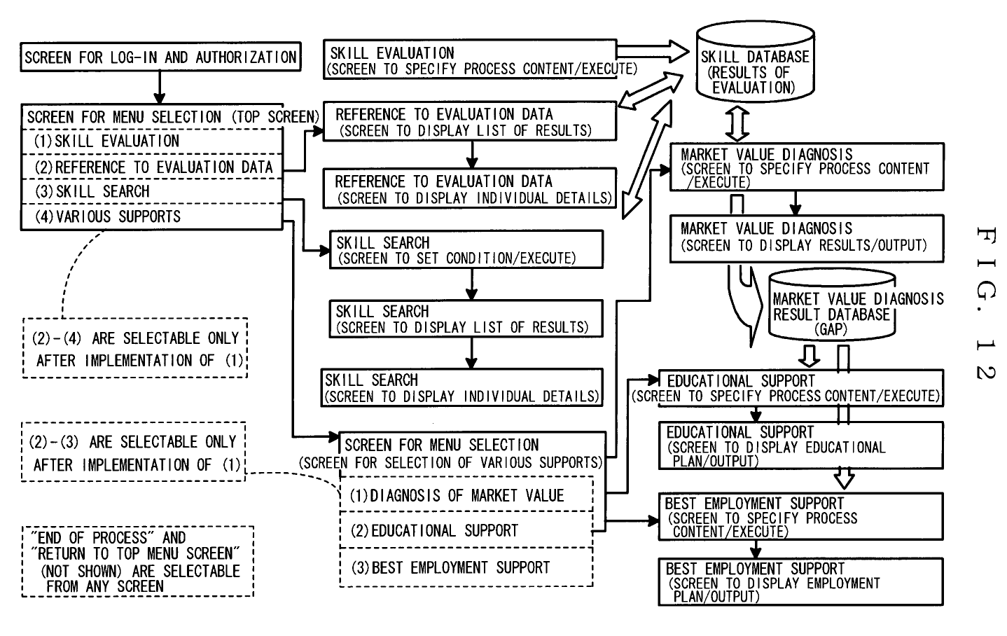

Next, the screen structure of the skill evaluation system according to the second embodiment is described. FIG. 12 is a diagram of the screen structure of the skill evaluation system according to the second embodiment. As shown in FIG. 12, the skill evaluation system first displays a screen for log-in and authorization. When the user is successfully authorized, the skill evaluation system displays a screen for menu selection (top screen).

The user selects one item from the menu, i.e., the skill evaluation, the reference to evaluation data, skill search, or the various supports on the screen for menu selection. When the user selects the various support menu, another screen is displayed to prompt the user to select the market value diagnosis, the educational support, or the best employment support.

The menu of the reference to evaluation data, the skill search, and the various supports are selectable only after the user goes through the skill evaluation. The user can select “end of process” or “return to the top menu screen” from any screen.

[2-3: Process Sequence of Skill Evaluation System]

Next, the process sequence of the skill evaluation system is described.

[2-3-1] Process of Log-In and Authorization

(1) Access to a predetermined URL on the WEB.

(2) Ask for authorization.

(3) When the user is authorized, proceed to the menu screen (top screen).

(4) When the user is not authorized, display an “error message” and end the process.

[2-3-2] Process of Menu Selection (Top Screen)

(1) Display the menu and prompt the user to select.
1: Skill evaluation
2: Reference to evaluation data
3: Skill search
4: Various supports
5: End
   (2) Proceed to a Process (Screen) Selected in (1)

Here, “2: Reference to evaluation data” to “4: Various supports” are selectable only when “1: Skill evaluation” has already performed.

[2-3-3] Process of Skill Evaluation

<Preprocess>

Following is performed as preprocess.

(1) Set “Original Skill Information File”

Import a file of a predetermined format which describes the skills of each evaluatee, and set the file in an “original skill information file storage folder”. A method and a content of description are not specified.

(2) Set “Original Evaluatees' List”

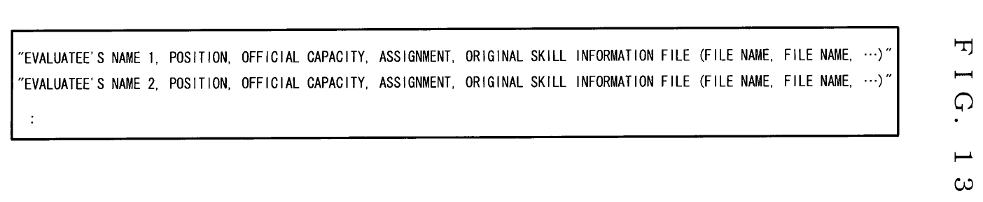

FIG. 13 is a diagram of an example of a format of the original evaluatees' list. Formulate a CSV file with a format as shown in FIG. 13 in advance and set in an “original skill information file storage folder.”

Any data can be employed as the original evaluatees' list as far as the data can uniquely identify the association between each name of evaluatee and skill information. The description on the type of job and the position can be omitted. At least one original skill information file must be specified.

(3) Create “Skill Information File”

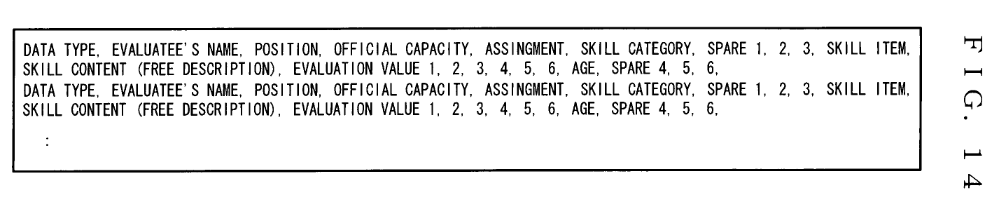

Create a skill information file with a format as shown in FIG. 14 with reference to the files set in (1) and (2). Set the created file into the “skill information file storage folder”. The skill information file contains data on the evaluatee's name, position, official capacity, and assignment, as well as data of each sentence extracted from the original skill information file in a skill content box as one-row data per one sentence.

The skill information file is created one for each evaluatee. Mandatory items are the name of the evaluatee and the skill content (any description is acceptable). When there is no information, the box is basically left blank. The skill item is described within the length of one row. When the item includes a linefeed code, the item should be modified to fit into one row. The skill content should be one sentence (without a linefeed code) for one skill item. When the original skill information contains many sentences for one skill item, data is made to extend over plural rows with other copied data such as the skill item.

(4) Set “Evaluatees' List”

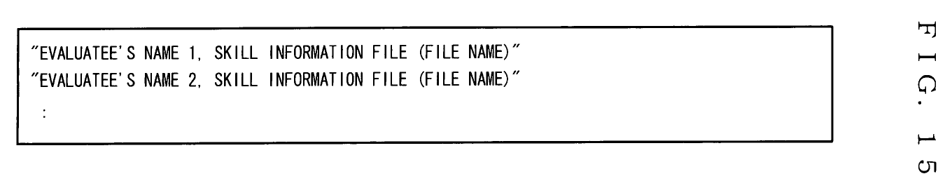

Create a CSV file of a format as shown in FIG. 15 and set the created file with a desired content into the “skill information file storage folder.” The file name should be same with the file name of the original evaluatees' list.

<Process of Skill Evaluation>

(1) Specify Input/Output Data

(1-1) Display an input BOX and prompt to specify the file name of the evaluatees' list set in the skill information file storage folder.

(1-2) Display the input BOX and prompt to specify the file names of the skill database storage folder and the skill database of the result of the skill evaluation.

(2) Prompt to select one of an execution button/a cancel button (an end button).

(3) If the “cancel” button is selected, return to the screen of upper level.

(4) If the “execution” button is selected, reconfirm the “specified content” and start the process from (5).

(5) Take in the data for each evaluatee in the list and perform the following skill evaluation (for each individual).

(5-1) OPEN the evaluatees' list.

(5-2) Take in the data (evaluatee's name, skill information file (file name)) of one evaluatee from the evaluatees' list (when the process completes for all evaluatees, CLOSE the evaluatees' list and proceed to (6).

(5-3) Initialize the data for one evaluatee.
1: “Information on Results of Rule Application”
2: “Collection of Answers to Questions (mandatory level and optional level are specified)”

(5-4) Set the evaluatee's name as a process ID.

(5-5) OPEN the skill information file.

(5-6) Read in each sentence from the skill information file and perform the following process of skill evaluation (for each skill) thereon. When there is no remaining evaluatee's data, CLOSE the skill information file and proceed to (5-7).

(5-6-1) Read the Skill Information

Read one row of the skill information (when all data are read, finish the process).

(5-6-2) Set Known Item

Set variables for the known items such as the position, official capacity, assignment, and skill item (category) or the like. The set variables are utilized at the rule application.

(5-6-3) Morphological Analysis/Syntactic Analysis of the Skill Content (Natural Language Sentence)

Fetch the skill content (natural language sentence) and perform the morphological analysis and the syntactic analysis (semantic analysis).

(5-6-4) Match the result of the morphological analysis and the syntactic analysis (semantic analysis) with the skill mapping rule and apply if there is a rule to be applied. Then, the result is stored as data (“information of result of rule application”) having the structure including “evaluatee's ID, original sentence, hit content, hit rule, and application processing.”

(5-6-5) Perform mapping to the Q&A table based on the result in (5-6-4). When there is no answer to the mandatory question, raise alarm and execute a suitable process.

(5-6-6) Return to (5-6-1).

(5-7) Write in the Result of Evaluation of (One) Evaluatee

Following the mapping process to data in the Q&A table, map the data in a corresponding location in the skill database 209.

(5-8) Proceed to the process of skill evaluation (for individual) (5-2) of the next evaluates.

(6) Data Output.

When the evaluation is completed for all the evaluatees, write in the data into the “skill database” in the “skill database storage folder.”

(7) End the process and return to the screen of upper level.

[2-3-4] Process of Reference to Evaluation Data (Screen to Display List of Results)

(1) Display the input BOX (if there are plural skill databases) and prompt to specify a skill database. Thereafter, if the user selects an OK button, display data of evaluatees' list in the skill database selected in (1).

(2) Display “end” button, “previous/next” button, “display individual details” button (set for each evaluatee) and process according to the selected content.

(2-1) If the “end” button is selected, return to the screen of upper level.

(2-2) if the “previous/next” button is selected, move to a previous page or a next page, and display the data of the list.

(2-3) If the “display individual details” button is selected, display detailed information on the result of skill evaluation for the pertinent evaluatee.

[2-3-5] Process of Reference to Evaluation Data (Screen Displaying Individual Details)

(1) Display detailed data of the result of evaluation of the evaluatee.

(2) Display the “end” button and the “previous/next” button, and perform processing according to the selected content.

(2-1) If the “end” button is selected, return to the screen of upper level.

(2-2) if the “previous/next” button is selected, move to a previous page or a next page, and display the detailed data of the list.

[2-3-6] Process of Skill Search (Screen to Set Condition/Execute)

(1) Display the input BOX (if there are plural skill databases) and prompt to specify a skill database. Thereafter, if the OK button is selected,

(2) Display the search condition input BOX and prompt to input a search condition. Here, the search condition can be set by:
1: free word, and
2: selection of predetermined skill content (skill category, skill level, or specific skill item).

(3) Thereafter, if a search execution button is selected, proceed to the skill search (screen displaying the list of results). If the “end” button is selected, return to the screen of upper level.

[2-3-7] Process of Skill Search (Screen to Display List of Results)

(1) Display the list of search results.

(2) If the “return” button is selected, return to the screen for search condition setting (screen of upper level).

(3) If the “detailed display” button of each row in the data list is selected, proceed to a “screen displaying individual details” of each evaluatee.

[2-3-8] Process of Skill Search (Screen Displaying Individual Details)

(1) Display “individual detailed information” for each evaluatee.

(2) If the “return” button is selected, return to the screen for search condition setting (screen of upper level).

[2-3-9] Process of Menu Selection Screen (Screen for Selection of Various Supports)

Prompt to select from the following menu and proceed to the selected screen.

(1) Diagnosis of Market Value

(2) Educational Support

(3) Support for Best Employment

[2-3-10] Process of Market Value Diagnosis (Screen to Specify Process Content/Execute)

<Building Market Value Scale Database >

The market value scale database is built by some tool or the like at the installation of the skill evaluation system as a part of the process of creating the “market value scale database” on the side of the system (process algorithm, rule, and dictionary are basically the same with the skill evaluation process. Only the storage file or the like of the data is different.)

Information of “market value scale” described in the natural language is regarded as the skill information of one user, evaluated similarly to the skill evaluation in the <preprocess> or the <process of skill evaluation> and stored in the “market value scale database.” Then, the “market value scale” is compiled into a database for various job types, assigning different user for each job type.

<Diagnosis Process>

(1) Display the input BOX (if there are plural skill databases) and prompt to specify a skill database. In addition prompt to specify the “evaluates to be diagnosed.”

(2) Prompt to specify a target job type (prompt to specify a job type in a list).

(3) Process according to the content selected via the “end” button or “execution” button.

(3-1) If the “end” button is selected, return to the screen of upper level.

(3-2) If the “execution” button is selected, perform the diagnosis process. After the completion of the diagnosis process, proceed to the “screen to display results/output.”

(3-2-1) Match the result of individual skill evaluation and the market value and find the gap (the evaluated items in each database are the same).

(3-2-2) Store the results for each “name of evaluatee” in the “market value scale GAP storing database.”

[2-3-11] Process of Market Value Diagnosis (Screen to Display Results/Output)

(1) Display the “GAP from the market value scale” for the specified job type of the evaluatee

[2-3-12] Process of Educational Support (Screen to Specify Process Content/Execute)

<Building of Training Database>

The training database is built by some tool or the like at the installation of the skill evaluation system (including the time of updating of the training information) as a part of the process of creating the “training database” on the side of the system (process algorithm, rule, and dictionary are basically the same with the skill evaluation process. Only the storage file of the data or the like is different.)

The “educational plan” (training curriculum) described as the natural language sentence is considered to be the skill information of a user, and processed similarly to the skill evaluation process and stored in the “training database.” The “educational plan” is compiled into a database for various job types, assigning different user for each job type.

<Process of Support for Educational Plan Formulation>

(1) Display an input BOX (when there are plural skill databases), and prompt to specify a skill database. In addition, prompt to specify the “name of the diagnosed.”

(2) Prompt to specify a target job type (prompt to specify a job type of his/her wish in a list).

(3) Process according to the content selected via the “end” button or the “execution” button.

(3-1) If the “end” button is selected, return to the screen of upper level.

(3-2) If the “execution” button is selected, perform the diagnosis process. After the completion of the diagnosis process, proceed to the “screen to display results/output.”

(3-2-1) Find a match between the GAP detected in the market value scale diagnosis and the training database, to extract the training item corresponding to the GAP.

(3-2-2) Store the results as data of the “educational plan” for the “name of the diagnosed”.

[2-3-13] Process of Educational Support (Screen to Display Educational Plan/Output)

(1) Display the “educational plan” for the target job type specified by the evaluatee.

[2-3-14] Process of Best Employment Support (Screen to Specify Process Content/Execute)

<Building of Integrated Employment Database>

The integrated employment database is built by some tool or the like at the installation of the skill evaluation system (including the time of updating of the integrated employment information) as a part of the process of creating the “integrated employment database” on the side of the system (process algorithm, rule, and dictionary are basically the same with the skill evaluation process. Only the storage file of the data or the like is different.)

The “integrated employment plan” (e.g., information on job vacancy) described as the natural language sentence is considered to be the skill information of a user, and processed similarly to the skill evaluation process and stored in the “integrated employment database.” The “integrated employment data” is compiled into database for various job types, assigning different user for each job type.

<Process of Support of Formulation of Reemployment (Best Employment Plan) >

(1) Display the input BOX (if there are plural skill databases) and prompt to specify a skill database. In addition prompt to specify the “name of the diagnosed.”

(2) Prompt to specify a target job type (prompt to specify a job type of his/her wish in a list).

(3) Process according to the content selected via the “end” button or “execution” button.

(3-1) If the “end” button is selected, return to the screen of upper level.

(3-2) If the “execution” button is selected, perform the diagnosis process. After the completion of the diagnosis process, proceed to the “screen to display results/output.”

(3-2-1) Find matches between the results of market value scale diagnosis and the integrated employment database, and extract the data item (candidate employer) corresponding to the market value from the best employment plan database.

(3-2-2) Store the results as the data of the “reemployment plan (best employment plan)” for the “name of the diagnosed.”

[2-3-15] Process of Best Employment Support (Screen to Display Employment Plan/Output)

(1) Display the “best employment plan” in the target job type of the evaluatee.

As described above, in the second embodiment, the data on job vacancy is stored in the job vacancy database. The job vacancy data stored in the job vacancy database is matched with the skill items stored in the skill database for the search of appropriate personnel, whereby personnel with a necessary skill can be found.

Further, according to the second embodiment, the job vacancy information written in the natural language is subjected to the natural language analysis, and the job vacancy data is extracted from the results of the natural language analysis and stored in the job vacancy database according to the job vacancy mapping rule. Hence, an efficient building of the job vacancy database is possible based on the documents written in the natural language about the job vacancy information.

Further, according to the second embodiment, the market value scale data is stored in the market value scale database, and the market value scale data stored in the market value scale database is matched with the results of skill evaluation stored in the skill database for the evaluation of individual's market value and the analysis of the skill GAP. Thus, the correct diagnosis of the market value and the analysis of the GAP are allowed based on the skill.

Further, according to the second embodiment, the market value scale information written in the natural language is subjected to the natural language analysis, and the market value scale data is extracted from the results of the natural language analysis and stored in the market value scale database according to the market value scale mapping rule. Hence, an efficient building of the market value scale database is possible based on the documents written in the natural language about the market value scale information.

Still further, according to the second embodiment, the training data is stored in the training database, and the training data stored in the training database is matched with the results of skill GAP analysis for the formulation of the individual educational plan. Thus, the educational plan can be created to supplement the skill GAP.

Further, according to the second embodiment, the training information written in the natural language is subjected to the natural language analysis, and the training data is extracted from the results of the natural language analysis of the training information and stored in the training database according to the training mapping rule. Hence, an efficient building of the training database is possible based on the documents written in the natural language about the training information.

Still further, according to the second embodiment, the integrated employment data is stored in the integrated employment database, and the integrated employment data stored in the integrated employment database is matched with the results of the market value diagnosis for the formulation of the individual reemployment plan. Hence, the best employment plan (reemployment plan) appropriate in view of the individual skill and the market value can be formulated.

Still further, according to the second embodiment, the integrated employment data is stored in the integrated employment database, and the integrated employment data stored in the integrated employment database can be matched with the results of the skill GAP analysis for the formulation of individual reemployment plan. Hence, the best employment plan (reemployment plan) appropriate in view of the predetermined upgrading of the skill can be formulated.

Further, according to the second embodiment, the integrated employment information written in the natural language is subjected to the natural language analysis, and the integrated employment data is extracted from the results of the natural language analysis and stored in the integrated employment database according to the integrated employment mapping rule. Hence, an efficient building of the integrated employment database is possible based on the documents written in the natural language about the integrated employment information.

### 3: Third Embodiment (Motivation Evaluation Apparatus)

In the first embodiment described above, the “skill” is evaluated as the individual ability. The present invention, however, is not limited to the evaluation of the skill. The present invention is similarly applicable to the evaluation of any individual abilities, such as individual motivation, which can be considered at the review of job application or internal transfer.

Hence, in the third embodiment below, a motivation evaluation apparatus which evaluates the individual motivation and stores the results of evaluation in a motivation database, similarly to the first embodiment, is described as another example of evaluation of individual ability. The description of the third embodiment can be understood similarly to the description of the first embodiment, with the term “skill” in the description of the first embodiment replaced with the term “motivation.”

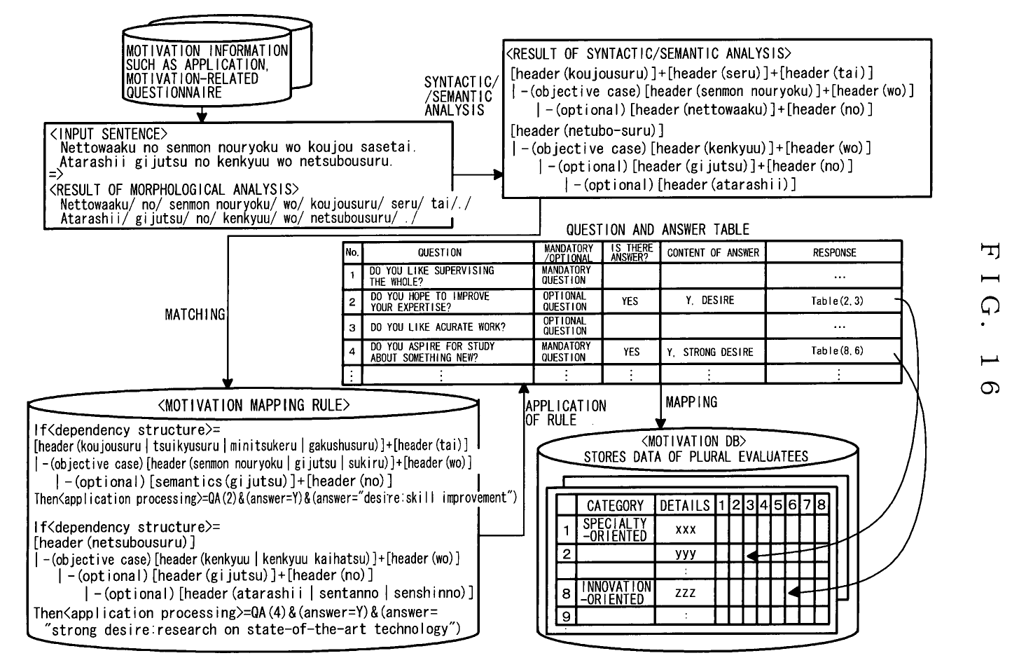

In the description of the third embodiment hereinbelow, with reference to FIGS. 16 to 26, a concept of the motivation evaluation apparatus according to the third embodiment ([3-1: Concept of Motivation Evaluation Apparatus]), a structure of the motivation evaluation apparatus according to the third embodiment ([3-2: Structure of Motivation Evaluation Apparatus]), a process sequence of the motivation evaluation apparatus according to the third embodiment ([3-3: Process Sequence of Motivation Evaluation Apparatus]), advantages of the motivation evaluation apparatus according to the third embodiment ([3-4: Advantages]), and other embodiments of the motivation evaluation apparatus ([3-5: Other Embodiments of Motivation Evaluation Apparatus]) are described.

Hereinbelow, the term “syntactic/semantic structure” is also referred to as a “dependency structure” or a “result of syntactic analysis,” and the term “morphological structure” is also referred to as a “result of morphological analysis,” a “morpheme list,” or a “word list.” These should be understood as denoting the same, respectively.

[3-1: Concept of Motivation Evaluation Apparatus]

The concept of the motivation evaluation apparatus according to the third embodiment is described. FIG. 16 is an explanatory diagram of the concept of the motivation evaluation apparatus according to the third embodiment. As shown in FIG. 16, the motivation evaluation apparatus prepares in advance a motivation mapping rule (motivation-associating rule) for association of a motivation sentence which describes a motivation with a Q&A table for motivation evaluation, finds a match in each sentence in a document such as an application or a response to a motivation-related questionnaire written in a natural language with the motivation mapping rule, and if there is a match, automatically creates an answer to the Q&A table from a matched sentence.

Specifically, the motivation evaluation apparatus prepares the motivation mapping rule in advance which includes a conditional part which is a data structure of a result of the syntactic analysis and the semantic analysis of the motivation sentence written in the natural language that would be used as an answer to the Q&A table for the motivation evaluation, and an executing part which associates the answer to a corresponding item in the Q&A table. The motivation evaluation apparatus analyses the syntax and the semantics of each sentence in the document such as the application or the response to the motivation-related questionnaire written in the natural language, checks if the analyzed sentence matches with any conditional part of the motivation mapping rule, and if there is a match, determines that the pertinent sentence is the motivation sentence, and creates an answer from the pertinent motivation sentence for an item associated therewith by the executing part of the motivation mapping rule.

For example, if the application or the response to the motivation-related questionnaire includes a sentence such as “Nettowaaku no senmon nouryoku wo koujou sasetai. (JE)” (“I hope to improve my expertise in network. (EE)”), the result of the morphological analysis for the sentence is a word list such as “Nettowaaku/no/senmon nouryoku/wo/ koujousuru/seru/tai/./(JE)” (“I/hope to/improve/my/expertise/in/ network/./(EE)”).

Then, the result of the syntactic analysis and the semantic analysis on the word list is:

[header(koujousuru)]+[header(seru)]+[header(tai)]
|-(objective case)[header(senmon nouryoku)]+[header(wo)]
|-(optional)[header(nettowaaku)]+[header(no)].
(JE)
[header(hope to)]+[header(improve)]
|-(objective case)[header(expertise)]
| |-(optional)[header(my)]
| |-(optional)[header(in)]+[header(network)]
|-(subjective case)[header (I)]
(EE)

In the result of the syntactic analysis shown above, “|” and “|-” are descriptive symbols used to indicate that a node (word) and a node (word) are related with each other in a predetermined dependency relation such as a super-subrelation.

After the analysis above is finished, the part,

```
[header(koujousuru)]+[header(seru)]+[header(tai)]
|-(objective case)[header(senmon nouryoku)]+[header(wo)]
  |-(optional)[header(nettowaaku)]+[header(no)]
(JE)
[header(hope to)]+[header(improve)]
|-(objective case)[header(expertise)]
  |-(optional)[header(in)]+[header(network)]
(EE)
```

is found to match with the conditional part in the motivation mapping rule, whereby “Y, desire” is found to be an answer to a second question “Do you hope to improve your expertise?” in the Q&A table. In the answer, “Y” means “Yes.”

In addition, when the application or the response to the motivation-related questionnaire includes the sentence such as “Atarashii gijutsu no kenkyuu wo netsubousuru. (JE)” (“I aspire for study about new technology. (EE)”), the result of the morphological analysis on the sentence results in the word list such as “Atarashii/gijutsu/no/kenkyuu/wo/netsubousuru/./ (JE)” (“I/aspire/for/study/about/new/technology/./ (EE)”), and further, the syntactic analysis and the semantic analysis on the word list results in,

```
[header(netsubousuru)]
|-(objective case)[header(kenkyuu)]+[header(wo)]
  |-(optional)[header(gijutsu)]+[header(no)]
    |-(optional)[header(atarashii)].
(JE)
[header(aspire)]
|-(objective case)[header(for)]+[header(study)]
| |-(optional) [header(about)] +[header(technology)]
| |-(optional)[header(new)].
|-(subject)[header(I)]
(EE)
```

Then, the result as above is found to match with the conditional part in the motivation mapping rule, whereby “Y, strong desire” is found to be an answer to a fourth question “Do you aspire for study about something new?” in the Q&A table.

Here, the information contained in each node (word) included in the result of the syntactic analysis shown above also provides grammatical and semantic information such as word class, conjugation, and semantics, other than the information as shown above. The above is merely a representation provided for convenience. To simplify the description, the result of the syntactic analysis is sometimes shown only with headers, and information denoting the inter-node relations (such as the term “objective case” and “optional” enclosed by parenthesis in the above example) is omitted from the description. These should be understood as to signify the complete representation of stored data of the syntactic analysis.

Here, the description “QA(2)” in the executing part means that the portion of the document matched with the conditional part should be associated with the second question in the Q&A table. Further, the description “Table(2,3)” in a second box of the “RESPONSE” column of the Q&A table means that the answer to the question, i.e., the extracted motivation item (content of answer), is associated with a data item specified by (2,3) and stored in the motivation database.

When the questions in the Q&A table are categorized into two categories, i.e., “a question to which the answer is mandatory,” and “a question to which the answer is optional,” and the category of the question (mandatory/optional) is stored in the Q&A table, even if a supplied document does not contain enough information on motivation, it would be possible to supplement information only for the mandatory question. Thus, even if the Q&A table includes a vast amount of questions, an efficient motivation evaluation can be carried out with the use of mandatory information alone.

The motivation database is a database which stores motivation items of the evaluatee. In the motivation database, data is stored for each evaluatee in a two-dimensional matrix format where a vertical direction (column) represents character/inclination of motivation items (i.e., motivation categories classified according to characters such as an all-rounder, an innovation-oriented character, a specialty-oriented character, a follower type.), and a horizontal direction (row) represents motivation level for each motivation item. The first number in the parenthesis shown above indicates the location along the vertical (column) direction in the motivation database, which denotes a motivation category set for each character/inclination. The second number in the parenthesis indicates the location along the horizontal (row) direction in the motivation database, which denotes a motivation level in a pertinent motivation category.

When the result of the syntactic analysis matches with the motivation mapping rule, the motivation item is not only extracted, but is associated with a data item (data storing location) in the motivation database. Such association indicates “in which motivation level of which motivation item (motivation category)” the corresponding data should be categorized.

Thus, when the match with the motivation mapping rule is found, the motivation item is extracted, the motivation level for the extracted skill item is evaluated, and the location in the motivation database at which the corresponding data should be stored (associated with) is known. In other words, when the match with the rule is found, the motivation evaluation for one motivation is finished.

Various motivation items may be stored in the same location in the motivation database. For example, when motivation sentences such as “Nettowaaku no senmon nouryoku wo koujousasetai. (JE)” (“I hope to improve my expertise in network. (EE)”) and “Deetabeesu no senmon nouryoku wo koujousasetai. (JE)” (“I hope to improve my expertise in database. (EE)”) are evaluated, the motivation items “Nettowaaku no senmon nouryoku wo koujousasetai (JE)” (“I hope to improve my expertise in network. (EE)”) and “Deetabeesu no senmon nouryoku wo koujousasetai. (JE)” (“I hope to improve my expertise in database. (EE)”) are expected to be stored in the same data item location. The evaluatee can be evaluated to have a higher motivation level when one location (data item) stores many motivation items.

Thus, the motivation evaluation apparatus according to the third embodiment prepares the motivation mapping rule which includes the conditional part which is the data structure representing the result of the syntactic analysis/semantic analysis of the motivation sentence, finds a match between the result of the syntactic analysis/semantic analysis of each sentence in the document such as an application or a response to a motivation-related questionnaire with the conditional part in the motivation mapping rule, and if a match is found, creates the answer for the Q&A table from the sentence, thereby making it possible to automatically extract the motivation item from the document such as the application or the response to the motivation-related questionnaire written in the natural language, and to evaluate the evaluatee.

[3-2: Structure of Motivation Evaluation Apparatus]

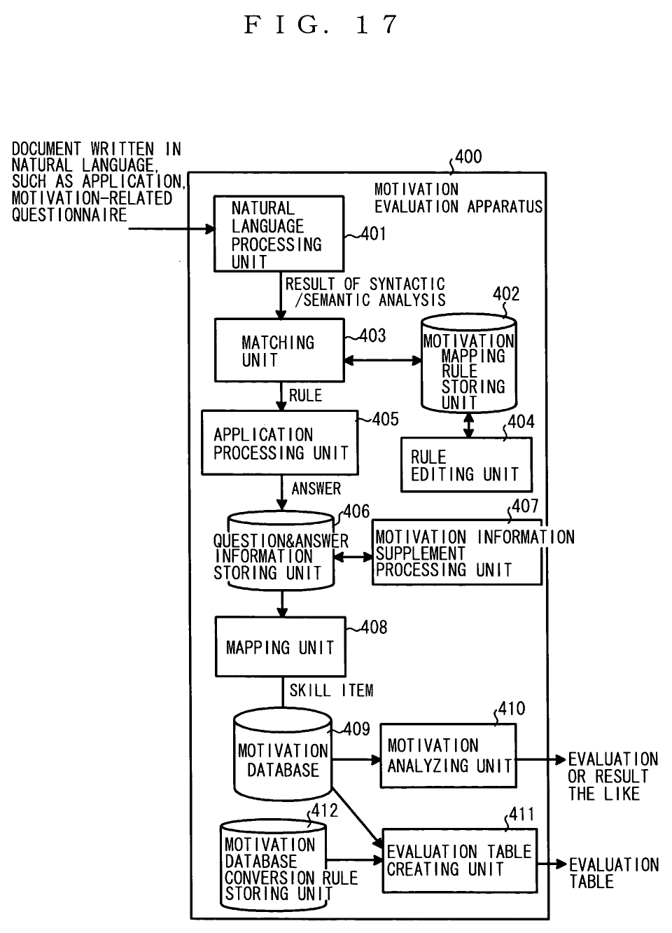

Next, the structure of the motivation evaluation apparatus according to the third embodiment is described. FIG. 17 is a functional block diagram of the structure of the motivation evaluation apparatus according to the third embodiment. As shown in FIG. 17, a motivation evaluation apparatus 400 includes a natural language processing unit 401, a motivation mapping rule storing unit 402, a matching unit 403, a rule editing unit 404, an application processing unit 405, a Q&A information storing unit 406, a motivation information supplement processing unit 407, a mapping unit 408, a motivation database 409, a motivation analyzing unit 410, an evaluation table creating unit 411, and a motivation database conversion rule storing unit 412.

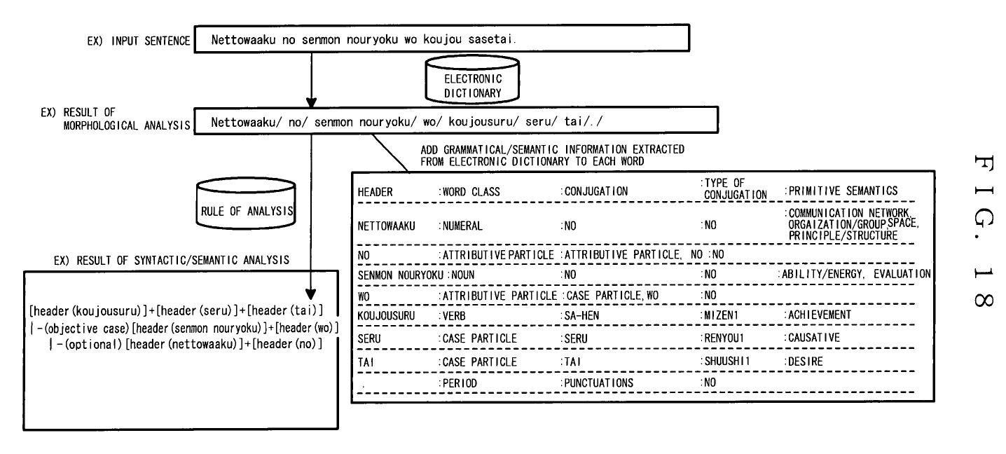

The natural language processing unit 401 is a processor which receives an input of a document such as an application or a response to a motivation-related questionnaire written in a natural language and performs the syntactic analysis and the semantic analysis thereon. FIG. 18 is an explanatory diagram of the natural language processing by the natural language processing unit 401.

As shown in FIG. 18, the natural language processing unit 401, on receiving an input of a sentence “Nettowaaku no senmon nouryoku wo koujousasetai (JE)” (“I hope to improve my expertise in network. (EE)”) for example, performs the morphological analysis using an electronic dictionary to obtain a word list “Nettowaaku/no/senmon nouryoku/wo/koujousuru/seru/tai/./ (JE)” (I/hope to/improve/my/expertise/in/network/./(EE)” as a result of the analysis. Further, the natural language processing unit 401 adds grammatical/semantic information such as word class, conjugation, type of conjugation, semantics, or the like for each word delineated by a slash (/). In FIG. 18, the term “MIZEN1” means imperfective form (“mizenkei (JE)”), the term “RENYOU1” means continuative form (“ren' youkei (JE)”), and the term “SHUUSHI1” means teminal form (“shushikei (JE)”).

For example, to the word “nettowaaku (JE)” (“network (EE)”), added grammatical/semantic information is: “noun” as the word class; “no conjugation” as the conjugation; “no conjugation” as the type of conjugation; and “communication network, organization/group, space, principle/structure.”

Then, through the syntactic analysis and the semantic analysis based on an analysis rule on the results of the morphological analysis, the following result of the syntactic/semantic analysis is obtained:

[header(koujousuru)]+[header(seru)]+[header(tai)]
|-(objective case)[header(senmon nouryoku)]+[header(wo)]
|-(optional)[header(nettowaaku)]+[header(no)].
(JE)
[header(hope to)]+[header(improve)]
|-(objective case)[header(expertise)]
| |-(optional)[header(my)]
| |-(optional)[header(in)]+[header(network)]
|-(subjective case)[header (I)]
(EE)

In the result of the syntactic/semantic analysis shown above, “|” and “|-” are descriptive symbols used to indicate that a node (word) and a node (word) are related with each other in a predetermined dependency relation such as a super-subrelation. The term “optional” in the parenthesis ( ) immediately after the symbol indicates that the inter-word relation is optional, and the term “objective case” indicates that the word is used as the objective case. These terms corresponds with the case relation (subjective case, objective case, accusative case, or the like) or the relation to attribute (subject, object, possession, or the like) in the natural language processing.

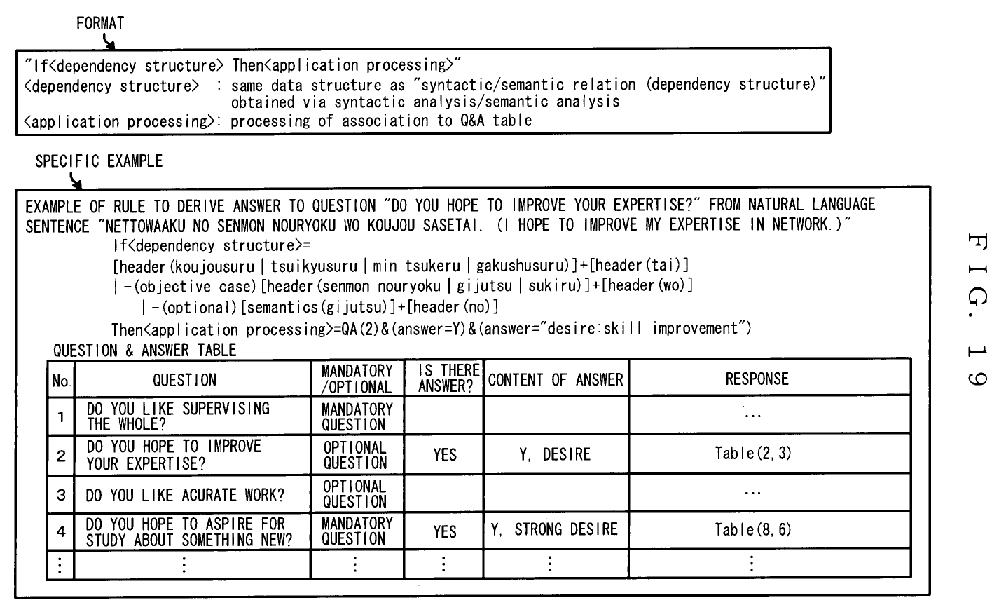

The motivation mapping rule storing unit 402 is a memory that stores the motivation mapping rule. FIG. 19 is a diagram of the motivation mapping rule and more particularly, shows a format of the motivation mapping rule and a specific example thereof.

As shown in the “FORMAT” of FIG. 19, the motivation mapping rule has a format constituted from a conditional part and an executing part, such as “If<dependency structure> Then<application processing>.” Here, <dependency structure> in the conditional part has the same data structure as “syntactic/semantic relation (dependency structure)” obtained via the syntactic/semantic analysis. On the other hand, <application processing> in the executing part is a process of association to the Q&A table.

Further, as shown in the “SPECIFIC EXAMPLE” in FIG. 19, the motivation mapping rule to derive the answer to the second question “Do you hope to improve your expertise?” from a natural language sentence “Nettowaaku no senmon nouryoku wo koujousasetai. (JE)” (I/hope to/ improve/my/expertise/in/network/./ (EE)” for example, is:

```
If <dependency structure>=
[header(koujousuru | tsuikyusuru | minitsukeru |
gakushusuru)]+[header(tai)]
|-(objective case)[header(senmon nouryoku | gijutsu | sukiru)]+
[header(wo)]
  |-(optional)[semantics (gijutsu)]+[header (no)]
(JE)
If <dependency structure>=
[header(hope to)]+[header(improve | pursuit | acquire| learn)]
|-(objective case)[header(expertise | technique | skill)]
  |-(optional)[semantics (technique)]
(EE)
```

Then<application processing>=QA(2)&(answer=Y)&(answer=“desire:skill improvement”).

Here, “|” in parentheses represents OR condition. In other words, “koujousuru|tsuikyusuru|minitsukeru|gakushusuru (JE)” (“improve|pursuit|acquire|learn (EE)”) means “koujousuru (JE)” or “tsuikyusuru (JE)” or “minitsukeru (JE)” or “gakushusuru (JE)” (“improve (EE)” or “pursuit (EE)” or “acquire (EE)” or “learn (EE)”). In the above example, the inter-node relation is limited to “(object),” though the application can be expanded to an optional relation, so that the inter-node relation is described as “(optional).”

When the motivation mapping rule is applied, a box for the second question “Do you hope to improve your expertise?” in the column of “is there answer?” in the Q&A table is checked as “YES,” according to the executing part “QA(2)”, and “Y, desire” is stored as the answer according to the part “(answer=“desire:skill improvement).”

Here, any terms in the motivation sentence, as in the above example of the answer, or the entire motivation sentence can be stored as the motivation item as the answer information. Specifically, the part of the motivation mapping rule in FIG. 19, “|-(optional)[semantics(gijutsu)]+[header(no)] (JE)” (|-(optional)[semantics (technic)] (EE)”) corresponds with the part “Nettowaaku no (JE)” (“network (EE)”) in the input natural language sentence. The term “nettowaaku (JE)” (“network (EE)”) can be extracted from this part and stored as an item specifically related with the motivation. On the other hand, any term (word list) individually specified in the motivation mapping rule, for example, the term which indicates a type of desire (“skill improvement” in the above rule), can be included in the answer information and stored. Further, to the question in the YES/NO format, the rule can be described as “(answer=Y)” and “(answer=N)” so that the sentence can be treated as equivalent to the answer “Yes” or “No.”

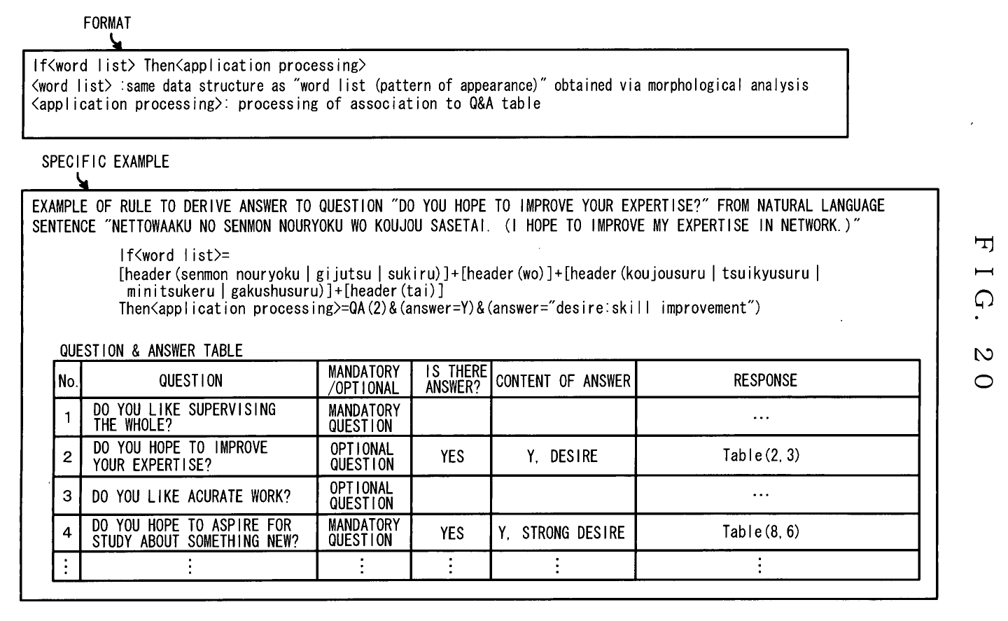

FIG. 20 is a diagram of another motivation mapping rule and more particularly, shows another format of the motivation mapping rule and a specific example thereof.

As shown in “FORMAT” in FIG. 20, the motivation mapping rule has a format “If <word list> Then <application processing>.” Here, <word list> has the same data structure as the “word list (pattern of appearance)” obtained via the morphological analysis.

Further, as shown in “SPECIFIC EXAMPLE” in FIG. 20, the motivation mapping rule to derive the answer to the question “Do you hope to improve your expertise?” from a natural language sentence “Nettowaaku no senmon nouryoku wo koujousasetai (JE)” (“I hope to improve my expertise in network (EE)”), for example, is:

If<word list>=
[header(senmon nouryoku | gijutsu | sukiru)]
+[header(wo)]
+[header(koujousuru | tsuikyusuru | minitsukeru | gakushusuru)]
+[header(tai)]
(JE)
If<word list>=
[header(hope to)]+[header(improve| pursuit | acquire |
learn)]+[header(expertise| technique | skill)]
(EE)

Then<application processing>=QA(2)&(answer=Y)&(answer=“desire:skill improvement”).

When the motivation mapping rule is applied, a box for the second question “Do you hope to improve your expertise?” in the column of “is there answer?” in the Q&A table is checked as “YES,” according to the executing part “QA(2)”, and “Y, desire” is stored as the answer according to the part “(answer=“desire:skill improvement).”

Here, any terms in the motivation sentence, or the entire motivation sentence can be stored as the motivation item as the answer information. Further, to the question in the YES/NO format, the rule can be described as “(answer=Y)” and “(answer=N)” so that the sentence can be treated as equivalent to the answer “Yes” or “No.”

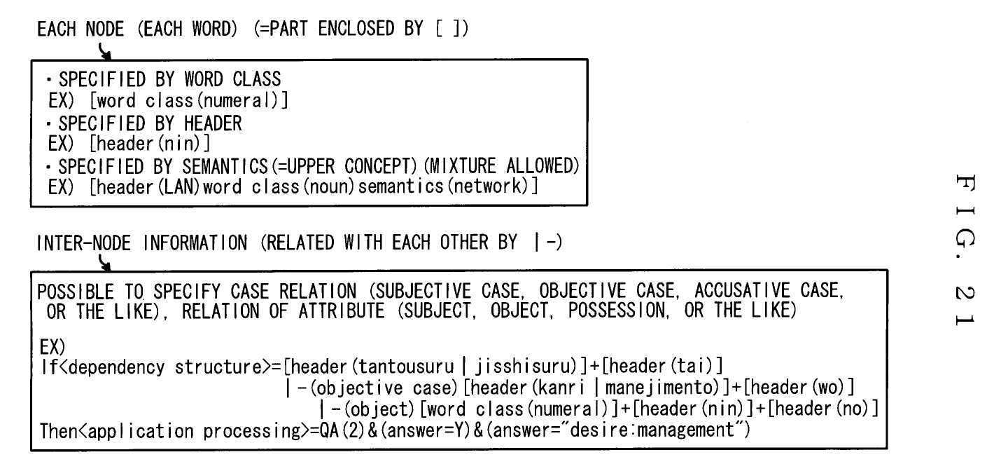

FIG. 21 is a diagram of information which can be specified in the conditional part of the motivation mapping rule. As is shown by “EACH NODE” in FIG. 21, information that can be specified in each node in the conditional part, i.e., a part demarcated by “[ ],” may include semantics (upper concept) in addition to the word class, the header, or the like. For example, [header(LAN)word class(noun)semantics(network)] means that the LAN is one of the networks.

Further, as shown by “INTER-NODE INFORMATION” in FIG. 21, inter-node information in <dependency structure> can specify the case relation (subjective case, objective case, accusative case, or the like) and the relation of attribute (subject, object, possession, or the like).

For example, in the motivation mapping rule,

```
If <dependency structure>=
[header(tantousuru|jisshisuru)]+[header(tai)]
|-(objective case)[header(kanri|manejimento)]+[header(wo)]
  |-(object)[word class(numeral)]+[header(nin)]+[header(no)]
(JE)
If <dependency structure>=
[header(hope to)]+[header(charge | implement)]
|-(objective case)[header(supervision |management)]
  |-(object)[word class(numeral)]+[header(people)]
(EE)
```

Then<application processing>=QA(2)&(answer=Y)&(answer=“desire:management”), “kanri|manejimento (JE)” (“supervision|management (EE)”) is the “object” of “tantou (JE)” (“charge(EE)”), meaning that someone is in charge of management, and “● nin (JE)” (“people (EE)”) is the “object” of “kanri (JE)” (“supervision (EE)”) meaning that someone is supervising ● people.”

In addition, since plural OR conditions can be described for the header and other elements, a variety of sentences and words can be properly handled. Further, the “semantics” description can be used to accommodate variation in description in the processed document. Thus, proper handling is possible without the increase in the number of motivation mapping rules. Further, “*” can be used as a wild card so that any desirable term can be processed as a matched term.

Thus, the <dependency structure> described in the conditional part of the motivation mapping rule has the same data structure as the dependency structure of the results of the syntactic/semantic analysis. Similarly, the <word list> described in the conditional part of the motivation mapping rule has the same data structure with the word list of the results of the morphological analysis.

The matching unit 403 shown in FIG. 17 is a processor which receives the results of the syntactic/semantic analysis from the natural language processing unit 401 and finds a match between the same and the motivation mapping rule stored in the motivation mapping rule storing unit 402.

Specifically, the matching unit 403 compares the results of the syntactic/semantic analysis performed by the natural language processing unit 401 with the conditional part of the motivation mapping rule, and searches for a motivation mapping rule whose conditional part has the same dependency structure with that of the results of the syntactic/semantic analysis.

Thus, since the matching unit 403 performs a matching process on the results of the syntactic/semantic analysis of each sentence in the supplied document and the conditional part of the motivation mapping rule, it is possible to select a motivation sentence from the document written in the natural language and to extract a motivation item.

The rule editing unit 404 is a processor that edits the motivation mapping rule storing unit 402. Specifically, the rule editing unit 402 performs operations such as addition of a motivation mapping rule to the motivation mapping storing unit 402, and correction or deletion of a motivation mapping rule stored in the motivation mapping storing unit 402.

The application processing unit 405 is a processor that deals with the executing part of the motivation mapping rule found as a match by the matching unit 403. Specifically, the application processing unit 405 extracts the motivation item from the motivation sentence and evaluate the same to generate an answer to a question in the Q&A table associated therewith by the executing part.

Since the application processing unit 405 generates an answer to the question associated therewith by the executing part of the motivation mapping rule among the questions in the Q&A table, it is possible to generate an answer to the Q&A table from the motivation sentence.

The Q&A table information storing unit 406 is a memory that stores the Q&A table for the motivation evaluation, in which the question and the answer are stored in association with each other. The application processing unit 406 writes the generated answer into the Q&A table in the Q&A table information storing unit 406.

Here, plural answers can be stored for each question. For example, when answers (result of motivation evaluation) such as “Nettowaaku no senmon nouryoku wo koujousasetai (JE)” (I hope to improve my expertise in network. (EE)”) or “Deetabeesu no senmon nouryoku wo koujousasetai (JE)” (I hope to improve my expertise in database. (EE)”) are extracted from the motivation sentence, both of them can be stored as an answer to the second question in the Q&A table of FIG. 20, i.e., “Do you hope to improve your expertise?” according to the motivation mapping rule.

The motivation information supplement processing unit 407 is a processor to supplement the Q&A table with an answer which is not acquired/generated by the application processing unit 406. The motivation information supplement processing unit 406 acquires an answer from the evaluatee as necessary and writes the same into the Q&A table stored in the Q&A table information storing unit 406. Alternatively, the motivation information supplement processing unit 407 may write only an answer to a mandatory question to the Q&A table among questions to which the answer is not generated by the application processing unit 406.

The mapping unit 408 is a processor which generates the motivation database 409 from the information in the Q&A table stored in the Q&A information storing unit 406. Specifically, the mapping unit 409 associates the answers appear on the Q&A table with the data items in the motivation database 409 according to the description in the “RESPONSE” column of the Q&A table.

The description in the “RESPONSE” column of the Q&A table provides information on which data item corresponding to which motivation level of which motivation category in the motivation database the extracted motivation item (answer) should be stored in. The storage of a motivation item (answer) in the motivation database is equivalent to the storage of the result of evaluation of a motivation level for one motivation category.

Further, dynamic control of the data item to be associated with the answer is made possible with the description in the “RESPONSE” column of the Q&A table (in other words, description of branched conditioning is allowed in the “RESPONSE” column). For example, the answer “. . . wo shitai (JE) (“hope to (EE)”) can be associated with the data item of motivation level 3 (desire, for example), whereas the answer “. . . wo netsubousuru (JE) (“aspire for (EE)”) can be associated with the data item of motivation level 4 (strong desire, for example).

The motivation database 409 is a database which stores the result of motivation evaluation of the evaluatee. In the motivation database 409, data is stored for each evaluatee in a two-dimensional matrix format where a vertical direction (column) represents the character/inclination of motivation (i.e., motivation categories classified by characters such as an all-rounder, an innovation-oriented character, a specialty-oriented character, a follower type.), and a horizontal direction (row) represents the motivation level for each motivation item.

Thus, the motivation items in, for example, the motivation category of the evaluatee's character such as the all-rounder or the innovation-oriented character can be stored in the locations of data items of corresponding motivation levels.

The motivation analyzing unit 410 is a processor that displays the results of the analysis/evaluation of the motivation of the evaluatee, for example, based on the results of the motivation evaluation stored in the motivation database 409. Further, the motivation analyzing unit 410 gathers the results of the motivation evaluation for all evaluatees stored in the motivation database 409 together and analyses the trends thereof to display the results.

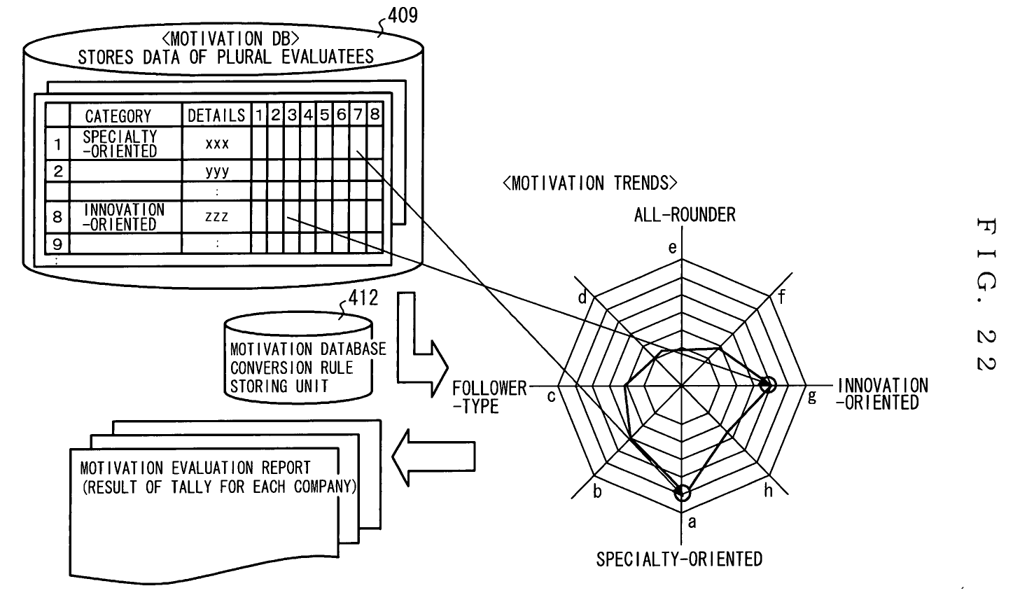

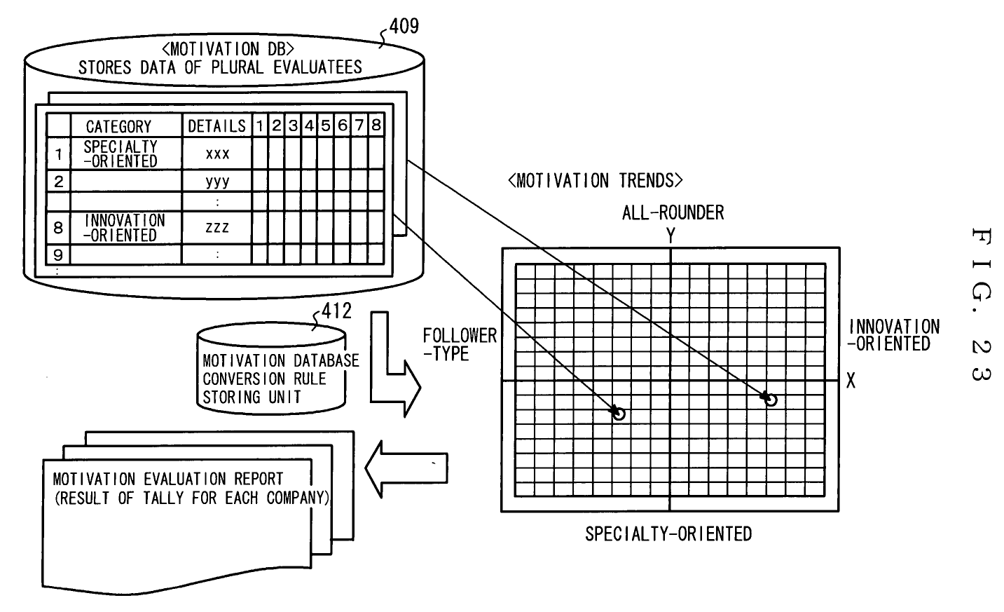

The evaluation table creating unit 411 converts the results of motivation evaluation stored in the motivation database 409 into a motivation evaluation table in a desired format based on the motivation database conversion rule stored in the motivation database conversion rule storing unit 412, to supply the results as an output. This process allows creation of a motivation evaluation table in a form complying, for example, with any motivation definition system (see FIGS. 22 and 23, for example).

The evaluation table creating unit 411 of course is able to output the results of the evaluation in the motivation database without applying the motivation database conversion rule, in other words, is able to output the motivation evaluation table including the motivation categories and motivation levels described in the same format as stored in the motivation database.

FIGS. 22 and 23 are explanatory diagrams of the correspondence between the motivation database 409 and a desired motivation definition system. As can be seen from FIGS. 22 and 23, the motivation items concerning the evaluatee's character, such as specialty-oriented character or an innovation-oriented character, stored in the motivation database 409 can be associated with predetermined motivation items according to the desired motivation definition system. Thus, when the motivation database 409 is associated with the desired motivation definition system, a report on motivation evaluation can be created following the desired motivation definition system.

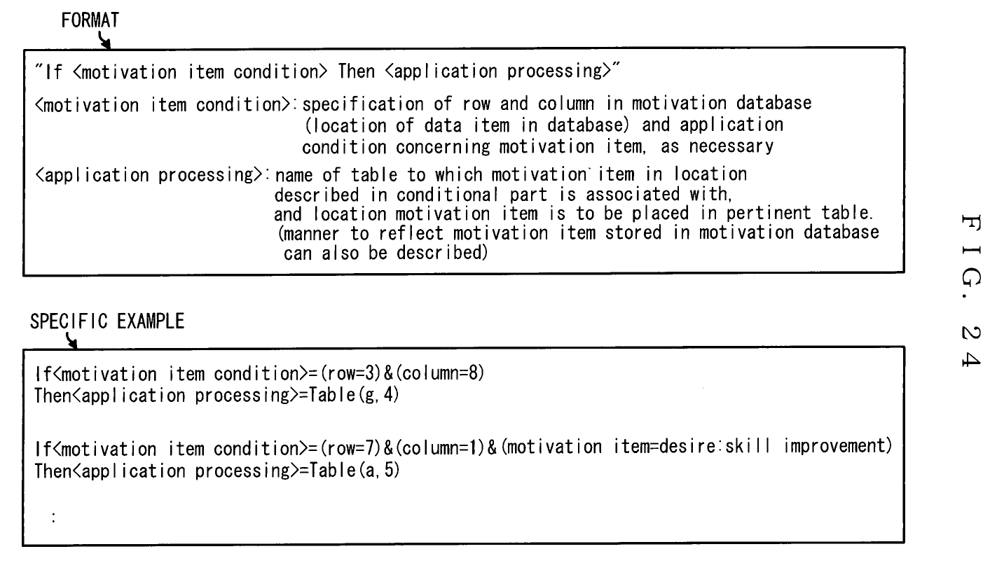

The motivation database conversion rule storing unit 412 stores the motivation database conversion rule which is utilized for the conversion of the results of motivation evaluation stored in the motivation database 409 into the motivation evaluation table in a desired format. The motivation database conversion rule is described in a format as shown in FIG. 24.

The conditional part of the motivation database conversion rule can specify a row and a column in the motivation database 409 (i.e., the location of the data item in the motivation database 409), and the condition to be applied to the motivation item as necessary. The executing part of the motivation database conversion rule describes processing such as matching of the motivation item (result of evaluation) located in a position specified in the conditional part to a predetermined position in an evaluation table with a desired format (an evaluation table according to a desired motivation definition system as illustrated in FIGS. 22 and 23, for example), use of the motivation item stored in the motivation database 409 without change, or storage of the results after a certain operation (e.g., converting the results of motivation evaluation to a score according to a predetermined scoring system).

Here, the condition to be applied to the motivation items may be described only when necessary. At the conversion, if the conditional part includes a motivation database conversion rule which matches with all rows and columns in the motivation database 409, executing part is sequentially applied.

Specifically, the motivation database conversion rule is described as shown in FIG. 24, for example. FIG. 24 is an example of the motivation database conversion rule for converting the data in the motivation database 409 into an evaluation table complying with a desired motivation definition system (specifically, the illustrative evaluation table according to the desired motivation definition system of FIG. 22).

[3-3: Process Sequence of Motivation Evaluation Apparatus]

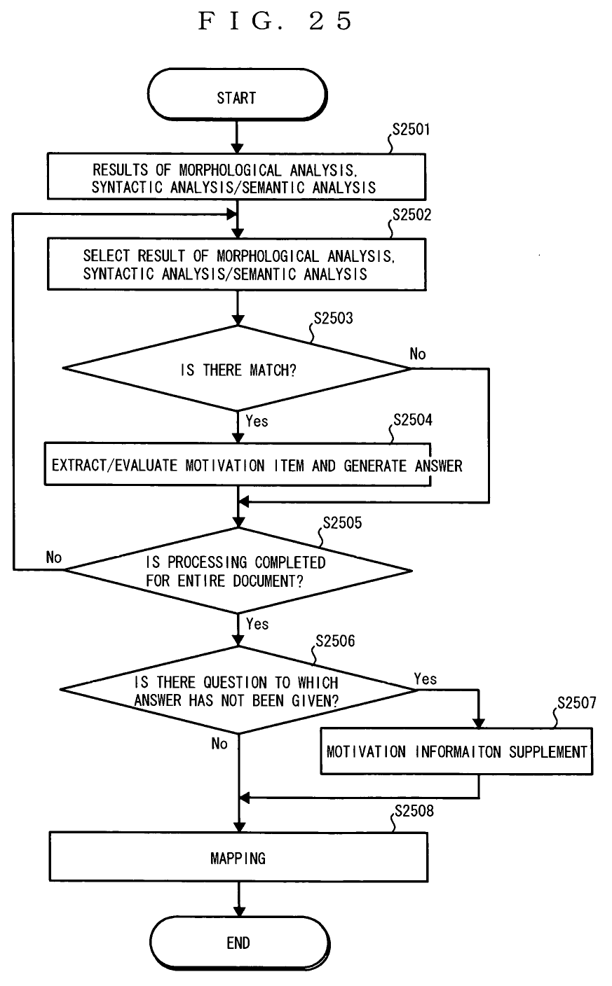

Next, the process sequence of the motivation evaluation apparatus 400 according to the third embodiment is described. FIG. 25 is a flowchart of the process sequence of the motivation evaluation apparatus 400 according to the third embodiment. As shown in FIG. 25, the motivation evaluation apparatus 400 receives the document written in a natural language at the natural language processing unit 401 and performs the morphological analysis and the syntactic/semantic analysis thereon (step S2501).

Then, the matching unit 403 sequentially selects the results of the morphological/syntactic analysis on the document performed by the natural language processing unit 401 (step S2502) and determines whether there is a motivation mapping rule whose conditional part matches with the selected result of the morphological/syntactic analysis (step S2503).

When, as a results, there is a motivation mapping rule with the conditional part that matches with the selected result of the morphological/syntactic analysis, the application processing unit 405 extracts the motivation item from the result of the morphological/syntactic analysis (or the input document) selected by the matching unit 403, evaluates the extracted motivation item, to generate an answer to a question which the result is associated with by the executing part of the matched motivation mapping rule (step S2504). On the other hand, when there is no motivation mapping rule which has the conditional part matching with the selected result of the morphological/syntactic analysis, the application processing unit 205 does not perform any processing on the result of the morphological/syntactic analysis (input document).

Then, the motivaiton evaluation apparatus 400 checks if the processing of the entire document has been finished or not (step S2505). When the processing of the entire document has not been completed, the motivation evaluation apparatus 400 returns to step S2502 and starts processing a next sentence. On the other hand, when the processing of the entire document has been finished, the motivation evaluation apparatus 400 checks if there is a question to which an answer has not been given in the Q&A table (step S2506). When the motivation evaluation apparatus 400 finds a non-answered question, the motivation information supplement processing unit 407 performs a motivation information supplement process by acquiring an answer from the evaluatee, for example (step S2507).

Here, questions in the Q&A table may be classified into a mandatory question and an optional question, and such information may be provided in the Q&A table. Then, the motivation information supplement processing unit 4207 may perform the supplement process only on the mandatory question. Then, an efficient motivation evaluation can be carried out only with necessary information regardless of the amount of the questions.

Then, the mapping unit 408 performs a process as described in the “RESPONSE” box of the Q&A table stored in the Q&A information storing unit 406, thereby storing the motivation item in the location of a data item with a predetermined motivation category and a motivation level in the motivation database 409 (step S2508).

When there are many evaluatees, the Q&A table, data (table) in the motivation database 409, or the like are generated for each evaluatee in the above-described process.

Thus, the matching unit 403 performs the matching process between the sentence analyzed by the natural language processing unit 401 and the motivation mapping rule; the application processing unit 405 generates an answer to the Q&A table when there is a motivation mapping rule matching with the analyzed sentence using the executing part of the motivation mapping rule; and mapping unit 408 maps the answer in the Q&A table into the data item in the motivation database 409 to store the answer in the motivation database 409, whereby the motivation item can be extracted from the document written in the natural language for evaluation and be stored in the motivation database 409.

[3-4: Advantages]

As can be seen from the foregoing, in the motivation evaluation apparatus 400 according to the third embodiment: the natural language processing unit 401 performs the syntactic analysis and the semantic analysis on each sentence in the document, e.g. an application or a response to a motivation-related questionnaire, written in the natural language; the motivation mapping rule storing unit 402 stores the motivation mapping rule associating the motivation item and the question item in the Q&A table; the matching unit 403 finds a match between each sentence analyzed by the natural language processing unit 401 and the motivation mapping rule; the application processing unit 405 generates an answer to a question item which is associated with a matched sentence found by the matching unit 403 according to the motivation mapping rule and stores the answer in the Q&A information storing unit 406; and the mapping unit 408 maps the answer stored in the Q&A information storing unit 406 to the data item in the motivation database 409, whereby the motivation database 409 can be automatically generated from the sentences written on the motivation in the natural language.

Further, the motivation evaluation by automatic extraction of motivation items from the document written in the natural language performed, for example, in the motivation evaluation apparatus 400 described in the third embodiment above has the following advantages similarly to the first embodiment described above: (1) extraction of the specific motivation item is possible (for example, when the evaluatee hopes to improve his/her expertise, the field in which the expertise improvement is desired, for example, whether in the network technology or database technology can be extracted); (2) extraction of detailed information or supplementary information is possible for each motivation item (for example, whether the desire is ordinary or strong); (3) more comprehensive extraction of motivation can be realized; and (4) plural pieces of information can be associated with one question as answers.

[3-5: Other Embodiments of Motivation Evaluation Apparatus]

In the third embodiment, the association with the Q&A table is performed according to the <application processing> in the executing part of the motivation mapping rule. However, in the <application processing> of the motivation mapping rule, associated data can be modified. Hence, the association may not be to the Q&A table but directly to the motivation database.

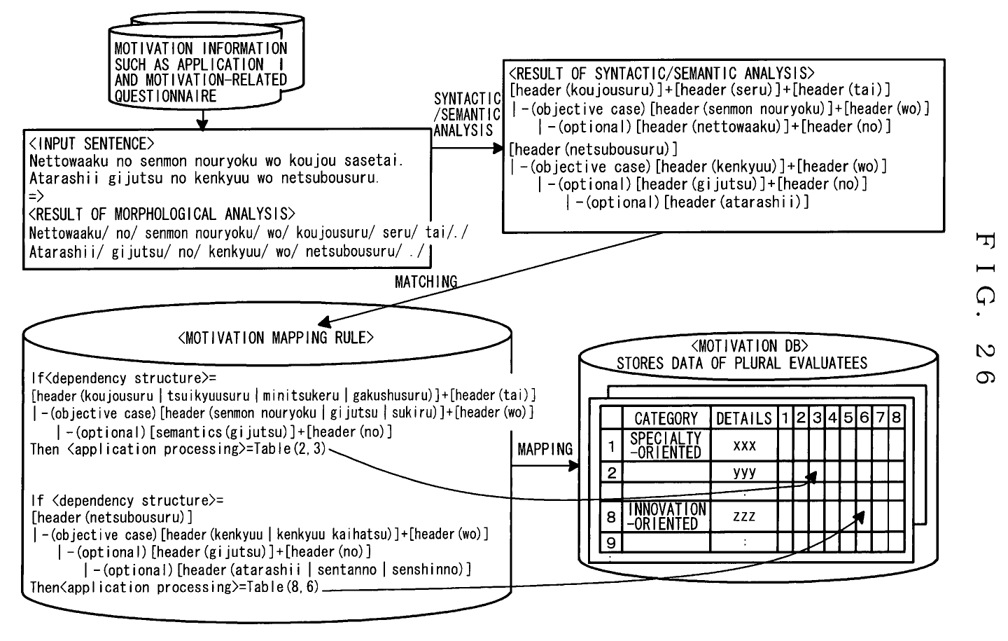

FIG. 26 is an explanatory diagram of a motivation evaluation apparatus which performs the direct association to the motivation database. As shown in FIG. 26, in the motivation evaluation apparatus, the motivation mapping rule directly associates the motivation sentence written in the natural language to the motivation database.

Further, though in the above, the description is given on the technique to convert the data in the motivation database to the motivation evaluation table (an evaluation table according to a desired motivation definition system as illustrated in FIGS. 22 and 23) according to the motivation database conversion rule, the data can be directly associated with a table (evaluation table, for example) in a desired format such as the above-described motivation evaluation table or the like according to the motivation mapping rule. Specifically, in a motivation mapping rule:

```
If <dependency structure>=
[header(koujousuru | tsuikyusuru | minitsukeru |
gakushusuru)]+[header(tai)]
|-(objective case)[header(senmon nouryoku | gijutsu |
sukiru)]+[header(wo)]
  |-(optional)[semantics (gijutsu)]+[header (no)]
(JE)
If <dependency structure>=
[header(hope to)]+[header(improve | pursuit | acquire | learn)]
|-(objective case)[header(expertise | technique | skill)]
  |-(optional)[semantics (technique)]
(EE)
```

Then<application processing>=Table(2,3), the <application processing> is “Table(2.3)” which specifies the association to the data item identified by (2,3) in the motivation database.

Further, in the part,

```
If <dependency structure>=
[header(netsubousuru)]
|-(objective case)[header(kenkyuu|kenkyuu kaihatsu)]+[header(wo)]
  |-(optional)[header(gijutsu)]+[header(no)]
    |-(optional)[header(atarashii | sentan-no | senshin-no)]
(JE)
If <dependency structure>=
[header(aspire for)]
|-(objective case)[header(study | develop)]
| |-(optional) [header(technology)]
| |-(optional)[header(new | advanced | leading-edge )]
|-(subjective case)[header (I)]
(EE)
```

Then<application processing>=Table(8.6), the <application processing> is “Table(8.6)” which specifies the association to the data item identified by (8.6) in the motivation database.

Thus, when the direct association to the motivation database is realized by the executing part of the motivation mapping rule instead of the Q&A table, an efficient creation of the motivation database can be realized.

In the third embodiment described above, the evaluation item is mapped to the evaluation table such as a radar chart of FIG. 22 or a matrix chart of FIG. 23. However, these evaluation tables are merely illustrative and the present invention is similarly applicable to an apparatus which maps the evaluation item to an evaluation table of different format.

For example, the evaluation table is not limited to a visual format such as “radar format or matrix format,” and the characters to be considered in the evaluation is not limited to those shown in FIGS. 22 and 23 such as “innovation-oriented character or specialty-oriented character,” and the characters such as “realistic, research-oriented, artistic, social, entrepreneur-like, conventional” can be applied as necessary.

In addition, though in the third embodiment the motivation items of an individual evaluatee are mapped into the evaluation table (see FIGS. 22 and 23), the present invention is not limited thereto. The present invention is similarly applicable, for example, to the mapping of the motivation items of many personnel in a predetermined organization into the evaluation table.

In such case, a conversion rule designed for an organization is stored in the motivation database conversion rule storing unit 412 in addition to the conversion rule designed for an individual so that the motivation items of plural persons are reflected in the evaluation table. Then, a conversion rule may be set so that one motivation item in which a person shows a highest motivation level among all motivation items (for example, an item which is plotted farthest from the origin among all plotted items as illustrated in the evaluation table of FIG. 22) is extracted as a representative motivation item or level of the person and such motivation item is extracted for each person in the organization to be mapped into the evaluation table as shown in FIGS. 22 and 23. The processing or operation for the extraction of the representative motivation item or level can be described in <motivation item condition> in the format shown in FIG. 24.

The radar chart shown in FIG. 22 is suitable for a visual illustration of the inclination of individual motivation, whereas the matrix chart shown in FIG. 23 is suitable for a comprehensive illustration of the inclination of motivation in an organization (for example, in order to show the distribution of motivation items/levels of plural personnel in the same section).

### 4: Fourth Embodiment (Motivation Evaluation System)

In the second embodiment, the description is given on the skill evaluation system which associates the results of evaluation of “skill” as individual ability with the information on job vacancy (personnel search) or with the integrated employment information, or the like to widely utilize the evaluation results. The present invention, however, is not limited to such embodiment. For example, the present invention is similarly applicable to the association and utilization of the results of individual motivation evaluation with the integrated employment information, or to the association and utilization of the results of evaluation of any individual ability which can be considered at the reviews of job applications or internal transfers with the integrated employment information.

Hence, in the fourth embodiment below, a description is given on a motivation evaluation system which utilizes the result of evaluation of individual motivation, as an example of utilization of the result of evaluation of individual ability in association with the integrated employment information similarly to the second embodiment. The description of the fourth embodiment can be understood similarly to the description of the second embodiment, with the term “skill” replaced with the term “motivation”.

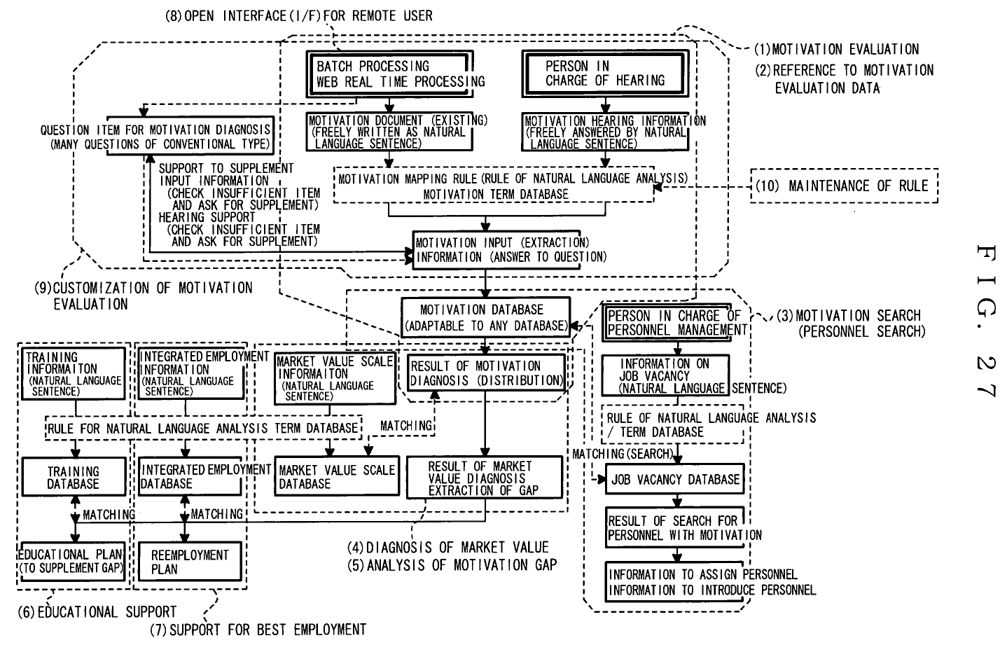

In the fourth embodiment, description is given with reference to FIGS. 27 to 31 on a functional structure of the motivation evaluation system according to the fourth embodiment ([4-1: Functional Structure of Motivation Evaluation System]), a screen structure of the motivation evaluation system according to the fourth embodiment ([4-2: Screen Structure of Motivation Evaluation System]), and a process sequence of the motivation evaluation system according to the fourth embodiment ([4-3: Process Sequence of Motivation Evaluation System]).

[4-1: Functional Structure of Motivation Evaluation System]

First, the functional structure of the motivation evaluation system according to the fourth embodiment is described. FIG. 27 is a diagram of the functional structure of the motivation evaluation system according to the fourth embodiment.

As shown in FIG. 27, the motivation evaluation system has functions such as (1) motivation evaluation, (2) reference of motivation evaluation data, (3) motivation search (personnel search), (4) diagnosis of market value, (5) analysis of motivation GAP, (6) educational support, (7) support for best employment, (8) open interface (I/F) for remote user, (9) customization of motivation evaluation, and (10) maintenance of rule.

The motivation evaluation function includes: fetching and shaping of motivation information; the morphological analysis and the syntactic analysis of motivation information; mapping of motivation items extracted after the morphological/syntactic analysis into the motivation database (or to the evaluation table according to a desired motivation definition system) according to the motivation mapping rule; analysis and evaluation; storage of the results of motivation evaluation into the motivation database; analysis of individual tendency; and compilation of data per company and output of the result of trend analysis. The motivation evaluation function is one of the functions of the motivation evaluation apparatus shown according to the third embodiment. The function of reference to the motivation evaluation data is a function such as a display of a list of the evaluatees, and a detailed display of the results of the evaluation for each evaluates.

The function of motivation search is a function such as a search of the results of motivation evaluation (motivation database), a display of a list, a detailed display, and a support for the analysis of intra-company trends. In addition, according to the function of the motivation search, a job vacancy item (corresponding to the motivation item in the motivation evaluation) is extracted from job vacancy information written in the natural language, and the extracted job vacancy item is associated with a job vacancy database (corresponding to the motivation database in the motivation evaluation, and having the same data structure as the motivation category and the motivation level in the motivation database) and stored in a predetermined location according to a job vacancy mapping rule described with a similar data structure to the motivation mapping rule used in the motivation evaluation similarly to the motivation evaluation by the motivation evaluation apparatus of the third embodiment.

The job vacancy item in the job vacancy database is matched with the results of motivation evaluation for all evaluatees in the motivation database. When there is an evaluatee whose data matches with the job vacancy item, the evaluatee is extracted. Thus, the person with the specified motivation can be found.

The function of the diagnosis of market value is a function such as determination of market value. According to the function of the market value diagnosis, a market value scale item (corresponding to the motivation item in the motivation evaluation) is extracted from market value scale information written in the natural language, and the extracted market value scale item is associated with a market value scale database (corresponding to the motivation database in the motivation evaluation, and having the same data structure as the motivation category and the motivation level in the motivation database) and stored in a predetermined location according to a market value scale mapping rule described with a similar data structure to the motivation mapping rule used in the motivation evaluation similarly to the motivation evaluation by the motivation evaluation apparatus of the third embodiment.

The market value scale database stores a result of motivation evaluation expected from a person with a standard motivation in the market for each job type and for each motivation level separately. The result of the motivation evaluation of an evaluatee under the diagnosis of market value is matched with the data item of corresponding job type in the market value scale database. Then, the motivation level of the person can be determined (i.e., the standard person in which motivation level of which job type is closest to the diagnosed person is determined) for the determination of his/her market value.

The function of the motivation GAP analysis is a function such as an extraction of GAP with respect to the specified job type. When a certain motivation level is set as a target level in a matching condition for the person under market value diagnosis, a GAP from the target value can be calculated.

The market value and the GAP obtained as a result of these processing have the same structure as the data item (in terms of structure of motivation category or motivation level) in the motivation database or the data in the market value scale database.

The function of the educational support is a function such as a support to formulate an educational plan according to the motivation GAP. According to the function of the educational support, a training item (corresponding to the motivation item in the motivation evaluation) is extracted from training information written in the natural language, and the extracted training item is associated with a training database (corresponding to the motivation database in the motivation evaluation, and having the same data structure as the motivation category and the motivation level in the motivation database) and stored in a predetermined location according to a training mapping rule described with a similar data structure to the motivation mapping rule used in the motivation evaluation similarly to the motivation evaluation by the motivation evaluation apparatus of the third embodiment.

The training database stores a result of motivation evaluation expected from a person with a standard motivation in the market (classified according to the job type, motivation level, or the like) and the name of the training item required to be categorized into each motivation level (similarly to the storage of the motivation-related names in the motivation database). Then, the training item is extracted corresponding to the GAP detected in the diagnosis of the market value.

The function of the support for best employment is a function such as a support to formulate a best employment plan according to the motivation GAP. According to the function of the best employment support, an integrated employment item (corresponding to the motivation item in the motivation evaluation) is extracted from integrated employment information written in the natural language, and the extracted integrated employment item is associated with an integrated employment database (corresponding to the motivation database in the motivation evaluation, and having the same data structure as the motivation category and the motivation level in the motivation database) and stored in a predetermined location according to an integrated employment mapping rule described with the similar data structure to the motivation mapping rule used in the motivation evaluation similarly to the motivation evaluation by the motivation evaluation apparatus of the third embodiment.

The data item (motivation category or motivation level) in the integrated employment database has basically the same structure as the data in the motivation database. The integrated employment information database stores various information such as information of the standard motivation required in the job market, and information on actual job vacancy classified by various categories such as a job type and motivation level as the result of motivation evaluation (motivation holding condition). The data item in the integrated employment information database is matched with the market value (or the result of motivation evaluation) of the evaluatee to extract the matched data item from the integrated employment information database as a candidate employer.

Here, it is possible to take the motivation GAP into consideration so that the evaluatee is treated as a person with a higher motivation level at the matching. Here, it is also possible to find a match between the training data and the motivation GAP so that the educational support can be provided to supplement the GAP.

The function of the open interface (I/F) for remote user is a function such as a function to allow easy self-diagnosis of the motivation by any user on the web, and a function to allow acquisition of various know-how. The function of the customization of motivation evaluation (support to facilitate input to answer the question, audio support) is a function such as a function to prompt an input concerning an item which cannot be acquired from the motivation information extracted from the natural language document, a function (tool) to analyze the Q&A on real-time and to prompt an acquisition (question) of lacked data, and a function (expert system) to ask question and to acquire answer via a notebook computer as a stand alone (or via the open I/F). The function of the rule maintenance is a function such as an automatic extraction of a rule.

[4-2: Screen Structure of Motivation Evaluation System]

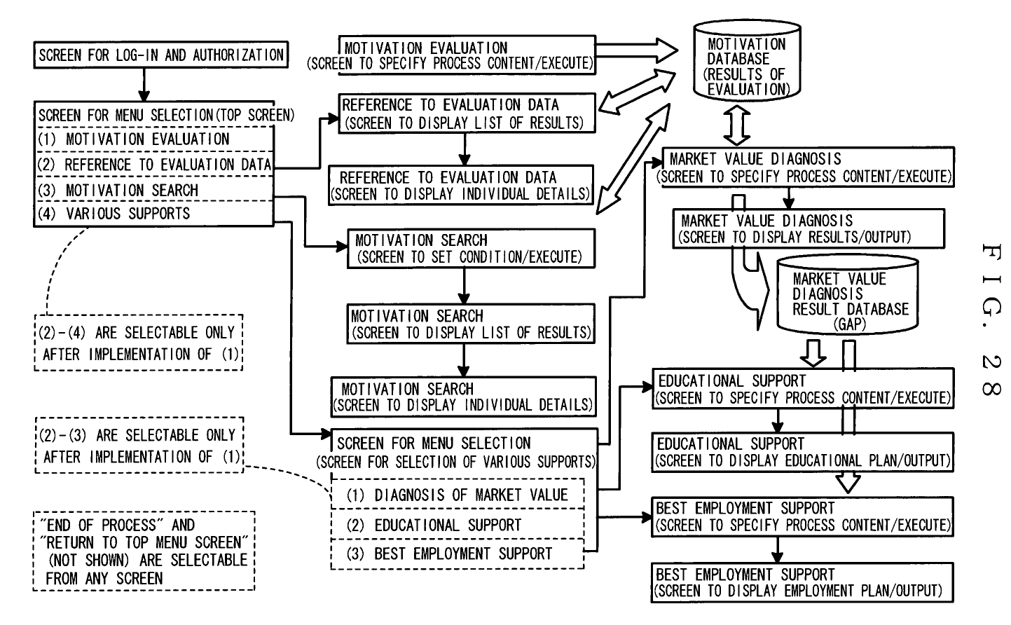

Next, the screen structure of the motivation evaluation system according to the fourth embodiment is described. FIG. 28 is a diagram of the screen structure of the motivation evaluation system according to the fourth embodiment. As shown in FIG. 28, the motivation evaluation system first displays a screen for log-in and authorization. When the user is successfully authorized, the motivation evaluation system displays a screen for menu selection (top screen).

The user selects one item from the menu, i.e., the motivation evaluation, the reference to evaluation data, motivation search, or the various supports on the screen for menu selection. When the user selects the various support menu, another screen is displayed to prompt the user to select the market value diagnosis, the educational support, or the best employment support.

The menu items, i.e., the reference to evaluation data, the motivation search, and the various supports are selectable only after the user goes through the motivation evaluation. The user can select “end of process” or “return to the top menu screen” from any screen.

[4-3: Process Sequence of Motivation Evaluation System]

Next, the process sequence of the motivation evaluation system is described.

[4-3-1] Process of Log-In and Authorization

(1) Access to a predetermined URL on the WEB.

(2) Ask for authorization.

(3) When the user is authorized, proceed to the menu screen (top screen).

(4) When the user is not authorized, display an “error message” and end the process.

[4-3-2] Process of Menu Selection (Top Screen)

(1) Display the menu and prompt the user to select.
1: Motivation Evaluation
2: Reference to evaluation data
3: Motivation Search
4: Various supports
5: End

(2) Proceed to a process (screen) selected in (1)

Here, “2: Reference to evaluation data” to “4: Various supports” are selectable only when “1: Motivation Evaluation” has already performed.

[4-3-3] Process of Motivation Evaluation

<Preprocess>

Following is performed as the preprocess.

(1) Set “Original Motivation Information File”

Import a file of a predetermined format which describes the motivation of each evaluatee, and set the file in an “original motivation information file storage folder”. A method and a content of description are not specified.

(2) Set “Original Evaluatees' List”

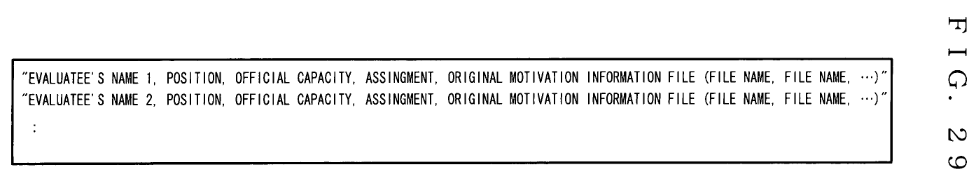

FIG. 29 is a diagram of an example of a format of the original evaluatees' list. Formulate a CSV file with a format as shown in FIG. 29 in advance and set in an “original motivation information file storage folder”.

Any data can be employed as the original evaluatees' list as far as the data can uniquely identify the association between each name of evaluatee and motivation information. The description on the type of job and the position can be omitted. At least one original motivation information file must be specified.

(3) Create “Motivation Information File”

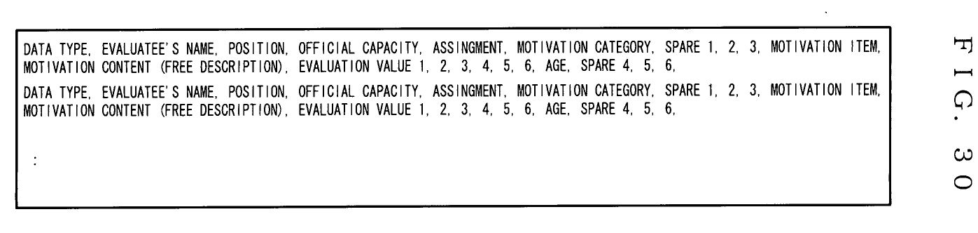

Create a motivation information file with a format as shown in FIG. 30 with reference to the files (1) and (2). Set the created file into the “motivation information file storage folder”. The motivation information file contains data on the evaluatee's name, position, official capacity, and assignment, as well as data of each sentence extracted from the original motivation information file in a motivation content box as one-row data per one sentence.

The motivation information file is created one for each evaluatee. mandatory items are the name of the evaluatee and the motivation content (any description is acceptable). When there is no information, the box is basically left blank. The motivation item is described within the length of one row. When the item includes a linefeed code, the item should be modified to fit into one row. The motivation content should be one sentence (without a linefeed code) for one motivation item. When the original motivation information contains many sentences for one motivation item, data is made to extend over plural rows with other copied data such as the motivation item.

(4) Set “Evaluatees' List”

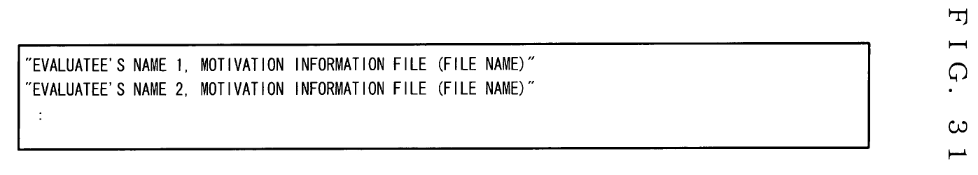

Create a CSV file of a format as shown in FIG. 31 and set the created file with a desired content into the “motivation information file storage folder.” The file name should be same with the file name of the original evaluatees' list.

<Process of Motivation Evaluation>

(1) Specify input/output data

(1-1) Display an input BOX and prompt to specify the file name of the “evaluatees' list” set in the “motivation information file storage folder.”

(1-2) Display the input BOX and prompt to specify the file names of the “motivation database storage folder” and the “motivation database” of the result of the motivation evaluation.

(2) Prompt to select one of an execution button/a cancel button (an end button).

(3) If the “cancel” button is selected, return to the screen of upper level.

(4) If the “execution” button is selected, reconfirm the “specified content” and start the process from (5).

(5) Take in the data for each evaluatee in the list and perform the following motivation evaluation (for each individual).

(5-1) OPEN the evaluatees' list.

(5-2) Take in the data (evaluatee's name, motivation information file (file name)) of one evaluatee from the evaluatees' list (when the process completes for all evaluatees, CLOSE the evaluatees' list and proceed to (6).

(5-3) Initialize the data for one evaluatee.
1: “Information on Results of Rule Application”
2: “Collection of Answers to Questions (mandatory level and optional level are specified)”

(5-4) Set the evaluatee's name as a process ID.

(5-5) OPEN the motivation information file.

(5-6) Read in each sentence from the motivation information file and perform the following process of motivation evaluation (for each motivation) thereon. When there is no remaining evaluatee's data, CLOSE the motivation information file and proceed to (5-7).

(5-6-1) Read the motivation information

Read one row of the motivation information (when all data are read, finish the process).

(5-6-2) Set Known Item

Set variables of the known items such as the position, official capacity, assignment, and motivation item (category) or the like. The set variables are utilized at the rule application.

(5-6-3) Morphological analysis/syntactic analysis of the motivation content (natural language sentence)

Fetch the motivation content (natural language sentence) and perform the morphological analysis and the syntactic analysis (semantic analysis).

(5-6-4) Match the result of the morphological analysis and the syntactic analysis (semantic analysis) with the motivation mapping rule and apply if there is a rule to be applied. Then, the result is stored as data (“information of result of rule application”) with the structure having “evaluatee's ID, original sentence, hit content, hit rule, and application processing.”

(5-6-5) Perform mapping to the Q&A table based on the result in (5-6-4). When there is no answer to the mandatory question, raise alarm and execute a suitable process.

(5-6-6) Return to (5-6-1)

(5-7) Write in the result of evaluation of (one) evaluatee

Following the mapping process to data in the Q&A table, map the data in corresponding location in the motivation database 409.

(5-8) Proceed to the process of motivation evaluation (for individual) (5-2) of the next evaluatee

(6) Data output

When the evaluation is completed for all the evaluatees, write in the data into the “motivation database” in the “motivation database storage folder.”

(7) End the process and return to the screen of upper level.

[4-3-4] Process of Reference to Evaluation Data (Screen to Display List of Results)

(1) Display the input BOX (if there are plural motivation databases) and prompt to specify a motivation database. Thereafter, if the user selects an OK button, display data of evaluatees' list in the motivation database selected in (1).

(2) Display “end” button, “previous/next” button, “display individual details” button (set for each evaluatee) and process according to the selected content.

(2-1) If the “end” button is selected, return to the screen of upper level.

(2-2) if the “previous/next” button is selected, move to a previous page or a next page, and display the data of the list.

(2-3) If the “display individual details” button is selected, display detailed information on the result of motivation evaluation for the pertinent evaluatee.

[4-3-5] Process of Reference to Evaluation Data (Screen Displaying Individual Details)

(1) Display detailed data of the result of evaluation of the evaluatee.

(2) Display the “end” button and the “previous/next” button, and perform processing according to the selected content.

(2-1) If the “end” button is selected, return to the screen of upper level.

(2-2) if the “previous/next” button is selected, move to a previous page or a next page, and display the detailed data of the list.

[4-3-6] Process of Motivation Search (Screen to Set Condition/Execute)

(1) Display the input BOX (if there are plural motivation databases) and prompt to specify a motivation database. Thereafter, if the OK button is selected,

(2) Display the search condition input BOX and prompt to input a search condition. Here, the search condition can be specified by:

\textcircled{1} free word, and

\textcircled{2} selection of predetermined motivation content (motivation category, motivation level, or specific motivation item).

(3) Thereafter, if a search execution button is selected, proceed to the motivation search (screen displaying the list of results). If the “end” button is selected, return to the screen of upper level.

[4-3-7] Process of Motivation Search (Screen to Display List of Results)

(1) Display the list of search results.

(2) If the “return” button is selected, return to the screen for search condition setting (screen of upper level).

(3) If the “detailed display” button of each row in the data list is selected, proceed to a “screen displaying individual details” of each evaluatee.

[4-3-8] Process of Motivation Search (Screen Displaying Individual Details)

(1) Display “individual detailed information” for each evaluatee.

(2) If the “return” button is selected, return to the screen for search condition setting (screen of upper level).

[4-3-9] Process of Menu Selection Screen (Screen for Selection of Various Supports)

Prompt to select from the following menu and proceed to the selected screen.

(1) Diagnosis of Market Value

(2) Educational Support

(3) Support for Best Employment

[4-3-10] Process of Market Value Diagnosis (Screen to Specify Process Content/Execute)

<Building Market Value Scale Database>

The market value scale database is built by some tool or the like at the installation of the motivation evaluation system as a part of the process of creating the “market value scale database” on the side of the system (process algorithm, rule, and dictionary are basically the same with the motivation evaluation process. Only the storage file or the like of the data is different.)

Information of “market value scale” described in the natural language is regarded as the motivation information for one user, evaluated similarly to the motivation evaluation in the <preprocess> or <motivation evaluation process> and stored in the “market value scale database.” Then, the “market value scale” is compiled into a database for various job types, assigning different user for each job type.

<Diagnosis Process>

(1) Display the input BOX (if there are plural motivation databases) and prompt to specify a motivation database. In addition prompt to specify the “evaluatee to be diagnosed.”

(2) Prompt to specify a target job type (prompt to specify a job type in a list).

(3) Process according to the content selected via the “end” button or “execution” button.

(3-1) If the “end” button is selected, return to the screen of upper level.

(3-2) If the “execution” button is selected, perform diagnosis process. After the completion of the diagnosis process, proceed to the “screen to display results/output.”

(3-2-1) Match the result of individual motivation evaluation and the market value and find the gap (the evaluated items in each database are the same).

(3-2-2) Store the results for each “name of evaluatee” in the “market value scale GAP storing database.”

[4-3-11] Process of Market Value Diagnosis (Screen to Display Results/Output)

(1) Display the “GAP from the market value scale” in the specified job type of the evaluatee

[4-3-12] Process of Educational Support (Screen to Specify Process Content/Execute)

<Building of Training Database>

The training database is built by some tool or the like at the installation of the motivation evaluation system (including the time of updating of the training information) as a part of the process of creating the “training database” on the side of the system (process algorithm, rule, and dictionary are basically the same with the motivation evaluation process. Only the storage file of the data or the like is different.)

The “educational plan” (e.g., training curriculum) described as the natural language sentence is considered to be the motivation information of a user, and processed similarly to the motivation evaluation process and stored in the “training database.” The “educational plan” is compiled into a database for various job types, assigning different user for each job type.

<Process of Support for Educational Plan Formulation>

(1) Display an input BOX (if there are plural motivation databases), and prompt to specify a motivation database. In addition, prompt to specify the “name of the diagnosed.”

(2) Prompt to specify a target job type (prompt to specify a job type of his/her wish in a list).

(3) Process according to the content selected via the “end” button or the “execution” button.

(3-1) If the “end” button is selected, return to the screen of upper level.

(3-2) If the “execution” button is selected, perform the diagnosis process. After the completion of the diagnosis process, proceed to the “screen to display results/output.”

(3-2-1) Find matches between the GAP detected in the market value scale diagnosis and the training database, to extract the training item corresponding to the GAP.

(3-2-2) Store the results as the data of the “educational plan” for the “name of the diagnosed.”

[4-3-13] Process of Educational Support (Screen to Display Educational Plan/Output)

(1) Display the “educational plan” for the target job type specified by the evaluatee.

[4-3-14] Process of Best Employment Support (Screen to Specify Process Content/Execute)

<Building of Integrated Employment Database>

The integrated employment database is built by some tool or the like at the installation of the motivation evaluation system (including the time of updating of the integrated employment information) as a part of the process of creating the “integrated employment database” on the side of the system (process algorithm, rule, and dictionary are basically the same with the motivation evaluation process. Only the storage file of the data or the like is different.)

The “integrated employment data” (e.g., information on job vacancy) described as the natural language sentence is considered to be the motivation information of a user, and processed similarly to the motivation evaluation process and stored in the “integrated employment database.” The “integrated employment data” is compiled into database for various job types, assigning different user for each job type.

<Process of Support of Formulation of Reemployment (Best Employment Plan)>

(1) Display the input BOX (if there are plural motivation databases) and prompt to specify a motivation database. In addition prompt to specify the “name of the diagnosed.”

(2) Prompt to specify the target job type (prompt to specify a job type of his/her wish in a list).

(3) Process according to the content selected via the “end” button or “execution” button.

(3-1) If the “end” button is selected, return to the screen of upper level.

(3-2) If the “execution” button is selected, perform the diagnosis process. After the completion of the diagnosis process, proceed to the “screen to display results/output.”

(3-2-1) Find matches between the results of market value scale diagnosis and the integrated employment database, and extract the data item (candidate employer) corresponding to the market value from the best employment plan database.

(3-2-2) Store the results as the data of the “reemployment plan (best employment plan)” for the “name of the diagnosed.”

[4-3-15] Process of Best Employment Support (Screen to Display Employment Plan/Output)

(1) Display the “best employment plan” in the target job type of the evaluatee.

As described above, in the fourth embodiment, the data on job vacancy is stored in the job vacancy database. The job vacancy data stored in the job vacancy database is matched with the motivation items stored in the motivation database for the search of appropriate personnel, whereby personnel with a necessary motivation can be found.

Further, according to the fourth embodiment, the job vacancy information written in the natural language is subjected to the natural language analysis, and the job vacancy data is extracted from the results of the natural language analysis and stored in the job vacancy database according to the job vacancy mapping rule. Hence, an efficient building of the job vacancy database is possible based on the documents written in the natural language about the job vacancy information.

Further, according to the fourth embodiment, the market value scale data is stored in the market value scale database, and the market value scale data stored in the market value scale database is matched with the results of motivation evaluation stored in the motivation database for the evaluation of individual's market value and the analysis of the motivation GAP. Thus, the correct diagnosis of the market value and the analysis of the motivation GAP are allowed based on the motivation.

Further, according to the fourth embodiment, the market value scale information written in the natural language is subjected to the natural language analysis, and the market value scale data is extracted from the results of the natural language analysis and stored in the market value scale database according to the market value scale mapping rule. Hence, an efficient building of the market value scale database is possible based on the documents written in the natural language about the market value scale information.

Still further, according to the fourth embodiment, the training data is stored in the training database, and the training data stored in the training database is matched with the results of motivation GAP analysis for the formulation of the individual educational plan. Thus, the educational plan can be created to supplement the motivation GAP.

Further, according to the fourth embodiment, the training information written in the natural language is subjected to the natural language analysis, and the training data is extracted from the results of the natural language analysis of the training information and stored in the training database according to the training mapping rule. Hence, an efficient building of the training database is possible based on the documents written in the natural language about the training information.

Still further, according to the fourth embodiment, the integrated employment data is stored in the integrated employment database, and the integrated employment data stored in the integrated employment database is matched with the results of the market value diagnosis for the formulation of the individual reemployment plan. Hence, the best employment plan (reemployment plan) appropriate in view of the individual motivation and the market value can be formulated.

Still further, according to the fourth embodiment, the integrated employment data is stored in the integrated employment database, and the integrated employment data stored in the integrated employment database can be matched with the results of the motivation GAP analysi for the formulation of individual reemployment plan. Hence, the best employment plan (reemployment plan) appropriate in view of the predetermined upgrading of the motivation can be formulated.

Further, according to the fourth embodiment, the integrated employment information written in the natural language is subjected to the natural language analysis, and the integrated employment data is extracted from the results of the natural language analysis and stored in the integrated employment database according to the integrated employment mapping rule. Hence, an efficient building of the integrated employment database is possible based on the documents written in the natural language about the integrated employment information.

### 5: Fifth Embodiment (Other Embodiments)

In the foregoing, the embodiments of the present invention are described. The present invention, however, can be realized in various forms as described below other than those described above.

In the embodiments described above, the “skill” and the “motivation” are evaluated as the individual ability. The present invention, however, is not limited to the above-described embodiments. The present invention is similarly applicable to the evaluation of any individual abilities, which can be considered at the review of job application or internal transfer.

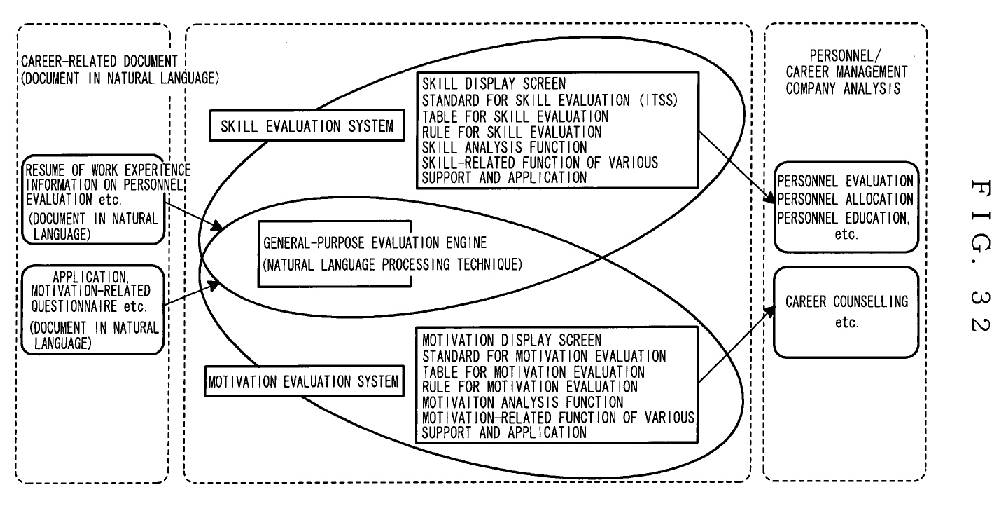

In addition, the skill evaluation apparatus and the motivation evaluation apparatus are described to be formed as separate apparatuses in the above embodiments. The present invention, however, is not limited to such structure, and the skill evaluation apparatus and the motivation evaluation apparatus can be integrated as illustrated in FIG. 32, so that the skill evaluation and the motivation evaluation are similarly realized in a general-purpose evaluation engine.

Further, each of the processes in the above embodiments described as performed automatically may partially or entirely performed manually, and each of the processes described as performed manually may partially or entirely performed automatically in a known method. The process sequence, the control sequence, the specific names, the information such as various data and parameters (particularly, the contents of the skill mapping rule and the motivation mapping rule, or the like) shown and described in the above description and in the accompanying drawings can be modified as necessary if not otherwise specified.

The components in the apparatus shown in the drawings (particularly the skill evaluation apparatus 200 illustrated in FIG. 2 and the motivation evaluation apparatus 400 illustrated in FIG. 17) are conceptual illustration and the physical structure thereof is not necessarily as shown in the drawings. In other words, the specific arrangement of respective components, i.e., integration and distribution, is not limited to the one shown in the drawings, and a part or a whole thereof can be modified as required according to various loads and the condition of use. The components can be structured based on any desirable unit so as to be functionally or physically integrated or separated. Still further, the processing function realized in each apparatus may be partially or entirely realized by a central processing unit (CPU) and a program which is analyzed and executed by the CPU, or may be realized as a hardware with a wired logic.

The method of processing through various process sequences described according to the embodiments (the skill evaluation process illustrated in FIG. 9, the motivation evaluation process illustrated in FIG. 25, for example) may be realized by a previously prepared program executed by a computer such as a personal computer and a workstation. The program can be distributed via a network such as the Internet. Further, the program may be recorded on the computer-readable recording medium such as a hard disc, a flexible disk (FD), a CD-ROM, a magnetooptic disc (MO), or a digital versatile disc (DVD), and read out from the recording medium and executed by a computer.

According to the embodiments, since the structure of the sentence written in the natural language is analyzed, the document written in the natural language about the individual ability can be understood for the extraction of the ability item, and the extracted ability item can be stored in the ability database. Further, according to the embodiments, the function of the apparatus can be modified or expanded through the modification and the addition of the ability mapping rule, whereby the ability evaluation apparatus with an excellent maintenance performance and expandability can be realized.

According to the embodiments, since the structure of the sentence written in the natural language is analyzed, the document written in the natural language about the skill can be understood for the extraction of the skill item, and the extracted skill item can be stored in the skill database.

Further, according to the embodiments, the function of the apparatus can be modified or expanded through the modification and the addition of the skill mapping rule, whereby the skill evaluation apparatus with an excellent maintenance performance and expandability can be realized. Similarly, according to the embodiments, since the structure of the sentence written in the natural language is analyzed, the document written in the natural language about the motivation can be understood for the extraction of the motivation item, and the extracted motivation item can be stored in the motivation database. Further, according to the embodiments, the function of the apparatus can be modified or expanded through the modification and the addition of the motivation mapping rule, whereby the motivation evaluation apparatus with an excellent maintenance performance and expandability can be realized.

According to the embodiments, since the syntactic structure and the semantic structure of the sentence written in the natural language is analyzed, the document written in the natural language about the skill can be understood for the extraction of the skill item, and the extracted skill item can be stored in the skill database. Similarly, according to the embodiments, since the syntactic structure and the semantic structure of the sentence written in the natural language is analyzed, the document written in the natural language about the motivation can be understood for the extraction of the motivation item, and the extracted motivation item can be stored in the motivation database.

Further, according to the embodiments, the extraction of the skill item can be performed only with the morphological analysis without the syntactic/semantic analysis which requires a relatively long processing time, whereby the efficient extraction of the skill item is realized. Further, even when the syntactic/semantic analysis is performed, if the pattern of appearance of the words (word list) in the skill description of the skill sentence is typical, the skill mapping rule can be created easily and efficiently only with the string of the morphemes (word list) without the description of the conditional part of the skill mapping rule with complicated dependency structure. Similarly, according to the embodiments, the extraction of the motivation item can be performed only with the morphological analysis without the syntactic/semantic analysis which requires a relatively long processing time, whereby the efficient extraction of the motivation item is realized. Further, even when the syntactic/semantic analysis is performed, if the pattern of appearance of the words (word list) in the motivation description of the motivation sentence is typical, the motivation mapping rule can be created easily and efficiently only with the string of the morphemes (word list) without the description of the conditional part of the motivation mapping rule with complicated dependency structure.

Further, according to the embodiments, the apparatus has a favorable compatibility with the conventional skill evaluation apparatus which receives the input of the answers in the Q&A table and stores the same in the database, the transition from the conventional skill evaluation apparatus can be easily realized. Similarly, according to the embodiments, the apparatus has a favorable compatibility with the conventional motivation evaluation apparatus which receives the input of the answers in the Q&A table and stores the same in the database, the transition from the conventional motivation evaluation apparatus can be easily realized.

Further, according to the embodiments, even when the skill information in the document written in the natural language is not sufficient, necessary information can be supplemented, whereby the skill information can be gathered without being negatively affected by the quality of the input document. Similarly, according to the embodiments, even when the motivation information in the document written in the natural language is not sufficient, necessary information can be supplemented, whereby the motivation information can be gathered without being negatively affected by the quality of the input document.

Further, according to the embodiments, the skill information is input via audio, whereby the skill information can be more easily input. Similarly, according to the embodiments, the motivation information is input via audio, whereby the motivation information can be more easily input.

Further, according to the embodiments, the conversion is performed with the use of the skill database conversion rule. Hence, the desired skill evaluation table such as the skill evaluation table complying with the ITSS (IT Skill Standard) formulated by the Japanese Ministry of Economy, Trade and Industry can be easily created with the skill database conversion rule. Similarly, according to the embodiments, the conversion is performed with the use of the motivation database conversion rule. Hence the desired motivation evaluation table can be easily created with the motivation database conversion rule.

Further, according to the embodiments, the personnel is searched based on the skill item, whereby the personnel with the necessary skill can be found. Similarly, according to the embodiments, the personnel is searched based on the motivation item, whereby the personnel with the necessary motivation can be found.

Further, according to the embodiments, since the structure of the sentence written in the natural language is analyzed, the document written in the natural language about the job vacancy information can be understood for the extraction of the job vacancy item, and the extracted job vacancy item can be stored in the job vacancy database. Further, according to the embodiments, the function of the apparatus can be modified or expanded through the modification and the addition of the job vacancy mapping rule, whereby the skill evaluation apparatus and the motivation evaluation apparatus with an excellent maintenance performance and expandability can be realized.

Further, according to the embodiments, the diagnosis of the individual evaluatee's market value and the analysis of the individual skill GAP are performed with the use of the result of skill evaluation, whereby the market value diagnosis and the skill GAP analysis can be correctly performed. Further, according to the embodiments, the diagnosis of the individual evaluatee's market value and the analysis of the individual motivation GAP are performed with the use of the result of motivation evaluation, whereby the market value diagnosis and the motivation GAP analysis can be correctly performed.

Further, according to the embodiments, since the structure of the sentence written in the natural language is analyzed, the document written in the natural language about the market value scale information can be understood for the extraction of the market value scale data, and the extracted market value scale data can be stored in the market value scale database. Further, according to the embodiments, the function of the apparatus can be modified or expanded through the modification and the addition of the market value scale mapping rule, whereby the skill evaluation apparatus and the motivation evaluation apparatus with an excellent maintenance performance and expandability can be realized.

Further, according to the embodiments, the educational plan is formulated based on the skill GAP, whereby the educational plan can be formulated to supplement the skill GAP. Similarly, according to the embodiments, the educational plan is formulated based on the motivation GAP, whereby the educational plan can be formulated to supplement the motivation GAP.

Further, according to the embodiments, since the structure of the sentence written in the natural language is analyzed, the document written in the natural language about the training information can be understood for the extraction of the training data, and the extracted training data can be stored in the training database. Further, according to the embodiments, the function of the apparatus can be modified or expanded through the modification and the addition of the training mapping rule, whereby the skill evaluation apparatus and the motivation evaluation apparatus with an excellent maintenance performance and expandability can be realized.

Further, according to the embodiments, the reemployment plan is formulated based on the market value and the skill GAP, whereby the reemployment plan can be formulated to realize the upgrading of the skill. Similarly, according to the embodiments, the reemployment plan is formulated based on the market value and the motivation GAP, whereby the reemployment plan can be formulated to realize the upgrading of the motivation.

Further, according to the embodiments, since the structure of the sentence written in the natural language is analyzed, the document written in the natural language about the integrated employment information can be understood for the extraction of the integrated employment data, and the extracted integrated employment data can be stored in the integrated employment database. Further, according to the embodiments, the function of the apparatus can be modified or expanded through the modification and the addition of the integrated employment mapping rule, whereby the skill evaluation apparatus and the motivation evaluation apparatus with an excellent maintenance performance and expandability can be realized.

### INDUSTRIAL APPLICABILITY

As can be seen from the foregoing, the ability evaluation apparatus, a method of evaluating ability, and a program for ability evaluation according to the present invention are suitable for understanding a document written in a natural language about individual abilities (skill or motivation, for example), extracting an ability item (skill item or motivation item, for example), and storing the extracted ability item in an ability database (skill database or motivation database, for example).

What is claimed is:

1. An ability evaluation apparatus which evaluates an individual ability and stores a result of evaluation in an ability database, comprising:
an ability mapping rule storing unit that stores an ability mapping rule which associates an ability item extracted from an ability sentence written in a natural language about an individual ability with a data item in the ability database using a structure of the ability sentence;
a natural language processing unit that analyzes each sentence in a document written in the natural language about the individual ability to output a result of structural analysis; and
an ability item storing unit that extracts the ability item from the result of structural analysis output from the natural language processing unit using the ability mapping rule stored in the ability mapping rule storing unit, and stores the extracted ability item in the ability database.

2. The ability evaluation apparatus according to claim 1 wherein,
the ability database is a skill database which stores a result of evaluation of an individual skill,
the ability mapping rule storing unit, as a skill mapping rule storing unit, stores a skill mapping rule which associates a skill item extracted from a skill sentence written in a natural language about a skill with a data item in the skill database using a structure of the skill sentence,
the natural language processing unit analyzes a structure of each sentence in a document written in the natural language about the individual skill to output a result of structural analysis, and
the ability item storing unit, as a skill item storing unit, extracts the skill item from the result of structural analysis output from the natural language processing unit using the skill mapping rule stored in the skill mapping rule storing unit, and stores the extracted skill item in the skill database.

3. The ability evaluation apparatus according to claim 2 wherein,
the skill mapping rule stored in the skill mapping rule storing unit includes a conditional part which is a syntactic/semantic structure of the skill sentence, and an executing part which is an association of the skill item with the data item in the skill database,
the natural language processing unit analyzes a syntactic structure and a semantic structure of each sentence in a document to output a result of the syntactic analysis and the semantic analysis, and
the skill item storing unit determines whether the result of the syntactic analysis and the semantic analysis output by the natural language processing unit matches with the conditional part of the skill mapping rule, and if there is a match, extracts the skill item from the result of the syntactic analysis and the semantic analysis, and stores the extracted skill item in the skill database based on the association in the executing part of the matched skill mapping rule.

4. The ability evaluation apparatus according to claim 3 wherein,
the skill mapping rule stored in the skill mapping rule storing unit includes a morphological structure in the conditional part in addition to the syntactic structure and the semantic structure,
the natural language processing unit outputs a result of morphological analysis in addition to the result of the syntactic analysis and the semantic analysis, and
the skill item storing unit determines whether the result of the syntactic analysis and the semantic analysis or the result of the morphological analysis output by the natural language processing unit matches with the conditional part of the skill mapping rule or not.

5. The ability evaluation apparatus according to claim 3 wherein,
the executing part of the skill mapping rule is an association of the skill item to a question in a question and answer table for the extraction of the skill item,
the question and answer table includes an association of the question with the data item in the skill database, and
the skill item storing unit uses the association of the skill item with the question in the question and answer table and the association of the question with the data item in the skill database, to store the skill item in the skill database.

6. The ability evaluation apparatus according to claim 5 further comprising:
a skill information supplementing unit which supplements an answer to a question in the question and answer table which answer has not been acquired after the extraction of the skill item from the document; and
a mapping unit that maps the answer in the question and answer table supplemented by the skill information supplementing unit to the data item in the skill database.

7. The ability evaluation apparatus according to claim 2 further comprising:
an audio recognizing unit that generates a document written in the natural language from audio information acquired via a hearing on the skill; and
the natural language processing unit performs the morphological analysis, the syntactic analysis, and the semantic analysis of each sentence in the document generated by the audio recognizing unit.

8. The ability evaluation apparatus according to claim 2 further comprising:
a skill database conversion rule storing unit that stores skill database conversion rules for conversion of the result of skill evaluation stored in the skill database into skill evaluation tables with different formats; and
an evaluation table format converting unit that converts the result of skill evaluation into the skill evaluation tables with different formats using the skill database conversion rules stored in the skill database conversion rule storing unit.

9. The ability evaluation apparatus according to claim 1 wherein,
the ability database is a motivation database which stores a result of evaluation of an individual motivation,
the ability mapping rule storing unit, as a motivation mapping rule storing unit, stores a motivation mapping rule which associates a motivation item extracted from a motivation sentence written in a natural language about a motivation with a data item in the motivation database using a structure of the motivation sentence,
the natural language processing unit analyzes a structure of each sentence in a document written in the natural language about the individual motivation to output a result of structural analysis, and
the ability item storing unit, as a motivation item storing unit, extracts the motivation item from the result of structural analysis output from the natural language processing unit using the motivation mapping rule stored in the motivation mapping rule storing unit, and stores the extracted motivation item in the motivation database.

10. The ability evaluation apparatus according to claim 9 wherein,
the motivation mapping rule stored in the motivation mapping rule storing unit includes a conditional part which is a syntactic/semantic structure of the motivation sentence, and an executing part which is an association of the motivation item with the data item in the motivation database,
the natural language processing unit analyzes a syntactic structure and a semantic structure of each sentence in a document to output a result of the syntactic analysis and the semantic analysis, and
the motivation item storing unit determines whether the result of the syntactic analysis and the semantic analysis output by the natural language processing unit matches with the conditional part of the motivation mapping rule, and if there is a match, extracts the motivation item from the result of the syntactic analysis and the semantic analysis, and stores the extracted motivation item in the motivation database based on the association in the executing part of the matched motivation mapping rule.

11. The ability evaluation apparatus according to claim 10 wherein,
the motivation mapping rule stored in the motivation mapping rule storing unit includes a morphological structure in the conditional part in addition to the syntactic structure and the semantic structure,
the natural language processing unit outputs a result of morphological analysis in addition to the result of the syntactic analysis and the semantic analysis, and
the motivation item storing unit determines whether the result of the syntactic analysis and the semantic analysis or the result of the morphological analysis output by the natural language processing unit matches with the conditional part of the motivation mapping rule or not.

12. The ability evaluation apparatus according to claim 10 wherein,
the executing part of the motivation mapping rule is an association of the motivation item to a question in a question and answer table for the extraction of the motivation item,
the question and answer table includes an association of the question with the data item in the motivation database, and
the motivation item storing unit uses the association of the motivation item with the question in the question and answer table and the association of the question with the data item in the motivation database, to store the motivation item in the motivation database.

13. The ability evaluation apparatus according to clam 12 further comprising:
a motivation information supplementing unit which supplements an answer to a question in the question and answer table which answer has not been acquired after the extraction of the motivation item from the document; and
a mapping unit that maps the answer in the question and answer table supplemented by the motivation information supplementing unit to the data item in the motivation database.

14. The ability evaluation apparatus according to claim 9 further comprising:
an audio recognizing unit that generates a document written in the natural language from audio information acquired via a hearing on the motivation; and
the natural language processing unit performs the morphological analysis, the syntactic analysis, and the semantic analysis of each sentence in the document generated by the audio recognizing unit.

15. The ability evaluation apparatus according to claim 9 further comprising:
a motivation database conversion rule storing unit that stores motivation database conversion rules for conversion of the result of motivation evaluation stored in the motivation database into motivation evaluation tables with different formats; and
an evaluation table format converting unit that converts the result of motivation evaluation into the motivation evaluation tables with different formats using the motivation database conversion rules stored in the motivation database conversion rule storing unit.

16. The ability evaluation apparatus according to claim 2 further comprising:
a job vacancy database that stores job vacancy data; and
a personnel searching unit that searches a suitable personnel by finding a match between the job vacancy data stored in the job vacancy database and the skill item stored in the skill database.

17. The ability evaluation apparatus according to claim 9 further comprising:
a job vacancy database that stores job vacancy data; and
a personnel searching unit that searches a suitable personnel by finding a match between the job vacancy data stored in the job vacancy database and the motivation item stored in the motivation database.

18. The ability evaluation apparatus according to claim 16 further comprising:
a job vacancy mapping rule storing unit that stores a job vacancy mapping rule which associates job vacancy data extracted from a job vacancy sentence written in a natural language about job vacancy with a data item in the job vacancy database using a structure of the job vacancy sentence;
a job vacancy information processing unit that analyzes a structure of each sentence of job vacancy information written in the natural language to output the result of the structural analysis; and
a job vacancy data storing unit that extracts the job vacancy data from the result of structural analysis output from the job vacancy information processing unit using the job vacancy mapping rule stored in the job vacancy mapping rule storing unit, and stores the extracted job vacancy data in the job vacancy database.

19. The ability evaluation apparatus according to claim 2 further comprising:
a market value scale database that stores market value scale data; and
a market value diagnosing unit that diagnoses an individual market value and analyzes a skill GAP by finding a match between the market value scale data stored in the market value scale database and the result of skill evaluation stored in the skill database.

20. The ability evaluation apparatus according to claim 9 further comprising:
a market value scale database that stores market value scale data; and
a market value diagnosing unit that diagnoses an individual market value and analyzes a motivation GAP by finding a match between the market value scale data stored in the market value scale database and the result of motivation evaluation stored in the motivation database.

21. The ability evaluation apparatus according to claim 19 further comprising:
a market value scale mapping rule storing unit that stores a market value scale mapping rule which associates a market value scale item extracted from a market value scale sentence written in a natural language about a market value scale with a data item in the market value scale database using a structure of the market value scale sentence;
a market value scale information processing unit that analyzes a structure of each sentence of market value scale information written in the natural language to output the result of the structural analysis; and
a market value scale data storing unit that extracts the market value data from the result of the structural analysis output by the market value information processing unit using the market value mapping rule stored in the market value mapping rule storing unit, and stores the extracted market value data in the market value database.

22. The ability evaluation apparatus according to claim 19 further comprising:
a training database that stores training data; and
an educational supporting unit that formulates an individual educational plan by finding a match between the training data stored in the training database and the skill GAP provided by the analysis by the market value diagnosing unit.

23. The ability evaluation apparatus according to claim 20 further comprising:
a training database that stores training data; and
an educational supporting unit that formulates an individual educational plan by finding a match between the training data stored in the training database and the motivation GAP provided by the analysis by the market value diagnosing unit.

24. The ability evaluation apparatus according to claim 22 further comprising:
a training mapping rule storing unit that stores a training mapping rule which associates a training item extracted from a training sentence written in a natural language about a training with a data item in the training database using a structure of the training sentence;
a training information processing unit that analyzes a structure of each sentence of training information written in the natural language to output the result of the structural analysis; and
a training data storing unit that extracts the training data from the result of the structural analysis output from the training information processing unit using the training mapping rule stored in the training mapping rule storing unit, and stores the extracted training data in the training database.

25. The ability evaluation apparatus according to claim 19 further comprising:
an integrated employment database that stores integrated employment data; and
a best employment supporting unit that formulates an individual reemployment plan by finding a match between the integrated employment data stored in the integrated employment database and the skill GAP provided by the analysis by the market value diagnosing unit.

26. The ability evaluation apparatus according to claim 20 further comprising:
an integrated employment database that stores integrated employment data; and
a best employment supporting unit that formulates an individual reemployment plan by finding a match between the integrated employment data stored in the integrated employment database and the motivation GAP provided by the analysis by the market value diagnosing unit.

27. The ability evaluation apparatus according to claim 25 further comprising:
an integrated employment mapping rule storing unit that stores an integrated employment mapping rule which associates an integrated employment item extracted from an integrated employment sentence written in a natural language about integrated employment with a data item in the integrated employment database using a structure of the integrated employment sentence;
an integrated employment information processing unit that analyzes a structure of each sentence of integrated employment information written in the natural language to output the result of the structural analysis, and
an integrated employment data storing unit that extracts the integrated employment data from the result of the structural analysis output from the integrated employment information processing unit using the integrated employment mapping rule stored in the integrated employment mapping rule storing unit, and stores the extracted integrated employment data in the integrated employment database.

28. An ability evaluation method of evaluating an individual ability and stores a result of evaluation in an ability database, comprising:
generating an ability mapping rule database that stores an ability mapping rule which associates an ability item extracted from an ability sentence written in a natural language about an individual ability with a data item in the ability database using a structure of the ability sentence;
analyzing each sentence in a document written in the natural language about the individual ability to output a result of structural analysis; and
extracting the ability item from the result of structural analysis output from the natural language processing unit using the ability mapping rule stored in the ability mapping rule storing unit to store the extracted ability item in the ability database.

29. The ability evaluation method according to claim 28 wherein,
the ability database is a skill database which stores a result of evaluation of an individual skill,
the ability mapping rule storing database is generated to store a skill mapping rule which associates a skill item extracted from a skill sentence written in a natural language about a skill with a data item in the skill database using a structure of the skill sentence,
a structure of each sentence in a document written in the natural language about the individual skill to output a result of structural analysis is analyzed, and
the ability item is extracted from the result of structural analysis output from the natural language processing unit using the skill mapping rule stored in the skill mapping rule storing unit, and stored in the skill database.

30. The ability evaluation method according to claim 29 further comprising:
generating a document written in the natural language from audio information acquired via a hearing on the skill; wherein,
the morphological analysis, the syntactic analysis, and the semantic analysis of each sentence in the document generated by the audio recognizing unit is performed.

31. The ability evaluation method according to claim 28 wherein,
the ability database is a motivation database which stores a result of evaluation of an individual motivation,
a motivation mapping rule database is generated to store a motivation mapping rule which associates a motivation item extracted from a motivation sentence written in a natural language about a motivation with a data item in the motivation database using a structure of the motivation sentence,
a structure of each sentence in a document written in the natural language about the individual motivation to output a result of structural analysis is analyzed, and
a motivation item is extracted from the result of structural analysis output from the natural language processing unit using the motivation mapping rule stored in the motivation mapping rule storing unit, and is stored in the motivation database.

32. The ability evaluation method according to claim 31 further comprising:
generating a document written in the natural language from audio information acquired via a hearing on the motivation; wherein,
the morphological analysis, the syntactic analysis, and the semantic analysis of each sentence in the document generated by the audio recognizing unit is performed.

33. A computer program product having a computer readable medium including programmed instructions for evaluating an individual ability and stores a result of evaluation in an ability database, wherein the instructions, when executed by a computer, cause the computer to perform:
generating an ability mapping rule database that stores an ability mapping rule which associates an ability item extracted from an ability sentence written in a natural language about an individual ability with a data item in the ability database using a structure of the ability sentence;
analyzing each sentence in a document written in the natural language about the individual ability to output a result of structural analysis; and
extracting the ability item from the result of structural analysis output from the natural language processing unit using the ability mapping rule stored in the ability mapping rule storing unit to store the extracted ability item in the ability database.

34. The computer program product according to claim 33 wherein, the ability database is a skill database which stores a result of evaluation of an individual skill,
the ability mapping rule storing database is generated to store a skill mapping rule which associates a skill item extracted from a skill sentence written in a natural language about a skill with a data item in the skill database using a structure of the skill sentence,
a structure of each sentence in a document written in the natural language about the individual skill to output a result of structural analysis is analyzed, and
the ability item is extracted from the result of structural analysis output from the natural language processing unit using the skill mapping rule stored in the skill mapping rule storing unit, and stored in the skill database.

35. The computer program product according to claim 34 further comprising:
generating a document written in the natural language from audio information acquired via a hearing on the skill; wherein,
the morphological analysis, the syntactic analysis, and the semantic analysis of each sentence in the document generated by the audio recognizing unit is performed.

36. The computer program product according to claim 33 wherein,
the ability database is a motivation database which stores a result of evaluation of an individual motivation,
a motivation mapping rule database is generated to store a motivation mapping rule which associates a motivation item extracted from a motivation sentence written in a natural language about a motivation with a data item in the motivation database using a structure of the motivation sentence,
a structure of each sentence in a document written in the natural language about the individual motivation to output a result of structural analysis is analyzed, and
a motivation item is extracted from the result of structural analysis output from the natural language processing unit using the motivation mapping rule stored in the motivation mapping rule storing unit, and is stored in the motivation database.

37. The computer program product according to claim 36 further comprising:
generating a document written in the natural language from audio information acquired via a hearing on the motivation; wherein,
the morphological analysis, the syntactic analysis, and the semantic analysis of each sentence in the document generated by the audio recognizing unit is performed.
